(19) United States
(12) Patent Application Publication
(10) Pub. No.: US 2013/0051405 A1
(43) Pub. Date: Feb. 28, 2013

(54) DIGITAL BROADCAST TRANSMITTER, DIGITAL BROADCAST RECEIVER, AND METHOD FOR CONFIGURING AND PROCESSING STREAMS THEREOF

(71) Applicants: Jin-hee Jeong, Yongin-si (KR); Hak-ju Lee, Incheon (KR); Se-ho Myung, Suwon-si (KR); Yong-sik Kwon, Suwon-si (KR); Kum-ran Ji, Suwon-si (KR)

(72) Inventors: Jin-hee Jeong, Yongin-si (KR); Hak-ju Lee, Incheon (KR); Se-ho Myung, Suwon-si (KR); Yong-sik Kwon, Suwon-si (KR); Kum-ran Ji, Suwon-si (KR)

(73) Assignee: SAMSUNG ELECTRONICS CO., LTD., Suwon-si (KR)

(21) Appl. No.: 13/696,167

(22) PCT Filed: May 4, 2011
(86) PCT No.: PCT/KR2011/003366

§ 371 Date: Nov. 5, 2012

(30) Foreign Application Priority Data
May 4, 2010 (KR) 10-2011-0042348
May 4, 2011 (KR) 10-2010-0012348

(51) Int. Cl. H04L 12/56

(52) U.S. Cl. 370/474

(57) ABSTRACT

Provided are a digital broadcast transmitter, a digital broadcast receiver, a method for processing a stream of the transmitter, and a method for processing a stream of the receiver. The method of processing the stream of the transmitter includes: arranging second mobile data according to a predetermined mode within a stream that includes a first region allocated for first mobile data and a second region allocated for normal data; configuring the stream in which the normal data and the second mobile data are arranged; and encoding and interleaving the stream to output the stream as a transport stream.

### CROSS-REFERENCE TO RELATED APPLICATIONS

This application is a National Stage application under 35 U.S.C. §371 of PCT/KR2011/003366 filed on May 4, 2011, which claims the benefit of U.S. Provisional Application No. 61/331,354, filed on May 4, 2010 in the United States Patent and Trademark Office, and claims priority from Korean Patent Application No. 10-2011-0042348, filed on May 4, 2010 in the Korean Intellectual Property Office, the disclosures of which are incorporated herein by reference in their entireties.

### BACKGROUND

1. Field

Apparatuses and methods consistent with exemplary embodiments relate to a digital broadcast transmitter, a digital broadcast receiver, and a method for configuring and processing streams thereof, and more particularly, to a digital broadcast transmitter which configures transport streams containing normal data and mobile data together, a digital broadcast receiver which receives and processes the transmission streams, and methods thereof.

2. Description of the Related Art

With the increasing use of digital broadcast, various types of electronic appliances currently provide digital broadcasting services. In addition to the digital broadcast TVs and settop boxes which are generally installed at homes, more and more devices including portable devices carried around by individual users such as mobile phones, navigation devices, personal digital assistants (PDAs), multimedia players (e.g., MP3 players), etc., are now enabled to provide digital broadcast services.

Accordingly, there are many discussions regarding the digital broadcasting standards to provide digital broadcasting services through the portable devices.

Among these, an ATSC-Mobile/Handheld (M/H) specification has been discussed. According to the ATSC-M/H specification, mobile data is also arranged in transport streams that transmit normal data (i.e., related art digital broadcast service data) and transmitted.

In consideration of mobility of the mobile device, the mobile data received and processed at a mobile device is processed to be more robust against errors than normal data when included in the transport streams.

FIG. 1 illustrates an example of a constitution of a transport stream (TS) containing mobile data and normal data.

Section (A) of FIG. 1 illustrates a stream in which the mobile and normal data are arranged to the assigned packets and multiplexed (MUXed), respectively.

Referring to section (A) of FIG. 1, the stream is converted to the structure as shown in the stream of section (B) of FIG. 1. Referring to section (B) of FIG. 1, the mobile data (MH) can be divided into A and B regions by interleaving. Region A covers a predetermined range formed with reference to an area where the MH exceeding a predetermined size are collected on a plurality of transmission units, and region B covers the remaining areas other than region A. However, regions A and B are only one example, and can vary. Accordingly, region A may include the area where there is no normal data, and region B may include all the areas corresponding to the transmission units where even just a little normal data is arranged.

Meanwhile, region B is relatively weaker against error than region A. That is, the digital broadcast data, which is demodulated and equalized appropriately at a receiver side, can include known data (e.g., a training sequence) for the purpose of error correction. According to the related art ATSC-M/H specification, since region B lacks the known data, the region is weak against errors.

Further, transmission of the mobile data can be limited because the stream is limited to the structure as illustrated in FIG. 1. That is, a problem of deteriorating utilization of streams may result from an increasing number of broadcasting stations and devices that support the mobile broadcast services while the streams of the structure as the one illustrated in FIG. 1 are unable to utilize the regions allocated to the normal data.

Accordingly, a technology that can utilize the structure of the TS efficiently is demanded.

### SUMMARY

Aspects of one or more exemplary embodiments provide a digital broadcast transmitter, a digital broadcast receiver and a method thereof for configuring and processing streams, which utilize packets allocated to normal data in a transport stream (TS) efficiently to thereby vary mobile data transmission efficiency, and improve TS reception performance.

According to an aspect of an exemplary embodiment, there is provided a method for processing a stream of a digital broadcast transmitter including: arranging new mobile data in a stream according to a predetermined mode, the stream divided into a first area allocated for existent mobile data and a second area allocated for normal data; constructing the stream in which known data and the new mobile data are arranged; and encoding and interleaving the stream and outputting the stream as a transport stream (TS).

The predetermined mode may be one of a mode to arrange the new mobile data within at least part of the second area, and a mode to arrange the new mobile data in an MPEG header and an RS parity area and the whole second area.

The second area may be made of 38 packets, and the mode to arrange the new mobile data in at least part of the second area may include at least one of: 1) a first mode to arrange the new mobile data in the 38 packets at ¼ rate; 2) a second mode to arrange the new mobile data in the 38 packets at 2/4 rate; 3) a third mode to arrange the new mobile data in the 38 packets at ¾ rate; and 4) a fourth mode to arrange the new mobile data in all the 38 packets.

Further, if the new mobile data is arranged in the whole second area in one slot, the arranging step may include, if a block mode set for a corresponding slot is a Separate mode, coding a block containing the MPEG header and the RS parity area independently from a body area within the slot, and if the block mode is a Paired mode, coding the block containing the MPEG header and RS parity area along with the body area.

The method may additionally include encoding signaling data to notify the mode to a receiver side.

The signaling data may include a preset number of bits to notify the mode.

The method may additionally include encoding signaling data to notify the mode to a receiver side, wherein the signaling data may include 3 bits which are recorded as 000 to indicate the first mode, 001 to indicate the second mode, 010 to indicate the third mode, 011 to indicate the fourth mode, and 111 to indicate a fifth mode in which the new mobile data is arranged on the MPEG header and the RS parity area and the whole second area.

The TS may be divided by the interleaving into a body area and head/tail areas, the known data may be arranged in the respective body area and the head/tail area in the form of a plurality of long training sequences, and an initialization byte may be arranged immediately before a starting point of each long training sequence to initialize memories within a trellis encoder to trellis-encode the TS.

The known data may be arranged in the form of a total of 5 long training sequences in the head/tail areas, wherein initialization bytes with respect to second, third, and fourth long training sequences among the total 5 long training sequences may be arranged after a preset number of bytes from a first byte of each segment where the second, third, and fourth long training sequences are arranged.

Further, in the arranging step, if 16 slots constructing one M/H sub-frame within the stream are set in a mode to arrange the new mobile data in the MPEG header and the RS parity area and the whole second area, and if an RS frame mode is a Single Frame mode, a block having a placeholder for the MPEG header and the RS parity area may be absorbed into at least one other block and used, and if the RS frame mode is a Dual Frame mode, the block having a placeholder for the MPEG header and the RS parity area may be used separately from the at least one other block.

According to an aspect of another exemplary embodiment, there is provided a digital broadcast transmitter including: a stream constructing unit which constructs a stream in which known data and new mobile data are arranged, by arranging the new mobile data in the stream according to a predetermined mode, wherein the stream is divided into a first area allocated for existent mobile data and a second area allocated for normal data; and an exciter unit which encodes and interleaves the stream and outputs as a transport stream (TS).

The predetermined mode may be one of a mode to arrange the new mobile data within at least part of the second area, and a mode to arrange the new mobile data in an MPEG header and an RS parity area and the whole second area.

The second area may be made of 38 packets.

The mode to arrange the new mobile data in at least part of the second area may include at least one of: 1) a first mode to arrange the new mobile data in the 38 packets at ¼ rate; 2) a second mode to arrange the new mobile data in the 38 packets at 2/4 rate; 3) a third mode to arrange the new mobile data in the 38 packets at ¾ rate; and 4) a fourth mode to arrange the new mobile data in all the 38 packets.

Further, if the new mobile data is arranged in the whole second area in one slot, and if a block mode set for a corresponding slot is a Separate mode, the stream constructing unit may code block containing the MPEG header and the RS parity area independently from a body area within the slot, and if block mode is a Paired mode, the stream constructing unit may code block containing the MPEG header and the RS parity area along with the body area.

Meanwhile, the stream constructing unit may additionally include a signaling encoder which encodes signaling data to notify the mode to a receiver side.

The signaling data may include a preset number of bits to notify the mode.

The stream constructing unit may additionally include a signaling encoder which encodes signaling data to notify the mode to a receiver side, wherein the signaling data includes 3 bits which are recorded as 000 to indicate the first mode, 001 to indicate the second mode, 010 to indicate the third mode, 011 to indicate the fourth mode, and 111 to indicate a fifth mode in which the new mobile data is arranged in the MPEG header and the RS parity area and the whole second area.

The TS may be divided by the interleaving into a body area and head/tail areas, the known data may be arranged in the respective body area and the head/tail area in the form of a plurality of long training sequences, and an initialization byte may be arranged immediately before a starting point of each long training sequence to initialize memories within a trellis encoder to trellis-encode the TS.

The known data may be arranged in the form of total 5 long training sequences in the head/tail areas, and initialization bytes with respect to second, third, and fourth long training sequences among the total 5 long training sequences may be arranged after a preset number of bytes from a first byte of each segment where the second, third, and fourth long training sequences are arranged.

If 16 slots constructing one M/H sub-frame within the stream are set in a mode to arrange the new mobile data in the MPEG header and the RS parity area and the whole second area, and if an RS frame mode is a Single Frame mode, the stream constructing unit may absorb a block having a placeholder for the MPEG header and the RS parity into at least one other block and use the same, and if the RS frame mode is a Dual Frame mode, the stream constructing unit may use the block having a placeholder for the MPEG header and the RS parity separately from the at least one other block.

According to an aspect of another exemplary embodiment, there is provided a method for processing a stream of a digital broadcast receiver, the method including: receiving a transport stream including therein a first area allocated for existent mobile data and a second area allocated for normal data, and new mobile data arranged in at least one of the first and second areas in accordance with a predetermined mode; demodulating the TS; equalizing the demodulated TS; and decoding the new mobile data from the equalized stream, wherein the new mobile data may be arranged according to one of a mode to arrange the new mobile data in at least part of the second area, and a mode to arrange the new mobile data in an MPEG header and an RS parity area and the whole second area.

The second area may be made of 38 packets.

The mode to arrange the new mobile data in at least part of the second area may include at least one of: 1) a first mode to arrange the new mobile data in the 38 packets at ¼ rate; 2) a second mode to arrange the new mobile data in the 38 packets at 2/4 rate; 3) a third mode to arrange the new mobile data in the 38 packets at ¾ rate; and 4) a fourth mode to arrange the new mobile data in all the 38 packets.

The method may additionally include decoding signaling data and detecting information about the mode and information about block mode.

If the mode is to arrange the new mobile data in the whole second area within one slot, and if the block mode set for a corresponding slot is a Separate mode, the decoding step may include decoding a block containing the MPEG header and the RS parity area independently from a body area inside the slot, and if the block mode is a Paired mode, the decoding step may include decoding a block containing the MPEG header and the RS parity area along with the body area.

The method may additionally include decoding signaling data and detecting information about the mode, wherein the signaling data may include a preset number of bits to reveal the mode.

The method may additionally include decoding signaling data to detect information about the mode, wherein the signaling data may include 3 bits which are recorded as 000 to indicate the first mode, 001 to indicate the second mode, 010 to indicate the third mode, 011 to indicate the fourth mode, and 111 to indicate a fifth mode in which the new mobile data is arranged in the MPEG header and the RS parity area and the whole second area.

The method may additionally include, if the mode is one of the first to third modes, detecting normal data included in the TS and decoding the same.

In the TS at a digital broadcast transmitter, if 16 slots constructing one M/H sub-frame within the stream are set in a mode to arrange the new mobile data in the MPEG header and the RS parity area and the whole second area, and if the RS frame mode is a Single Frame mode, a block having a placeholder for the MPEG header and the RS parity area may be absorbed into at least one other block and used, and if the RS frame mode is a Dual Frame mode, the block having the placeholder for the MPEG header and the RS parity area may be used separately from the at least one other block.

According to an aspect of another exemplary embodiment, there is provided a digital broadcast receiver including: a receiving unit which receives a transport stream including therein a first area allocated for existent mobile data and a second area allocated for normal data, and new mobile data arranged in at least one of the first and second areas in accordance with a predetermined mode; a demodulating unit which demodulates the TS; an equalization unit which equalizes the demodulated TS; and a decoder which decodes the new mobile data from the equalized stream.

The new mobile data may be arranged according to one of a mode to arrange the new mobile data in at least part of the second area, and a mode to arrange the new mobile data in an MPEG header and an RS parity area and the whole second area.

The second area may be made of 38 packets, and the mode may include at least one of: 1) a first mode to arrange the new mobile data in the 38 packets at ¼ rate; 2) a second mode to arrange the new mobile data in the 38 packets at 2/4 rate; 3) a third mode to arrange the new mobile data in the 38 packets at ¾ rate; and 4) a fourth mode to arrange the new mobile data in all the 38 packets.

The receiver may additionally include a signaling decoder which decodes signaling data and detects information about the mode and information about a block mode, wherein, if the mode is to arrange the new mobile data in the whole second area within one slot, and if the block mode set for a corresponding slot is a Separate mode, the signaling decoder may decode a block containing the MPEG header and the RS parity area independently from a body area inside the slot, and if the block mode is a Paired mode, the signaling decoder may decode the block containing the MPEG header and the RS parity area along with the body area.

The receiver may additionally include a signaling decoder which decodes signaling data and detects information about the mode, wherein the signaling data includes a preset number of bits to reveal the mode.

The receiver may additionally include a signaling decoder which decodes signaling data and detects information about the mode, wherein the signaling data may include 3 bits which are recorded as 000 to indicate the first mode, 001 to indicate the second mode, 010 to indicate the third mode, 011 to indicate the fourth mode, and 111 to indicate a fifth mode in which the new mobile data is arranged in the MPEG header and the RS parity area and the whole second area.

In the TS at a digital broadcast transmitter, if 16 slots constructing one M/H sub-frame within the stream are set in a mode to arrange the new mobile data in the MPEG header and the RS parity area and the whole second area, and if the RS frame mode is a Single Frame mode, a block having a placeholder for the MPEG header and the RS parity area is absorbed into at least one other block and used, and if the RS frame mode is a Dual Frame mode, the block having the placeholder for the MPEG header and the RS parity area is used separately from the at least one other block.

In various exemplary embodiments, by constructing a TS in various forms and transmitting the same, a receiver can be provided with various types of mobile data.

### BRIEF DESCRIPTION OF THE DRAWINGS

The above and other features and advantages will become more apparent by describing in detail exemplary embodiments with reference to the attached drawings in which:

FIG. 1 illustrates an example of a constitution of a transport stream (TS) according to ATSC-M/H specification;

FIGS. 2 to 4 are block diagrams of a digital broadcast transmitter according various exemplary embodiments;

FIG. 5 is a block diagram of a frame encoder according to an exemplary embodiment;

FIG. 6 is a block diagram of a Reed Solomon (RS) frame encoder among the frame encoder of FIG. 5;

FIG. 7 is a block diagram of a block processor according to an exemplary embodiment;

FIG. 8 is a view provided to explain an example of block dividing in a stream;

FIG. 9 is a block diagram of a signaling encoder according to an exemplary embodiment;

FIGS. 10 to 13 illustrate constitution of a trellis encoder according to various exemplary embodiments;

FIG. 14 illustrates a structure of mobile data frame according to an exemplary embodiment;

FIGS. 15 to 21 are views illustrating a stream constitution according to various exemplary embodiments;

FIGS. 22 to 28 are views illustrating pattern of inserting known data according to various exemplary embodiments;

FIG. 29 is a view illustrating a pattern of arranging mobile data in a normal data area according to a first mode, according to an exemplary embodiment;

FIG. 30 is a view illustrating the stream of FIG. 29 interleaved, according to an exemplary embodiment;

FIG. 31 is a view illustrating a pattern of arranging mobile data in a normal data area according to a second mode, according to an exemplary embodiment;

FIG. 32 is a view illustrating the stream of FIG. 31 interleaved, according to an exemplary embodiment;

FIG. 33 is a view illustrating a pattern of arranging mobile data in a normal data area according to a third mode, according to an exemplary embodiment;

FIG. 34 is a view illustrating the stream of FIG. 33 interleaved, according to an exemplary embodiment;

FIG. 35 is a view illustrating a pattern of arranging mobile data in normal data area according to a fourth mode, according to an exemplary embodiment;

FIG. 36 is a view illustrating the stream of FIG. 35 interleaved, according to an exemplary embodiment;

FIGS. 37 to 40 are views illustrating a pattern of arranging mobile data according to various modes of exemplary embodiments;

FIGS. 41 to 43 are views illustrating a state of sequentially and repeatedly arranging various forms of slots, according to exemplary embodiments;

FIGS. 44 to 47 are views provided to explain a method for allocating blocks according to various exemplary embodiments;

FIG. 48 is a view provided to explain various exemplary embodiments to define starting point of RS frame;

FIG. 49 is a view provided to explain a location of inserting signaling data, according to an exemplary embodiment;

FIG. 50 is a view illustrating an example of constructing data field sync to transmit signaling data, according to an exemplary embodiment;

FIGS. 51 to 53 illustrate constitution of a digital broadcast receiver according to various exemplary embodiments;

FIG. 54 illustrates an example of stream format after interleaving, according to an exemplary embodiment;

FIG. 55 is a view provided to explain an example of signaling information of the next frame in advance, according to an exemplary embodiment;

FIG. 56 illustrates stream structure after interleaving in Scalable Mode 11a, according to an exemplary embodiment;

FIG. 57 illustrates stream structure before interleaving in Scalable Mode 11a, according to an exemplary embodiment;

FIG. 58 illustrates a stream structure having a first type Orphan Region after interleaving, according to an exemplary embodiment;

FIG. 59 illustrates a stream structure having a first type Orphan Region before interleaving, according to an exemplary embodiment;

FIG. 60 illustrates a stream structure having a second type Orphan Region after interleaving, according to an exemplary embodiment;

FIG. 61 illustrates a stream structure having a second type Orphan Region before interleaving, according to an exemplary embodiment;

FIG. 62 illustrates a stream structure having a third type Orphan Region after interleaving, according to an exemplary embodiment;

FIG. 63 illustrates a stream structure having a third type Orphan Region before interleaving, according to an exemplary embodiment;

FIG. 64 illustrates a stream structure before interleaving in Block Extension Mode 00, according to an exemplary embodiment; and

FIG. 65 illustrates a stream structure after interleaving in Block Extension Mode 00, according to an exemplary embodiment.

### DETAILED DESCRIPTION OF EXEMPLARY EMBODIMENTS

Hereinafter, exemplary embodiments will be described in detail with reference to the attached drawings. Like reference numerals in the drawings denote like elements.

[Digital Broadcast Transmitter]

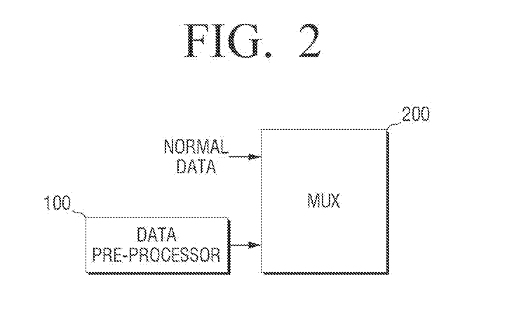

Referring to FIG. 2, a digital broadcast transmitter according to an exemplary embodiment may include a data preprocessor 100 and a multiplexer (MUX) 200.

The data preprocessor 100 operates to accept an input of mobile data and appropriately convert the input into a format suitable for transmission.

The MUX 200 generates transport streams including the mobile data outputted from the data preprocessor 100. To transfer normal data along with the stream, the MUX 200 may multiplex the mobile data and the normal data and generate the transport stream.

The data preprocessor 100 may process so that the mobile data is arranged in the whole or part of the packets allocated for the normal data among the whole streams.

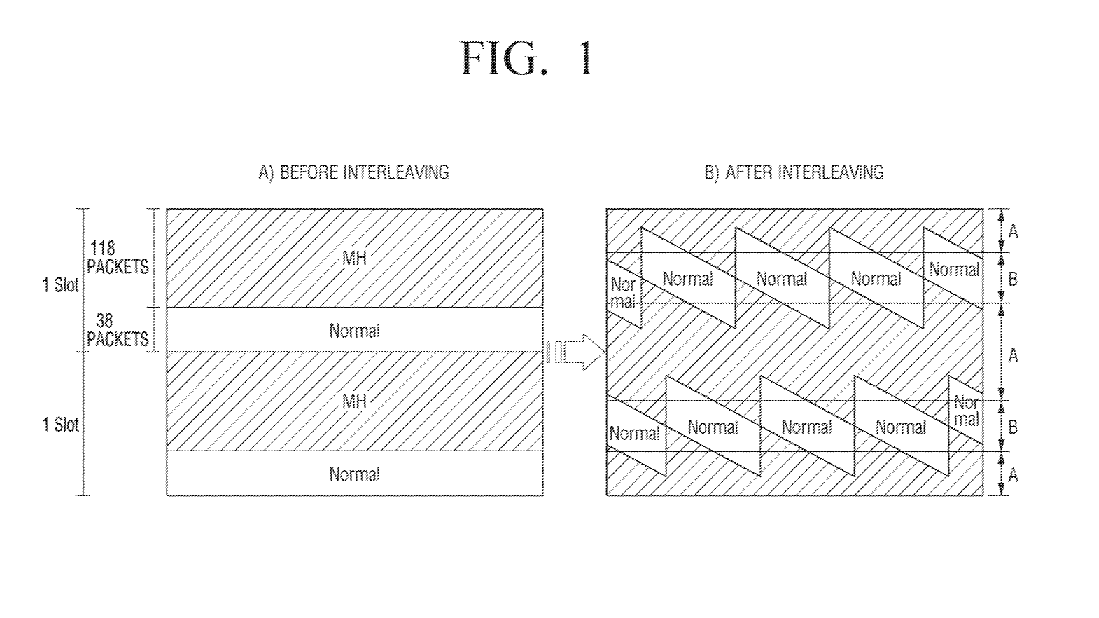

Referring to FIG. 1, according to the related art ATSC-MH standard, part of the whole packets may be allocated for the normal data. To be specific, as in FIG. 1, the stream may be divided into a plurality of slots based on time unit, in which one slot may include a total of 156 packets. Among these packets, 38 packets may be allocated for the normal data and the remaining 118 packets may be allocated for the mobile data. For the convenience of description, hereinbelow, the 118 packets will be referred to as the ‘region allocated for mobile data’, or, the ‘first region’, and the 38 packets as the ‘region allocated for normal data’ or the ‘second region’. The normal data may indicate the various types of related art data that can be received by, e.g., a TV and be processed, and the mobile data may indicate the data that can be received by instruments for mobile usage and be processed. The mobile data may be referred to as robust data, turbo data, additional data, or other various terms.

The data preprocessor 100 may place the data for the mobile usage in the packet area allocated for the mobile data, and in the part of the packets or the whole packets allocated for the normal data. The mobile data placed in the packets allocated for the mobile data may be referred to as the basic mobile data or the first mobile data, and the area distributed for the basic mobile data may be the first region, as described above. Compared to the first region, the mobile data placed in the packets for the normal data may be referred to as the new mobile data, the mobile data, or the second mobile data for convenience of description. The basic mobile data and the mobile data may be identical or different from each other.

Meanwhile, the data preprocessor 100 may place the mobile data in various manners according to the frame mode or the setting of the mode. The installation or placement of the mobile data will be described with reference to the drawings below.

The MUX 200 may multiplex the stream outputted from the data preprocessor 100 with the normal data, and generate the transport stream.

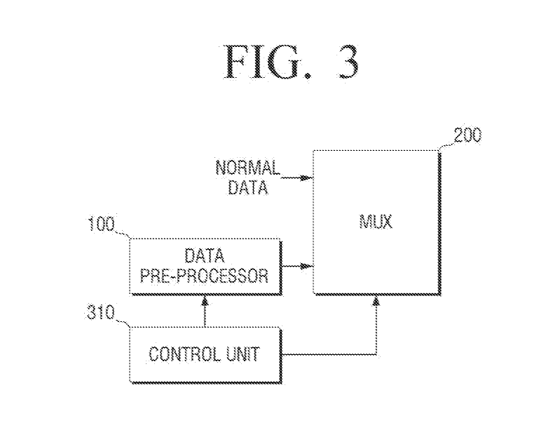

FIG. 3 illustrates an exemplary embodiment in which a control unit 310 (e.g., controller) may be included in a digital broadcast transmitter. Referring to FIG. 3, the control unit 310 installed (i.e., provided) in the digital broadcast transmitter may find the setting of the frame mode and control the data preprocessor 100.

Specifically, if the control unit 310 finds that the first frame mode is set, it may control the data preprocessor 100 to place the mobile data only in the first region and not to place the data in the whole packets for the normal data, i.e., the second region. The data preprocessor 100 may output the stream including the basic mobile data only. Thus, the MUX 200 may place the normal data in the packets for the normal data, and generate the transport stream.

Meanwhile, if the control unit 310 finds that the second frame mode is set, the control unit 310 may control the data preprocessor 100 to place the basic mobile data in the packets for the mobile data, in other words, the first region, and to place the mobile data in the parts of the packets for the normal data, in other words, the second region.

The control unit 310 may find the setting of another mode other than the frame mode, e.g., a mode setting which determines the number of the packets for the mobile data in the normal data packets. Thus, the control unit 310 may control the data preprocessor 100 to place the mobile data in the determined number of the packets according to the setting mode.

The mode may be provided in several types. For instance, the mode may include at least one more than compatible modes or non-compatible modes. The compatible mode may indicate the mode compatible with the related art normal data receiver receiving and processing the normal data, and the non-compatible mode may indicate the mode that cannot be compatible with the receiver.

Specifically, the compatible modes may include a plurality of modes placing the new mobile data in the part of the second region. For instance, the compatible modes may include a first compatible mode placing the mobile data in the whole or the part of the packets for the normal data and may include a second compatible mode placing the mobile data in the whole packets for the normal data.

The first compatible mode may be the mode placing the mobile data in the part of the data area in some packets within the second region. In other words, the first compatible mode may be the mode placing the mobile data in the part of the whole data area within some packets and placing the normal data in another part of the data area.

Further, the first compatible mode may be provided to place the mobile data in the whole data area of some packets within the second region.

Additionally, the mode may include various formats by considering the number of the packets allocated for the normal data, the size of the mobile data, the type of the mobile data, transmitting time, the transmitting environment, etc.

Referring to FIG. 1, if 38 packets are allocated for the normal data, the first compatible mode may include:

1) the first mode placing the new mobile data by one-fourth in 38 packets;

2) the second mode placing the new mobile data by two-fourths in 38 packets;

3) the third mode placing the new mobile data by three-fourths in 38 packets; and

4) the fourth mode placing the new mobile data by four-fourths in 38 packets.

The first mode may place the new mobile data in 11 packets of 38 packets, that is, 2 packets and the remaining 36 packets divided by 4, that is, 9 packets. The second mode may place the new mobile data in 20 packets of 38 packets, that is, 2 packets and the remaining 36 packets divided by 2, that is, 18 packets. Further, the third mode may place the new mobile data in 29 packets of 38 packets, that is, 2 packets and the remaining 36 packets divided by three-fourths, that is, 27 packets. The fourth mode may place the new mobile data in 38 packets.

Meanwhile, the non-compatible mode may ignore the compatibility with the receiver receiving the normal data and enlarge the transmitting capacity of the new mobile data. Specifically, the non-compatible mode may place the new mobile data by utilizing the whole second region, the MPEG header, and Reed Solomon (RS) parity area provided within the first region.

As a result, the data preprocessor 100 in FIGS. 2 and 3 may place the new mobile data and generate the transport stream according to the following modes:

1) the first mode placing the new mobile data in 11 packets of 38 packets allocated for the normal data;

2) the second mode placing the new mobile data in 20 packets of 38 packets allocated for the normal data;

3) the third mode placing the new mobile data in 29 packets of 38 packets allocated for the normal data;

4) the fourth mode placing the new mobile data in the whole 38 packets allocated for the normal data; and

5) the fifth mode placing the new mobile data in the whole 38 packets, and the MPEG header and the parity in the area distributed for the basic mobile data.

For convenience of description, an exemplary embodiment may be described by referring to the fifth mode as the non-compatible mode, and the other first to fourth modes as compatible modes. However, each mode may be utilized differently. Further, even though the foregoing describes four compatible modes and one non-compatible mode, the number of the compatible modes may vary. For instance, the first to third modes may be utilized as compatible as described above, and the fourth mode may be non-compatible as in the fifth mode.

Meanwhile, the data preprocessor 100 may insert station data other than the mobile data. The station data may indicate a sequence that the digital broadcast transmitter and the digital broadcast receiver may find in common. The digital broadcast receiver may receive the station data that the digital broadcast transmitter may transmit, find the difference in the sequences with the known sequences, and find the degree of correcting the errors, or others. The station data may be referred to as training data, training sequences, basic signals, additional basic signals, etc.

The data preprocessor 100 may insert at least one among the mobile data and the station data in the various parts of the whole transport stream to enhance the function of the receiving.

Referring to the constitution of the stream illustrated in section (B) of FIG. 1, in region A, MH may be the mobile data in congregated form, and in region B, MH may be the corn type. Thus, region A may be referred to as the body area, and region B may be referred to as the head/tail area. The head/tail area may not be set with the station data and may be less functional as compared to the data of the body area.

The data preprocessor 100 may insert the station data in a proper position so as to set the station data in the head/tail area. The station data may be placed in the long training sequence format, where the data having the size more than the determined amount may continue successively, or may be distributed non-successively.

Inserting the mobile data and the station data may be implemented variously according to exemplary embodiments, and will be described below by referring to the drawings. Below, a detailed constitution of the digital broadcast transmitter will be further described first.

[Detailed Constitution of Digital Broadcast Transmitter]

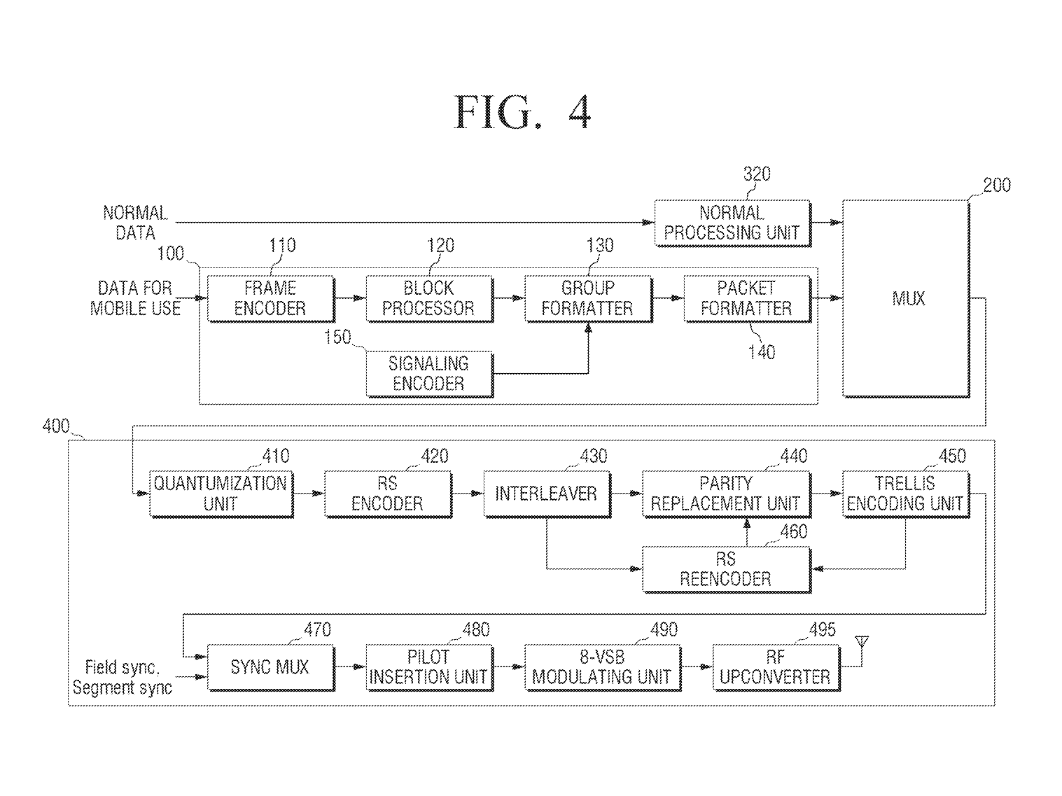

FIG. 4 is a block diagram illustrating a detailed diagram of the digital broadcast transmitter according to an exemplary embodiment. Referring to FIG. 4, the digital broadcast transmitter may include a normal processing unit 320 (e.g., normal processor), an exciter 400, the data preprocessor 100, and the MUX 200. For convenience of description, the part including the data preprocessor 100, the normal processor 320, and the MUX 200 may be referred to as the stream generator.

In FIG. 4, the constitution of the control unit 310 in FIG. 3 is not shown. However, it is understood that the control unit 310 also may be included in the digital broadcast transmitter. Further, the units of the digital broadcast transmitter drawn in FIG. 4 may be excluded as necessity or included with other new units. The installation order or the number of the units may change variously.

Referring to FIG. 4, the normal processor 320 may receive the normal data and convert the format thereof to transmit the stream constitution. The digital broadcast transmitter may generate and transmit the transport stream including the normal data and the mobile data, and the receiver may receive and process the normal data properly. Thus, the normal processor 320 may implement controlling the packet timing and the Program Clock Reference (PCR) of the normal data, or of the main service data, in a proper form according to the MPEG/ATSE standard used in decoding the normal data. Since the detailed description is included in ANNEX B of the ATSC-MH, further explanation may not be included herein.

The data preprocessor 100 may include the frame encoder 110, the block processor 120, the group formatter 130, the packet formatter 140, and the signaling encoder 150.

The frame encoder 110 may implement encoding of an RS frame. Specifically, the frame encoder 110 may receive one service and build the determined number of the RS frames. For instance, if one service is a plurality of M/H parades based on M/H ensemble, the frame encoder 110 may build the determined number of the RS frames in each M/H parade. Specifically, the frame encoder 110 may randomize the inputted mobile data, implement encoding RS-Cyclic Redundancy Check (CRC), divide each RS frame according to the predetermined frame mode, and output the determined number of the RS frames.

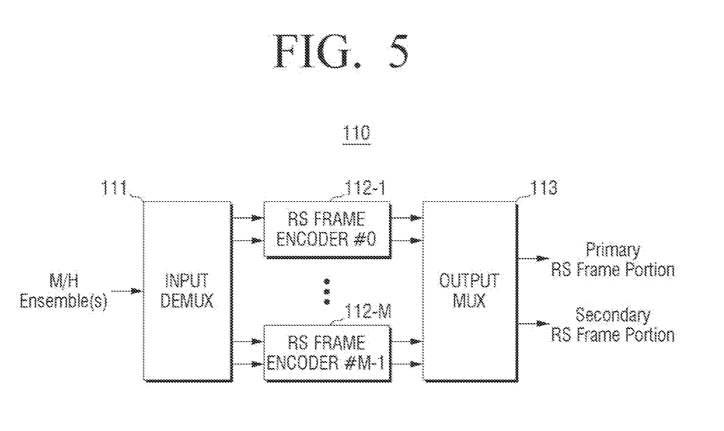

FIG. 5 is a block diagram illustrating the constitution of the frame encoder 110 according to an exemplary embodiment. Referring to FIG. 5, the frame encoder 110 may include an input deMUX (demultiplexer) 111, a plurality of RS frame encoders 112-1 to 112-M, and an output MUX 113.

If the mobile data based on the determined service unit, for instance, M/H ensemble, is inputted, the input deMUX 111 may deMUX the data to be a plurality of ensembles according to the frame mode, for instance, the primary ensemble and the secondary ensemble, and output to each RS frame encoder 112-1 to 112-M. Each RS frame encoder 112-1 to 112-M may implement randomizing, RS-CRC encoding, and dividing the inputted ensemble, and output to the output MUX 113. The output MUX 113 may multiplex the frame portion outputted from each RS frame encoder 112-1 to 112-M, and output the primary RS frame, the portion, and the secondary RS frame portion. According to the setting of the frame mode, only the primary RS frame portion may be outputted.

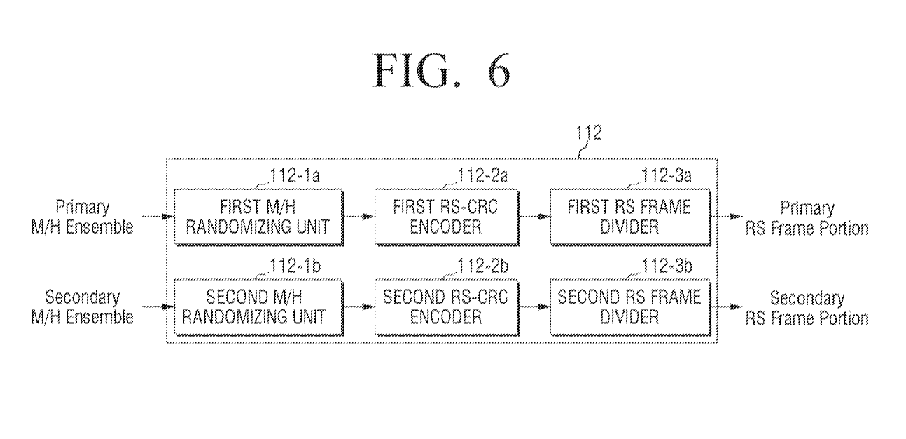

FIG. 6 is a block diagram illustrating an RS frame encoder constitution that may be provided with one of the RS frame encoders 112-1 to 112-M. Referring to FIG. 6, the frame encoder 112 may include a plurality of M/H randomizers 112-1a to 112-1b, the RS-CRC encoders 112-2a to 112-2b, and RS frame dividers 112-3a to 112-3b.

If the primary M/H ensemble and the secondary M/H ensemble are inputted from the input deMUX 111, each M/H randomizers 112-1a to 112-1b may implement the randomizing, and the RS-CRC encoders 112-2a to 112-2b may RS-CRC encode the randomized data. The RS frame dividers 112-3a to 112-3b may divide the block-coded data and output them to the output MUX 113 so that the block processor 120 can properly block-code the data. The output MUX 113 may combine and multiplex frame portions, and output the multiplexed frame portions to the block processor 120 so that the block processor 120 can block-code the data.

The block processor 120 may block-code the stream, in other words, code the stream outputted from the frame encoder 110 based on the block unit.

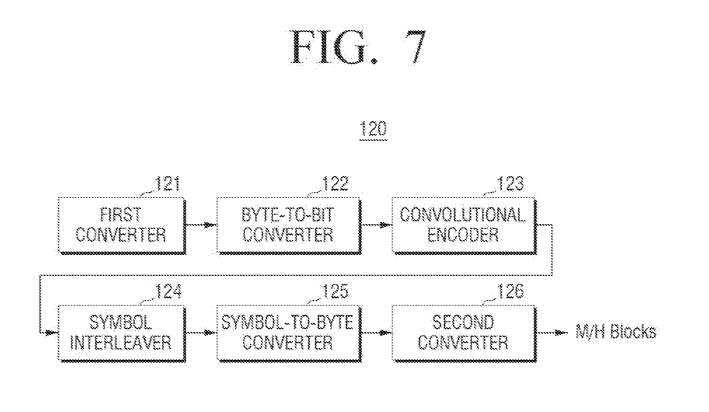

FIG. 7 is a block diagram illustrating a constitution of the block processor 120 according to an exemplary embodiment.

Referring to FIG. 7, the block processor 120 may include a first converter 121, a byte-to-bit converter 122, a convolutional encoder 123, a symbol interleaver 124, a symbol-to-byte converter 125, and a second converter 126.

The first converter 121 may convert the RS frame inputted from the frame encoder 110 to be based on the block. In other words, the first converter 121 may combine the mobile data within the RS frame according to the predetermined block mode, and output a Serially Concatenated Convolutional Code (SCCC) block.

For instance, if the block mode is “00,” one M/H block may be one SCCC block.

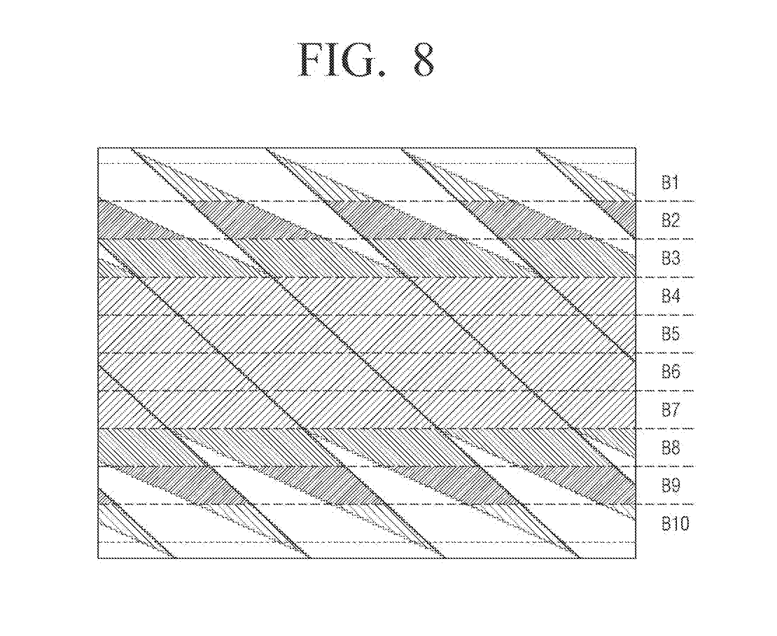

FIG. 8 is a diagram illustrating an M/H block where the mobile data may be divided by the block. Referring to FIG. 8, one mobile data unit, for instance, M/H group, may be divided by 10 blocks, B1 to B10. If the block mode is “00,” each block B1 to B10 may be outputted in the SCCC block. If the block mode is “01,” two M/H blocks may be combined in one SCCC block and outputted. The combination pattern may be set variously. For instance, B1 and B6 may be combined to be SCB1. B2 and B7, B3 and B8, B4 and B9, and B5 and B10 may be combined to be SCB2, SCB3, SCB4, and SCB5 correspondingly. According to other block modes, various means and numbers of combining the blocks may be implemented.

The byte-to-bit converter 122 may convert the SCCC block from the byte unit to the bit unit because the convolutional encoder 123 may operate in the bit unit. Thus, the convolutional encoder 123 may convolutionally encode the converted data.

The symbol interleaver 124 may implement the symbol-interleaving. The symbol-interleaving may be implemented as in the block-interleaving. The symbol-interleaved data may be converted to the byte unit by the symbol-to-byte converter 125, reconverted on M/H block unit by the second converter 126, and be outputted.

The group formatter 130 may receive the stream processed in the block processor 120 and format the stream in the group unit. Specifically, the group formatter 130 may map the data outputted from the block processor 120 on a proper position within the stream, and add the station data, the signaling data, and the configuration data. Furthermore, the group formatter 130 may add a place-holder-byte for the normal data, the MPEG-2 header, and the non-systematic RS parity, and a dummy byte for adjusting the group format.

The signaling data may indicate the information used for processing the transport stream. The signaling data may be properly processed by the signaling encoder 150 and be provided to the group formatter 130.

To transmit the mobile data, a Transmission Parameter Channel (TPC) and a Fast Information Channel (FIC) may be utilized. The TPC may be utilized to provide various parameters such as Forward Error Correction (FEC) information and M/H frame information. The FIC may be utilized for fast service implementation of the receiver and may include cross layer information between a physical class and an upper class. If the TPC information and the FIC information are provided to the signaling encoder 150, the signaling encoder 150 may process the inputted information accordingly and provide the information as the signaling data.

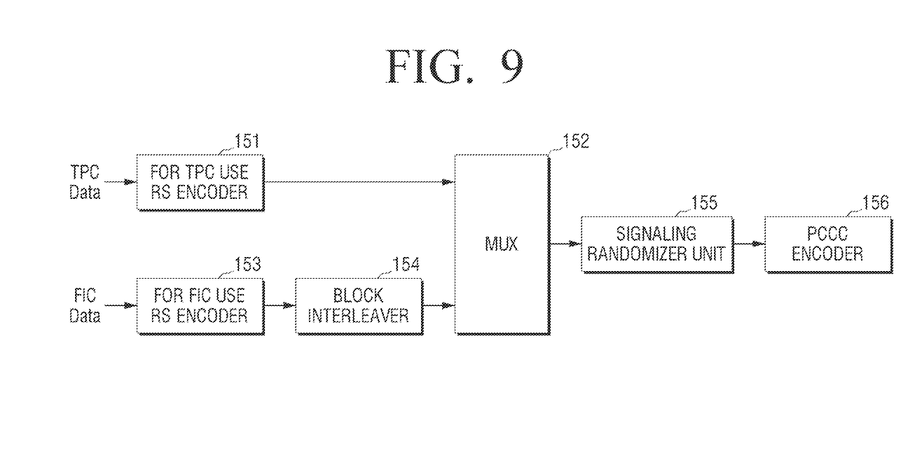

FIG. 9 is a block diagram illustrating a constitution of the signaling encoder 150 according to an exemplary embodiment.

Referring to FIG. 9, the signaling encoder 150 may include an RS encoder 151 for the TPC, a MUX 152, an RS encoder 153 for the FIC, a block interleaver 154, a signaling randomizer 155, and a Parallel Concatenated Convolutional Code (PCCC) encoder 156. The RS encoder 151 for the TPC may RS encode the inputted TPC data and generate a TPC code word. The RS encoder 153 for the FIC and the block interleaver 154 may RS encode and block-interleave the FIC data, and generate an FIC code word. The MUX 152 may position the FIC code word according to the TPC code word, and generate a series of sequences. The generated sequences may be randomized by the signaling randomizer 155, PCCC coded by the PCCC encoder 156, and outputted to the group formatter 130 as the signaling data.

Meanwhile, the station data may indicate the sequences commonly known between the digital broadcast transmitter and receiver, as described above. The group formatter 130 may insert the station data in a proper position according to the exteriorly installed units, for instance, control signals provided from the control unit 310, and place the station data in a proper position on the stream after being interleaved within the exciter 400. For instance, the group formatter 130 may insert the station data in a proper position so as to be placed in region B of the stream as shown in section (B) of FIG. 1. Meanwhile, the group formatter 130 may determine the position of inserting the station data by considering an interleaving rule.

Meanwhile, the configuration data may indicate the data so that the trellis encoder 450 (FIG. 4) can configure the interior data on a proper time. The configuration data will be further described in detail below when explaining the exciter 400.

The group formatter 130 may include a group format generator inserting a plurality of areas and signals within the stream and a data deinterleaver deinterleaving the stream generated in the group format, as described above.

The data deinterleaver may reposition the data against the interleaver 430 provided in the lower part regarding the stream. The stream deinterleaved by the data deinterleaver may be provided to the packet formatter 140.

The packet formatter 140 may delete the several placeholders that the group formatter 130 may install in the stream, and add the MPEG header having a packet identifier (PID) of the mobile data. Thus, the packet formatter 140 may output the stream by the predetermined number of the packets in each group. For instance, the packet formatter may output 118 TS packets.

The data preprocessor 100 may be implemented with various constitutions as shown above and generate the mobile data in a proper format. Particularly, if a plurality of mobile services are provided, one or more units included in the data preprocessor 100 may be provided in plural.

The MUX 200 may multiplex the normal stream processed in the normal processor 320 and the mobile stream processed in the data preprocessor 100, and generate the transport stream. The transport stream outputted from the MUX 200 may include the normal data and the mobile data, and further include the station data to enhance the receiving function.

The exciter 400 may implement encoding, interleaving, trellis encoding, and modulating the transport stream generated in the MUX 200, and output the stream. In this case, the exciter 400 may be referred to as the data postprocessor.

Referring to FIG. 4, the exciter 400 may include a quantumization unit 410 (e.g., quantumizer or randomizer), an RS encoder 420, an interleaver 430, a parity replacement unit 440 (e.g., parity replacer), a trellis encoder unit 450 (e.g., trellis encoder), the RS reencoder 460, a sync MUX 470, a pilot insertion unit 480 (e.g., pilot inserter), an 8-VSB modulating unit 490 (e.g., 8-VSB modulator), and an RF upconverter 495.

The randomizer 410 may randomize the transport stream outputted from the MUX 200. For example, the randomizer 410 may perform the same or similar function as the randomizer according to the ATSC standard.

The randomizer 410 may XOR calculate the MPEG header of the mobile data and the whole normal data with a Pseudo Random Binary Sequence (PRBS) having 16 bits to the maximum without XOR calculating the payload bytes of the mobile data. The PRBS generator may continue to shifting of the shift register. Thus, the payload bytes of the mobile data may be bypassed.

The RS encoder 420 may RS encode the randomized stream.

Specifically, if the part corresponding to the normal data is inputted, the RS encoder 420 may implement systematic RS encoding as in the related art ATSC system. The end of each packet having 187 bytes may be added with 20 bytes. Meanwhile, if the part corresponding to the mobile data is inputted, the RS encoder 420 may perform the non-systematic RS encoding. 20 bytes of the RS FEC data generated by the non-systematic RS encoding may be positioned on the determined parity bytes within each mobile data packet. Thus, an exemplary embodiment may be compatible with the receiver according to the ATSC standard.

The interleaver 430 may interleave the stream encoded by the RS encoder 420. The interleaving may be implemented by the same method as in the related art ATSC system. The interleaver 430 may be implemented to successively select a plurality of paths installed with different numbers of shift registers to each other by utilizing a switch, to write and read the data, and to interleave the shift registers on the path.

The parity replacer 440 may configure the memory in the lower trellis encoder 450, and correct the changed parity.

The trellis encoder 450 may receive the interleaved stream and perform the trellis encoding. The trellis encoder 450 may utilize 12 trellis encoders. Thus, the deMUX dividing the stream into independent 12 streams and inputting each to the trellis encoders and the MUX combining the streams trellis encoded in each trellis encoder to one stream may be utilized.

Each trellis encoder may implement the trellis encoding by utilizing a plurality of internal memories, calculating the newly inputted values and the values pre-stored in the internal memories, and outputting the calculated results.

Meanwhile, as described above, the transport stream may include the station data. The station data may indicate the sequence that the digital broadcast transmitter and the digital broadcast receiver commonly know. The digital broadcast receiver may find the received station data and determine the degree of correcting errors. The station data may be transmitted as the receiver knows. However, since the values pre-stored in the installed memory installed within the trellis encoder are not known, pre-stored values may be configured randomly before inputting the station data. Thus, the trellis encoder 450 may configure (e.g., initialize) the memory before trellis encoding the station data. The memory configuration may be referred to as a trellis reset.

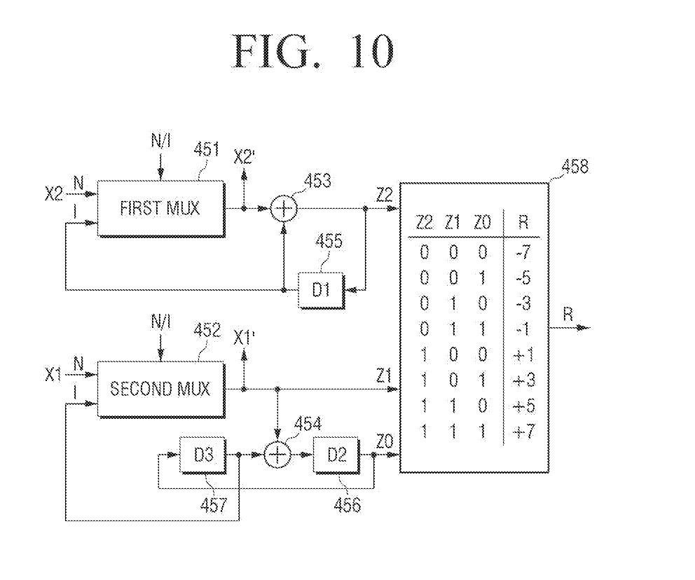

FIG. 10 illustrates an exemplary embodiment of one constitution among a plurality of trellis encoders installed within the trellis encoder 450.

Referring to FIG. 10, the trellis encoder may include first and second MUXs 451 and 452, first and second adders 453 and 454, first to third memories 455, 456, and 457, and a mapper 458.

The first MUX 451 may be inputted with data N within the stream and value I pre-stored in the first memory 455, and output one value, N or I, by the control signals N/I. Specifically, the control signal selecting I may be authorized when the value corresponding to the configuration data section is inputted, and the first MUX 451 may output I. In the other sections, the first MUX 451 may output N. Likewise, the second MUX 452 may output I only when corresponding to the configuration data section.

Thus, when the inputted value does not correspond to the configuration data section, the first MUX 451 may output the interleaved value to the lower part, and the outputted value may be inputted with the value pre-stored in the first memory 455 to the first adder 453. The first adder 453 may logically operate, for instance, exclusive OR, the inputted values and output to Z2. Thus, if the configuration data section is inputted, the value stored in the first adder 455 may be selected and outputted by the first MUX 451. Since two identical values are inputted to the first adder 453, the logically operated value may be consistent. If exclusive OR is operated, 0 may be outputted. Since the outputted value of the first adder 453 may be inputted to the first memory 455, the value of the first memory 455 may be configured to be 0.

When the inputted value does correspond to the configuration data section, the value stored in the third memory 457 may be selected and outputted by the second MUX 452. The outputted value may be inputted to the second adder 454 with the value stored in the third memory 457. The second adder 454 may logically operate the inputted identical values and output to the second memory 456. As described above, since the inputted values of the second adder 454 are identical, if the identical values are logically operated, for instance, exclusive OR, 0 may be inputted to the second memory 456. Thus, the second memory 456 may be configured. Meanwhile, the stored value of the second memory 456 may be shifted and stored in the third memory 457. Thus, when the next configuration data is inputted, the current value of the second memory 456, i.e., 0 may be inputted to the third memory 457, and the third memory 457 may be configured.

The mapper 458 may be inputted with the outputted value of the first adder 453, the outputted value of the second MUX 452, and the outputted value of the second memory 456. The mapper 458 may map the inputted values to the corresponding symbol value R and output the mapped symbol. For instance, if Z0, Z1, and Z2 are outputted as 0, 1, and 0, the mapper 458 may output −3 symbol.

Meanwhile, since the RS encoder 420 is provided before the trellis encoder 450, the value inputted to the trellis encoder 450 may be added with the parity. Thus, since the trellis encoder 450 implements the configuration and some of the data change, the parity may be changed.

The RS reencoder 460 may utilize X1′ and X2′ outputted from the trellis encoder 450, change the value of the configuration data section, and generate the new parity. The RS reencoder 460 may be referred to as non-systematic RS encoder.

Meanwhile, though FIG. 10 illustrates an exemplary embodiment of configuring the memory value to be 0, the memory value may be configured to be another value other than 0.

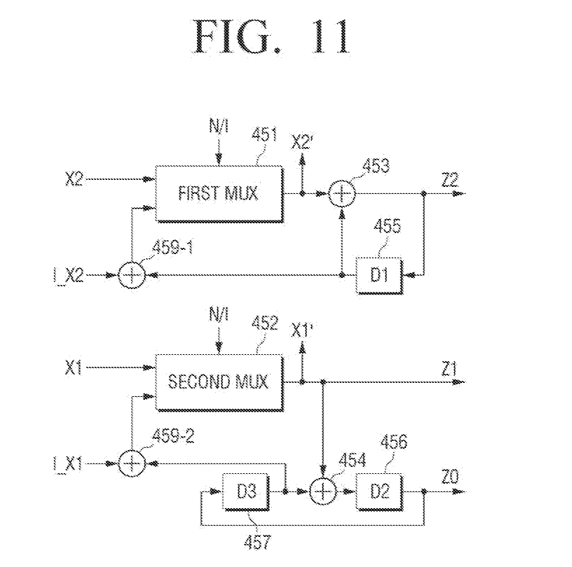

FIG. 11 is a diagram illustrating a trellis encoder according to an exemplary embodiment.

Referring to FIG. 11, the trellis encoder may include the first and second MUXs 451 and 452, the first to fourth adders 453, 454, 459-1, and 459-2, and the first to third memories 455, 456, and 457. The mapper 458 is not included in FIG. 11.

The first MUX 451 may output the stream inputted value, X2, or the value of the third adder 459-1. The third adder 459-1 may be inputted with I_X2 and the stored value of the first memory 455. I_X2 may indicate the memory reset value inputted exteriorly. For instance, when configuring the first memory 455 to be 1, I_X2 may be inputted as 1. If the stored value of the first memory 455 is 0, the outputted value of the third adder 459-1 may be 1, and the first MUX 451 may output 1. Thus, the first adder 453 may logically operate the outputted value of the first MUX 451, 1 and the stored value of the first memory 455, i.e., 0, and store the results, 1, in the first memory 455. The first memory 455 may be configured to be O.

The second MUX 452 may select and output the outputted value of the fourth adder 459-2 in the configuration data section. The fourth adder 459-2 may output the memory reset value, I_X1, inputted exteriorly and the logically operated value of the third memory 457. When the second memory 456 and the third memory 457 store 1 and 0 correspondingly and the two above memories are configured to be 1, the second MUX 452 may output the stored value of the third memory 457, 0, and the logically operated value of I_X1 and 1, 1. Outputted 1 may be logically operated with 0 stored in the third memory 457 by the second adder 454, and the results, 1, may be inputted to the second memory 456. Meanwhile, the value stored in the second memory 456, 1 may be shifted to the third memory 457 and the third memory 457 may be 1. When the second I_X1 is inputted as 1, it may be logically operated with the third memory 457 value, 1, and the results, 0, may be outputted from the second MUX 452. When 0 outputted from the second MUX 452 and 1 stored in the third memory 457 are logically operated by the second adder 454, the results, 1, may be inputted to the second memory 456, and the stored value of the second memory 456, 1, may be shifted and stored in the third memory 457. Thus, the second memory 456 and the third memory 457 may be configured to be 1.

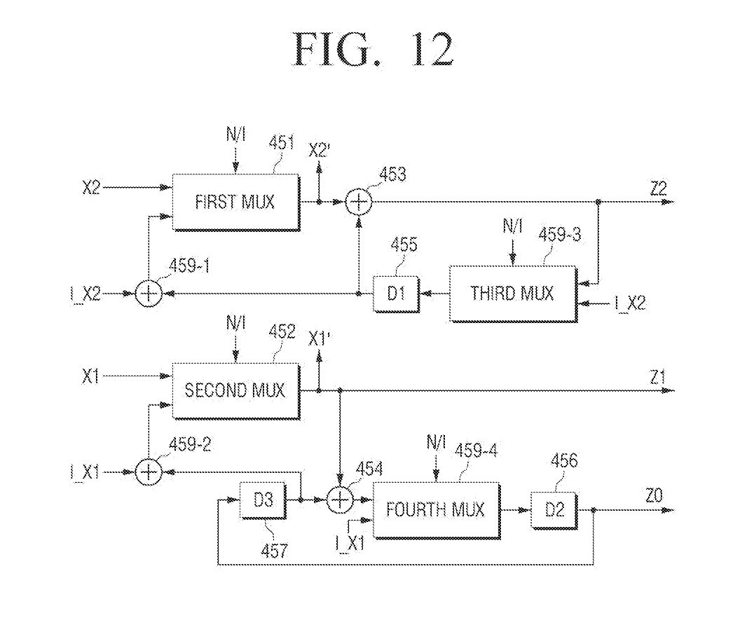

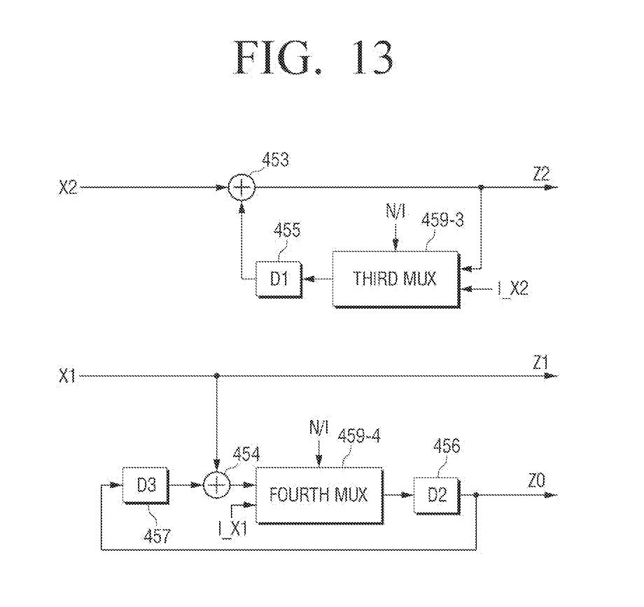

FIGS. 12 and 13 illustrate exemplary embodiments of the trellis encoder.

Referring to FIG. 12, the trellis encoder may further include the third and fourth MUXs 459-3 and 459-4 with the units drawn in FIG. 11. The third and fourth MUXs 459-3 and 459-4 may output the outputted value of the first and second adder 453 and 454 or I_X2 and I_X1 by the control signal N/I. Thus, the first to third memories 455, 456, and 457 may be configured to be the value in want.

FIG. 13 illustrates a simpler constitution of the trellis encoder compared to the previously described exemplary embodiments. Referring to FIG. 13, the trellis encoder may include the first and second adders 453 and 454, the first to third memories 455, 456, and 457, and the third and fourth MUXs 459-3 and 459-4. By I_X1 and I_X2 inputted to the third and fourth MUXs 459-3 and 459-4 correspondingly, the first to third memories 455, 456, and 457 may be configured. Referring to FIG. 13, I_X2 and I_X1 may be inputted to the first memory 455 and the second memory 456 correspondingly, and be the values of the first memory 455 and the second memory 456.

Referring to FIG. 4, the stream trellis encoded by the trellis encoder 450 may add the field sync and the segment sync in the sync MUX 470.

Meanwhile, as described above, in case the data preprocessor 100 sets and utilizes the mobile data in the packets for the normal data, the receiver may be informed of the new mobile data. Informing the receiver may be implemented in various ways. For example, according to an exemplary embodiment, the field sync may be utilized to inform the receiver, as will be further explained below.

The pilot inserter 480 may insert a pilot to the transport stream processed by the sync MUX 470, and the 8-VSB modulator 490 may modulate according to an 8-VSB modulating method. The RF upconverter 495 may convert the modulated stream to the upper RF band signal, and the modulated signal may be transmitted through an antenna.

The transport stream may be transmitted to the receiver while including the normal data, the mobile data, and the station data.

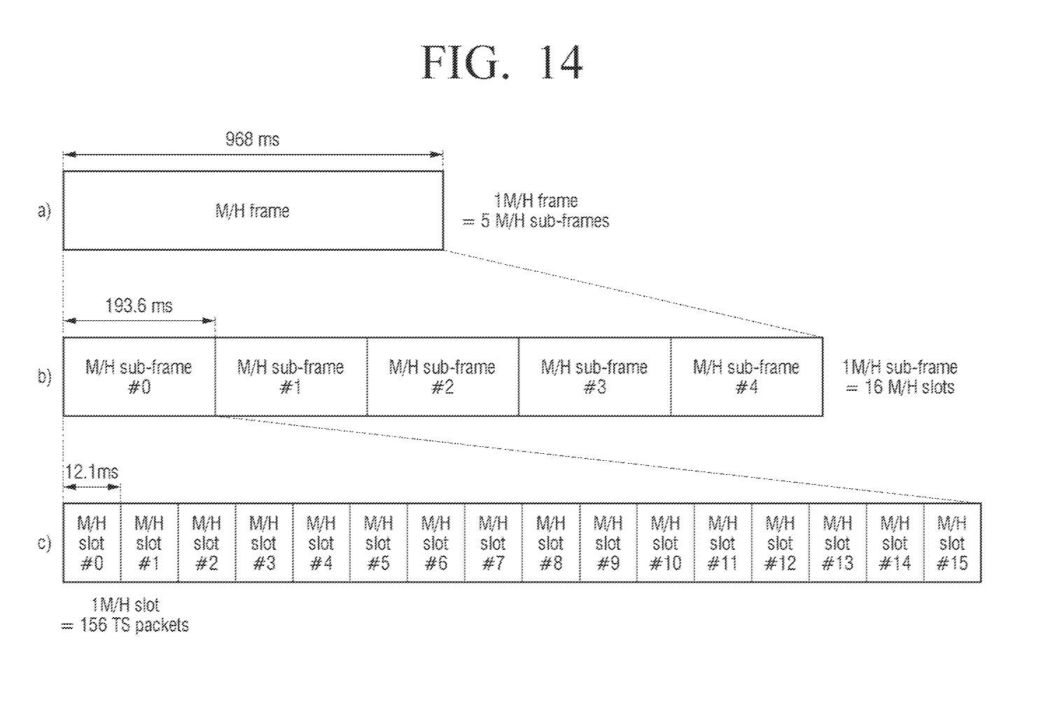

FIG. 14 is a diagram illustrating a base structure of a mobile data frame on the transport stream, in other words, M/H frame. Referring to section (a) of FIG. 14, one M/H frame may have a size base of 968 ms based on time, and referring to section (b) of FIG. 14, may be divided into 5 sub frames. One sub frame may have a time base of 193.6 ms. Further, as shown in section (c) of FIG. 14, each sub frame may be divided into 16 slots. Each slot may have a time base of 12.1 ms, and include 156 transport streams. As described above, since 38 packets of 156 transport streams may be set for the normal data, 118 packets may be set for the mobile data. Thus, one M/H group may be provided with 118 packets.

The data preprocessor 100 may set the mobile data and the station data on the packets for the normal data to enhance the transmitting function of the mobile data and receiving function.

[Exemplary Embodiments of Modified Transport Streams]

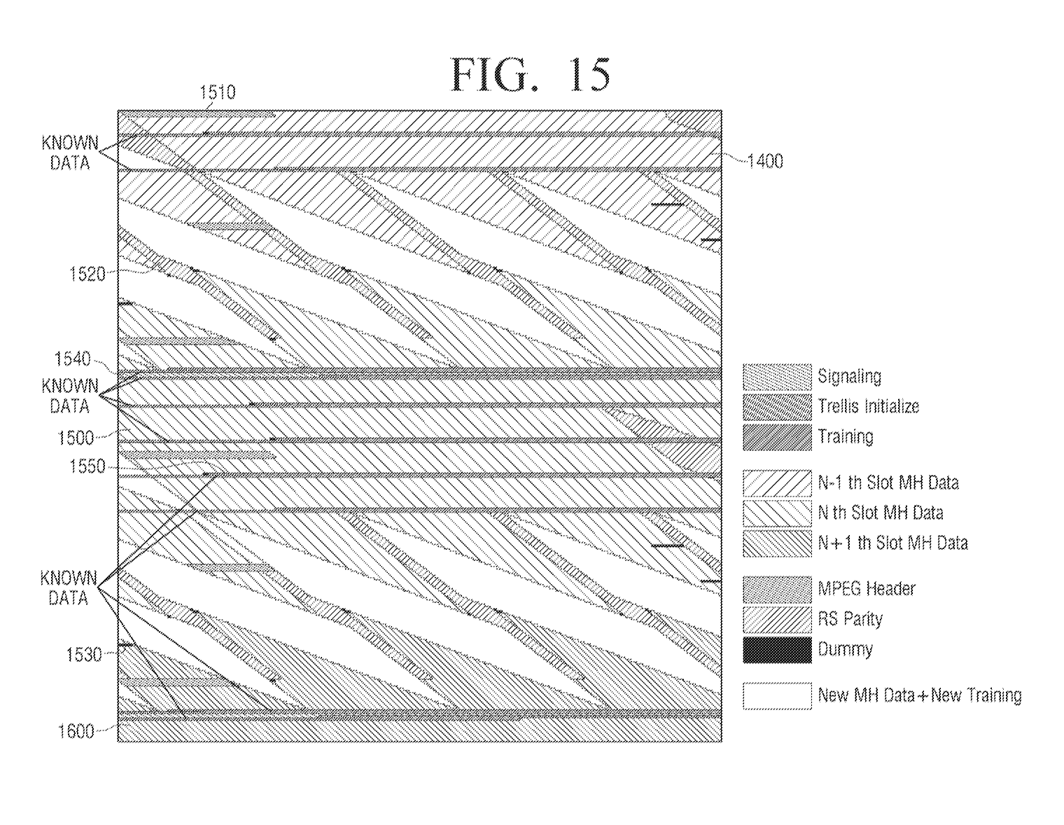

FIGS. 15 to 21 illustrate transport streams according to various exemplary embodiments.

FIG. 15 illustrates a simple modification among exemplary embodiments; the stream implementing the interleaving while setting the mobile data on the packets for the normal data, in other words, the second region. In the stream of FIG. 15, the station data may be set with the mobile data in the second region.

The packets that the related art ATSC-MH may not utilize for the mobile usage, i.e., 38 packets, may be utilized for the mobile usage. Further, since the second region may be utilized independently compared to the mobile data area, i.e., the first region, at least one service may be additionally provided. In case the new mobile data is utilized for the identical service of the basic mobile data, the efficiency of transmitting the data may be further enhanced.

Meanwhile, in case the new mobile data and the station data are transmitted as illustrated in FIG. 15, by utilizing the signaling data or the field sync, informing the new mobile data, the existence of the station data, and the position to the receiver may be implemented.

Setting the mobile data and the station data may be implemented by the data preprocessor 100. Specifically, the group formatter 130 within the data preprocessor 100 may set the mobile data and the station data in 38 packets.

Meanwhile, in FIG. 15, the body area congregating the mobile data may be positioned with 6 long training sequences of the station data. Further, for the error robustness of the signaling data, the signaling data may be positioned between first and second long training sequences. Compared to the previous one, in the packets for the normal data, the station data may also be set in the distribution form not only in the long training sequence form.

Further, in FIG. 15, the hatched area 1510 is the MPEG header, the hatched area 1520 is the RS parity area, the hatched area 1530 is the dummy area, the hatched area 1540 is the signaling data, and the hatched area 1550 is the configuration data. Referring to FIG. 15, the configuration data may be set right before the station data. Meanwhile, reference numeral ‘1400’ indicates N−1 slot M/H data, reference numeral ‘1500’ indicates N slot M/H data, and reference numeral ‘1600’ indicates N+1 slot M/H data.

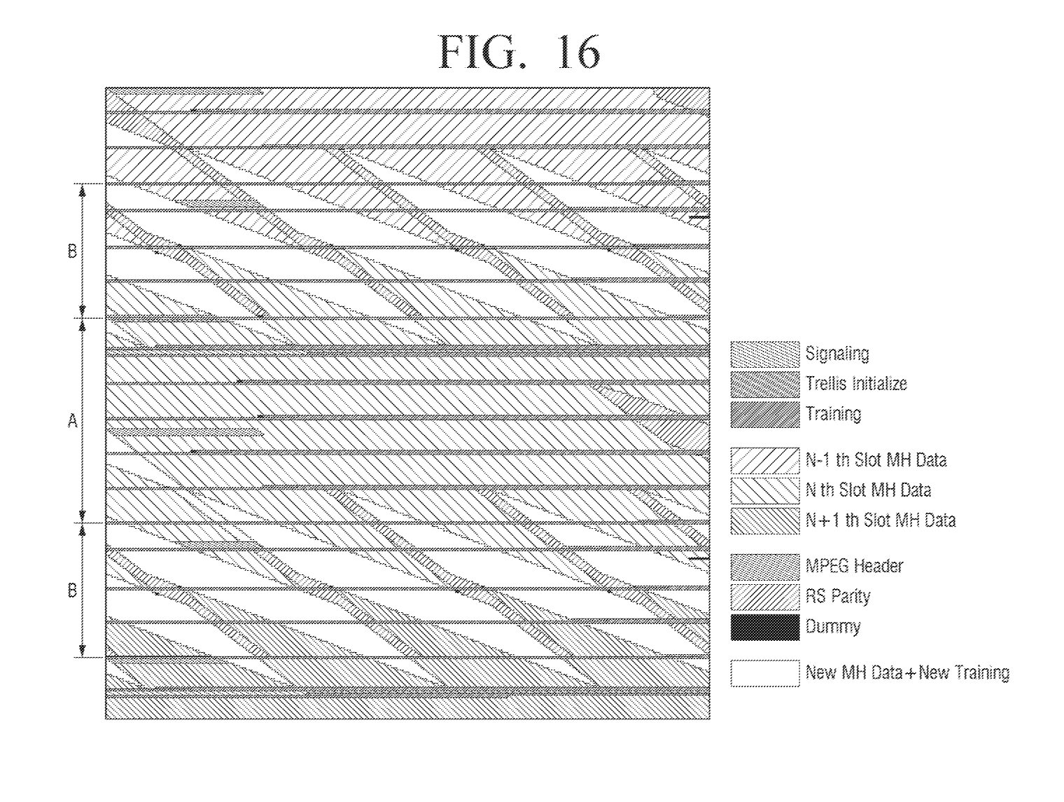

FIG. 16 illustrates a transport stream in order to utilize the first region for the basic mobile data and the packets for the normal data, i.e., the second region, and in order to transmit the mobile data and the station data.

Referring to FIG. 16, in the body area congregating the basic mobile data, 6 long training sequences of the station data are arranged. In region B, the long training sequences of the station data are arranged. To arrange the long training sequences of the station data in region B, the station data may be included in some packets of 118 packets for the mobile data but also in 38 packets. In the other packets of 38 packets excluding the station data, the new mobile data may be arranged. Thus, the function of correcting errors in region B may be enhanced.

Meanwhile, because of adding the station data in the part of the area for the basic mobile data, adding the information of the new station data in the signaling data for compatibility with the basic mobile data receiver or generating the mobile packet header that the new station data inserts in the format that the mobile data receiver cannot recognize, i.e., the null packet format, may be implemented. Thus, because the mobile data receiver may not recognize the new station data, the errors in functioning may not occur.

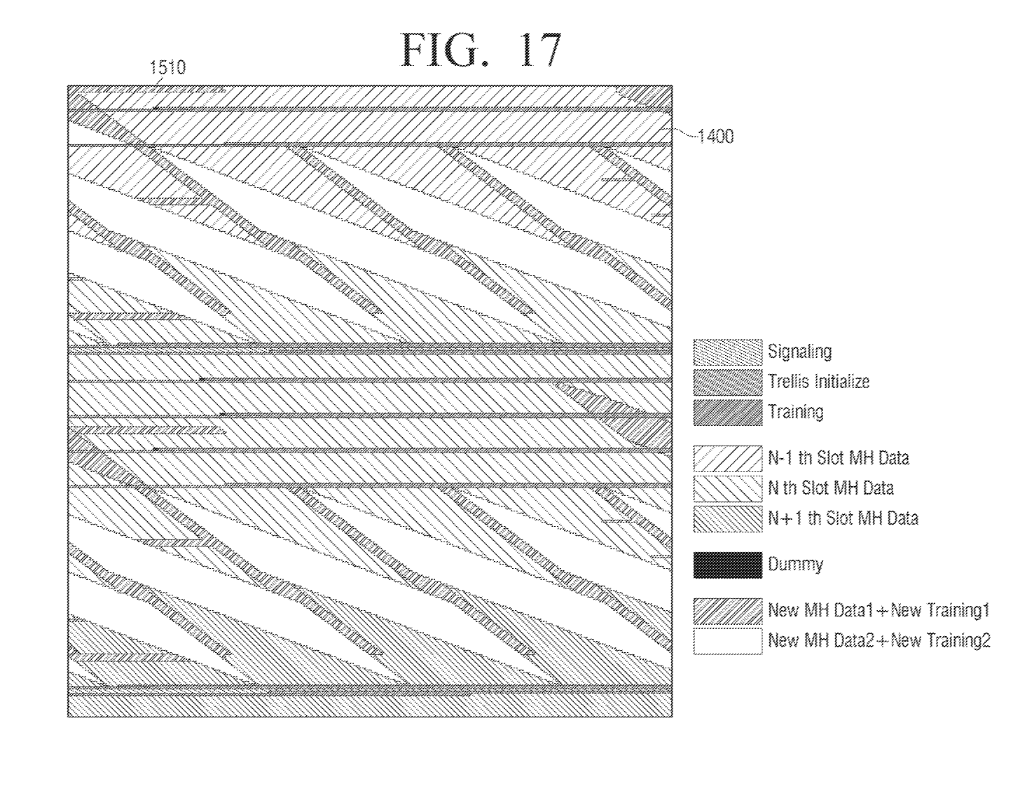

FIG. 17 illustrates a stream in which at least one of both mobile data and the station data is set on the MPEG header, the RS parity, some part of the dummies, and M/H data. By positioning, a plurality of new mobile data may be set.

Compared to FIG. 15, in FIG. 17, the new mobile data and the new station data is set in the MPEG header, the RS parity, and some part of the dummies. The mobile data inserted in the foregoing positions and the mobile data inserted in the normal data packets may be different from each other, or, may be identical to each other.

Meanwhile, besides the above-described positions, the new mobile data may be set in the position including the mobile data area.

In the case of generating the stream in FIG. 17, the transmission efficiency of the mobile data and the station data may be further enhanced as compared to FIGS. 15 and 16. Particularly, a plurality of mobile data services may be provided.

In the case of generating the stream in FIG. 17, by utilizing the signaling data or field sync, the new signaling data may be included in the new mobile data area. Thus, informing the new mobile data may be implemented.

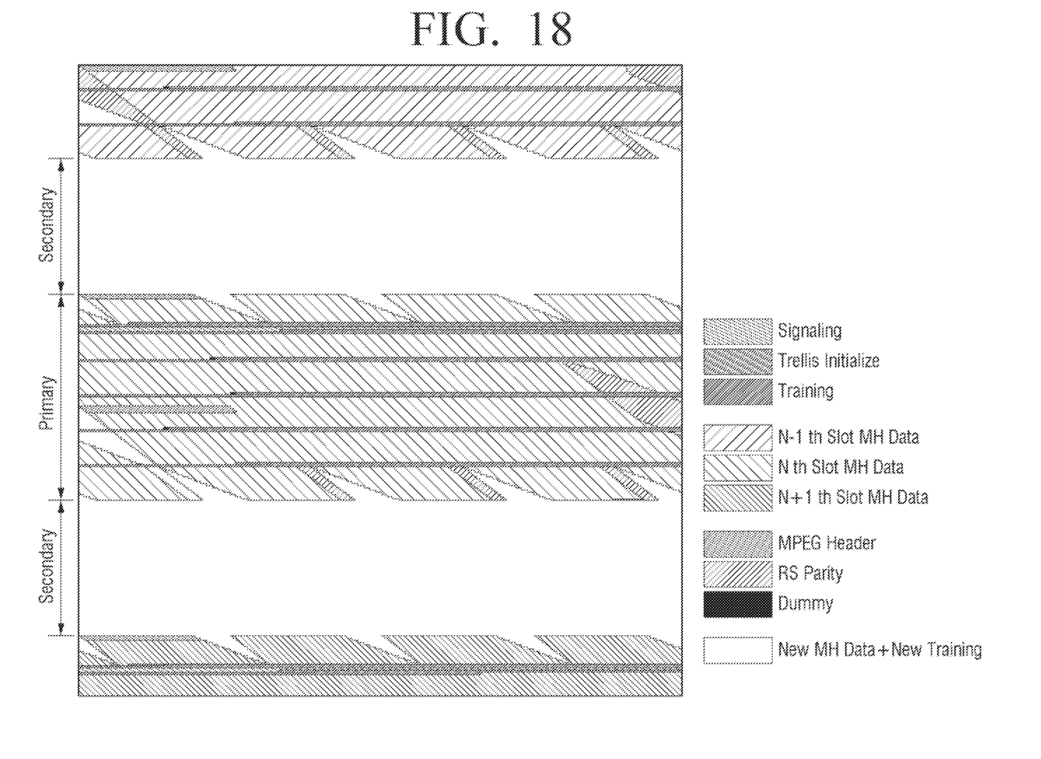

FIG. 18 illustrates the stream that the new mobile data and the station data are set in region B, i.e., the first region for the secondary service area, as well as the second region.

Referring to FIG. 18, the stream may be divided into the primary service area and the secondary service area. The primary service area may be referred to as the body area and the secondary service area may be referred to as the head/tail area. As described above, because the head/tail area does not include the station data and because the different slot data are mixed in the head/tail area, the function of the head/tail area may be lower compared to the body area. Thus, the head/tail area may be utilized to set the new mobile data and the station data. The station data may be set in the long training sequence format as in the body area, however, the format may not be limited. The station data may be set in the distribution format or in combinations of the long training sequence and the distribution formats.

Meanwhile, as the basic mobile data area is utilized for the new mobile data, the packet header including the new mobile data or the station data in the mobile data area may be provided in the format that the receiver may not recognize. The compatibility with the receiver according to the ATSC-MH standard may result.

Further, the signaling data or the new signaling data may inform the compatibility.

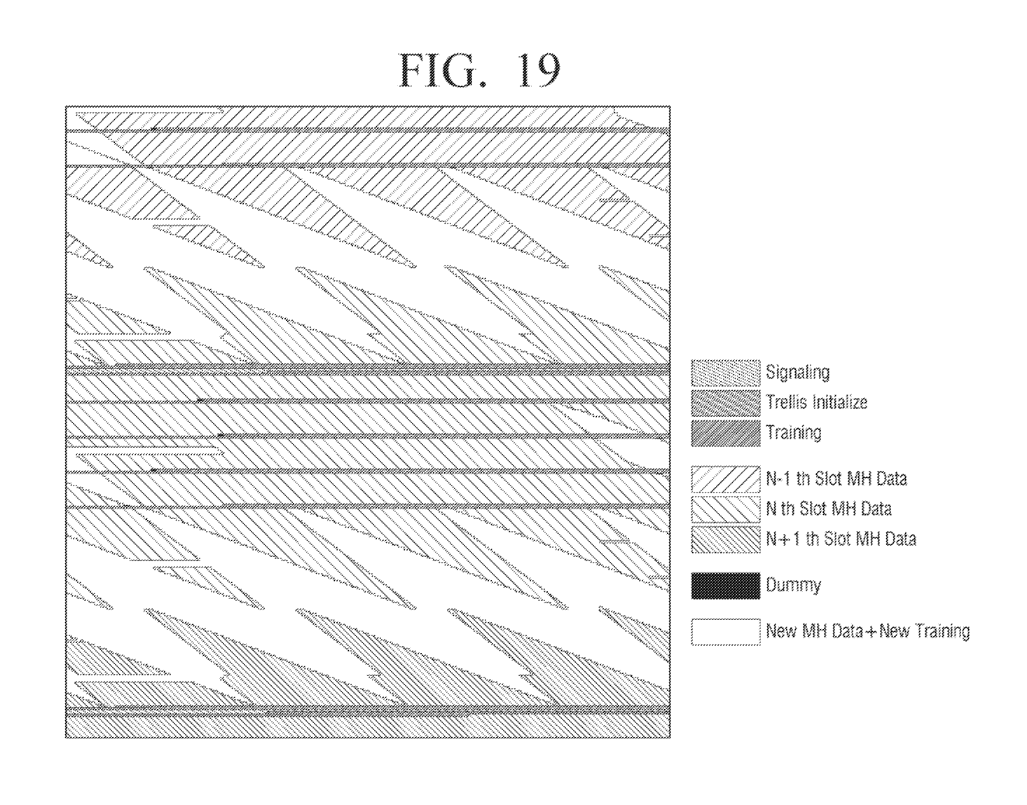

FIG. 19 illustrates an exemplary embodiment of the transport stream for transmitting the new mobile data and the station data by utilizing all of the normal data area, the MPEG header, the RS parity area, some parts of the mobile data dummies, and the mobile data area. FIG. 17 illustrates transmitting the new mobile data differently from the new mobile data set in the normal data area; however, FIG. 19 illustrates transmitting the new mobile data by utilizing all of the normal data area and the foregoing areas.

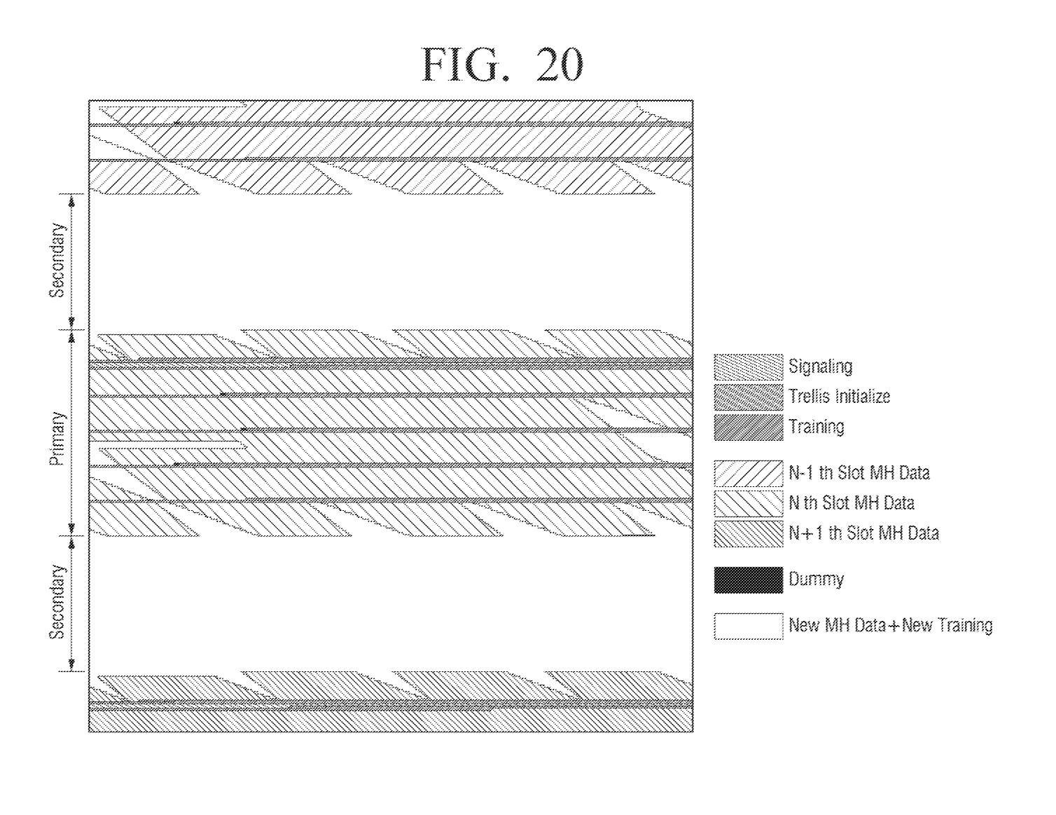

FIG. 20 illustrates an exemplary embodiment of the transport stream for transmitting the new mobile data and the station data by utilizing all of the whole region B, the normal data area, the MPEG header, the RS parity area, and some part of the mobile data dummies.

As described above, for the compatibility with the receiver, the part including the new mobile data and the station data may not be recognized.

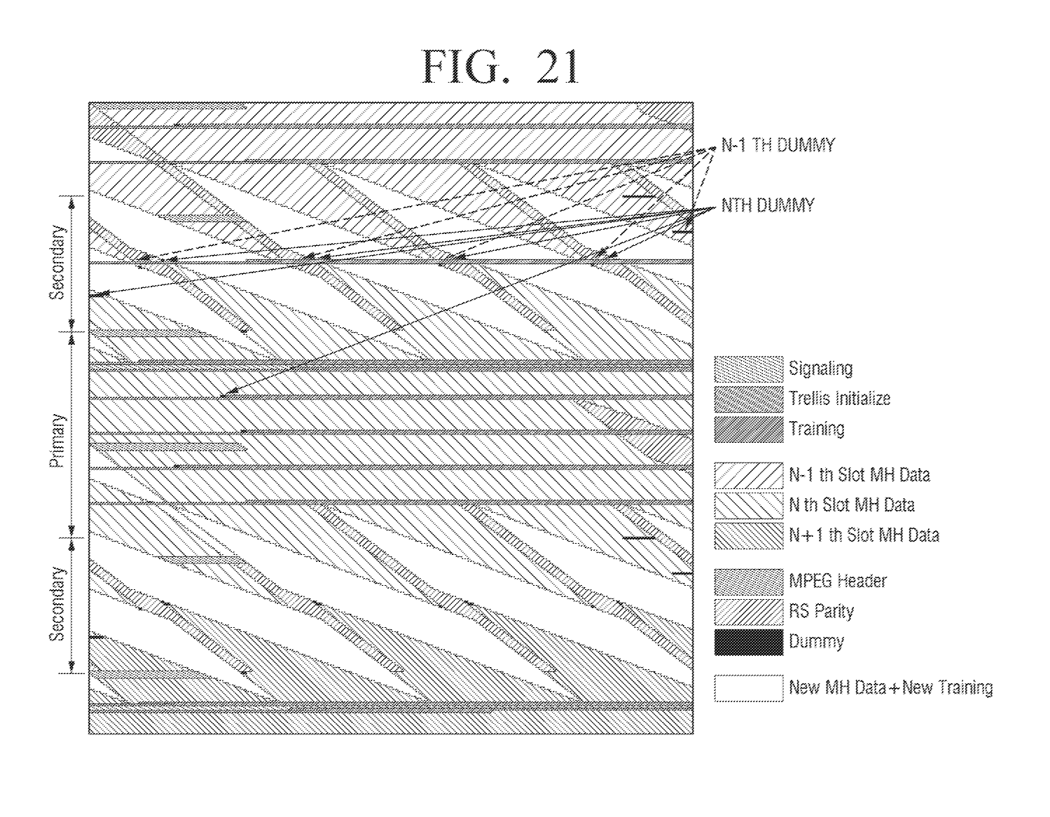

FIG. 21 illustrates the transport stream where the dummies of the areas utilized in the basic mobile data may be substituted with the parities or new mobile data areas, and where the mobile data and the station data may be placed by utilizing the substituted dummies and the normal data areas. In FIG. 21, the dummy of N−1 slot and the dummy of N slot are shown.

As described above, FIGS. 15 to 21 illustrate the stream construction after interleaving. The data preprocessor 100 may place the mobile data and the station data in a proper position for the stream construction as shown in FIGS. 15 to 21 after interleaving.

Specifically, the data preprocessor 100 may place the normal data areas, i.e., the mobile data packets of 38 packets, by the determined pattern on the stream construction in section (A) of FIG. 1. The mobile data may be placed in the whole payload of the packets or in some area within the packets. Further, also in the normal data area, the mobile data may be placed in the area arranged on the head or the tail after interleaving among the basic mobile areas.

Meanwhile, the station data may be placed within each mobile data packet or within the normal data packet. Because the station data may be a long training sequence or the similarly long training sequence on a horizontal direction after interleaving, the station data may be placed in series or by the determined gap on a vertical direction.

Further, the station data may be placed in a distributed form as well as the long training sequence. The various forms of placing the station data will be described below.

[Placing Station Data]

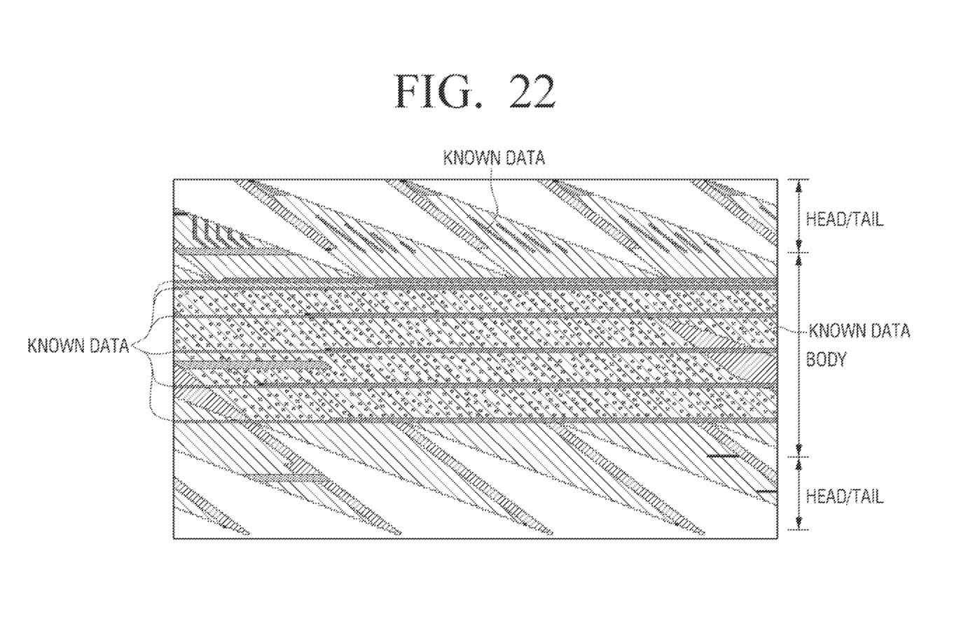

The station data may be placed in a proper position by the group formatter 130 of the data preprocessor 100 and be interleaved with the stream by the interleaver 430 within the exciter 400. FIGS. 22 to 28 illustrate methods of placing the station data according to exemplary embodiments.

FIG. 22 illustrates an arrangement in which the distributed station data with the long training sequence may be arranged while the station data may additionally be arranged in the corn part of the head and tail areas. By adding new station data while keeping the previous station data, the operation of the receiver, the function of analyzing channels, and the function of the lights may be enhanced.

The arrangement of the station data as drawn in FIG. 22 may be performed by the group formatter 130. The group formatter 130 may determine the inserting position of the station data by considering the interleaving rule of the interleaver 430. The interleaving rule may vary in exemplary embodiments. The group formatter may determine the position of the station data properly, if the interleaving rule is known. For instance, if the station data are inserted by the determined size to the same payload are in each four packets or additionally installed field, the distributed station data may be found in the determined pattern by interleaving.

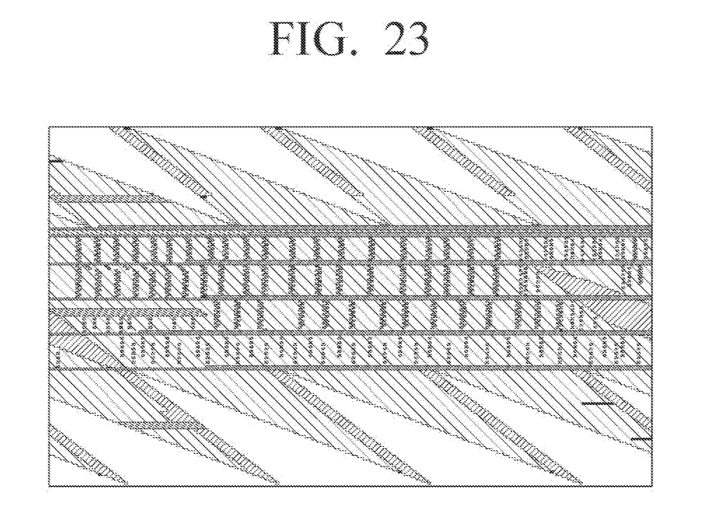

FIG. 23 illustrates a stream construction by the method inserting the station data.

In FIG. 23, the distributed station data may not be placed in the corn area while being placed in the body area with the long training sequence.

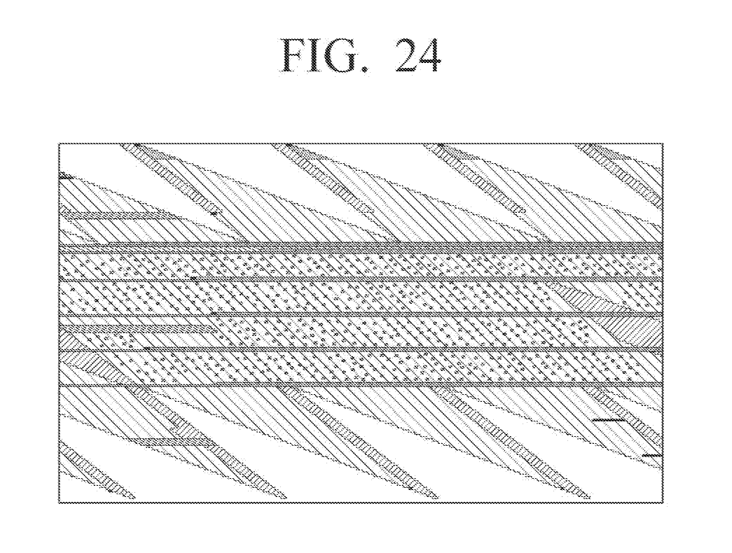

FIG. 24 illustrates a stream construction in which the length of the long training sequence may decrease compared to the construction in FIG. 23 and the distributed station data may be arranged in the area resulting from the decrease. Thus, while keeping the data efficiency on a similar performance compared to other exemplary embodiments, Doppler tracking may be enhanced.

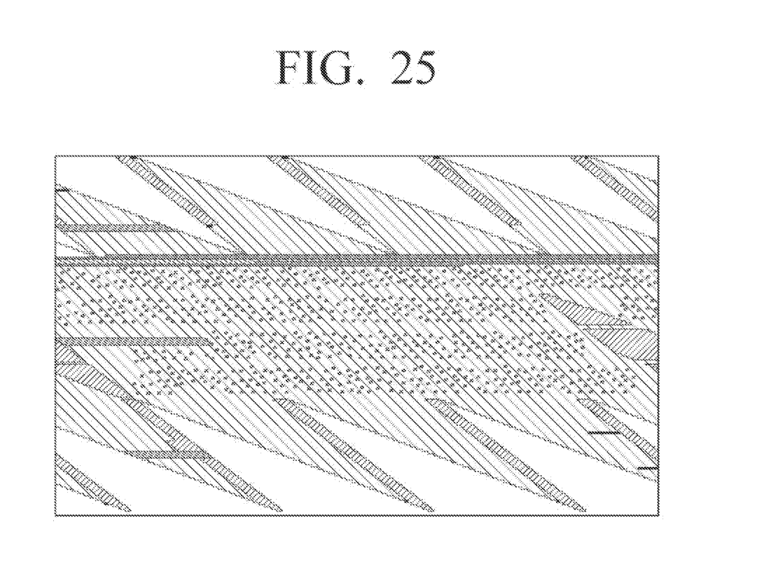

FIG. 25 illustrates a stream construction in which the station data is inserted according to another exemplary embodiment.

In FIG. 25, the first sequence of 6 long training sequences in the body area may be kept and the other sequences may be substituted with other distributed station data. By the first long training sequence at the beginning of the body area, the initial motivating and channel expecting may be kept while the Doppler tracking may be enhanced.

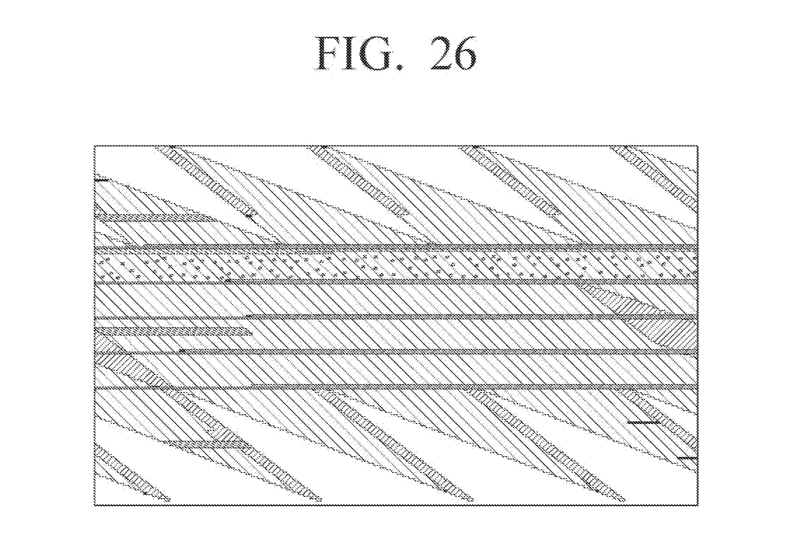

FIG. 26 illustrates a stream construction in which the station data is inserted according to another exemplary embodiment. In FIG. 26, the second sequence of 6 long training sequences may be substituted with the distributed station data.

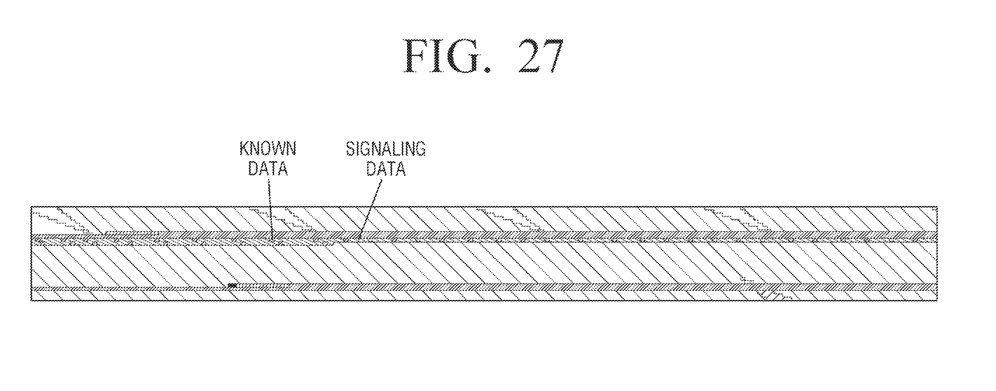

FIG. 27 illustrates a stream construction in which the substituted station data in FIG. 26 may be placed alternately with the signaling data.

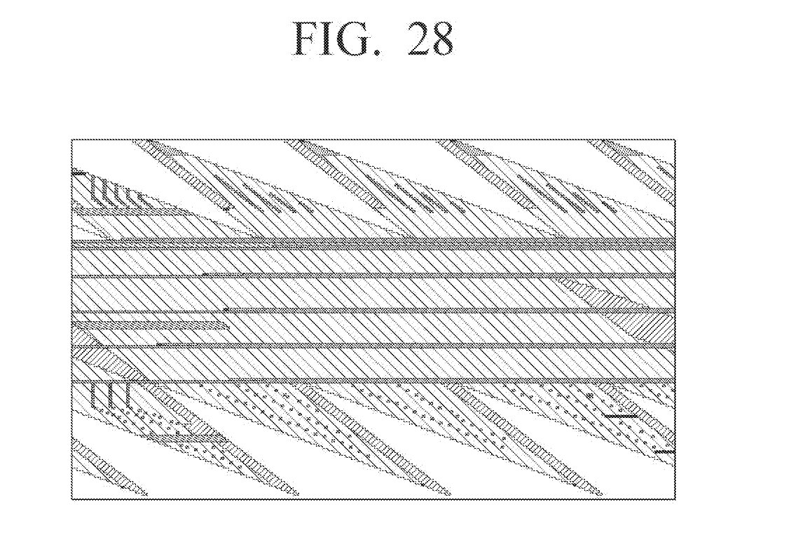

FIG. 28 illustrates a stream construction in which the distributed station data may be added in the tail area as well as the head area.

In summary, the station data may be placed in various arrangements according to exemplary embodiments.

Meanwhile, if the new mobile data may be set in the packet for the normal data, the set pattern may vary. The transport stream construction including the mobile data arranged by various methods by the modes will be described below.

[Arranging Mobile Data]

The data preprocessor 100 may find (i.e., determine) the setting of the frame mode. The frame mode may be provided variously. For instance, the first frame mode may be provided by utilizing the normal data in the packet for the normal data and the mobile data in the packet for the basic mobile data. The second frame mode may be provided by utilizing the mobile data in at least some part of the packet for the normal data. The frame mode may be set, for example, by considering the intention of the digital broadcasting transmitting manufacturer and the transreceiving environment.

If the data preprocessor 100 finds that the first frame mode, which places the normal data to the whole packets for the normal data, is set, the data preprocessor 100 may place the mobile data in the packet for the mobile data only by the related art ATSC-MH method.

Meanwhile, if the second frame mode is set, the data preprocessor 100 may determine the setting of the mode. The mode may set the pattern in which the mobile data may be arranged and how many packets may be arranged in the packet for the normal data, i.e., in the second region. The mode may vary according to exemplary embodiments.

Specifically, the mode may arrange the mobile data in some part of the whole packets for the normal data, the mode may arrange the mobile data in the whole packets for the normal data, and the non-compatible mode may arrange the mobile data in the RS parity area installed for the compatibility with the receiver receiving the normal data and in the head area while arranging the mobile data in the whole packets for the normal data. Any one of the foregoing modes may be set. The mode arranging the mobile data in some of the whole packets may utilize the mobile data in the data area of the some packets, i.e., the whole payload, or may utilize the mobile data in some part of the payload area.

Specifically, if the packets in the second region for the normal data are 38 packets, the mode may be vary such as:

1) a first mode may arrange the new mobile data in 11 packets in 38 packets for the normal data;

2) a second mode may arrange the new mobile data in 20 packets in 38 packets for the normal data;

3) a third mode may arrange the new mobile data in 29 packets in 38 packets for the normal data;

4) a fourth mode may arrange the new mobile data in 38 packets for the normal data; and

5) a fifth mode may arrange the new mobile data in 38 packets for the normal data, to the MPEG header, and the parity in the area for the basic mobile data.

As described above, the fifth mode may be referred to as non-compatible mode and the first to fourth modes may be referred to as compatible modes. The type of the compatible mode and the number of the packets in each mode may vary according to exemplary embodiments.

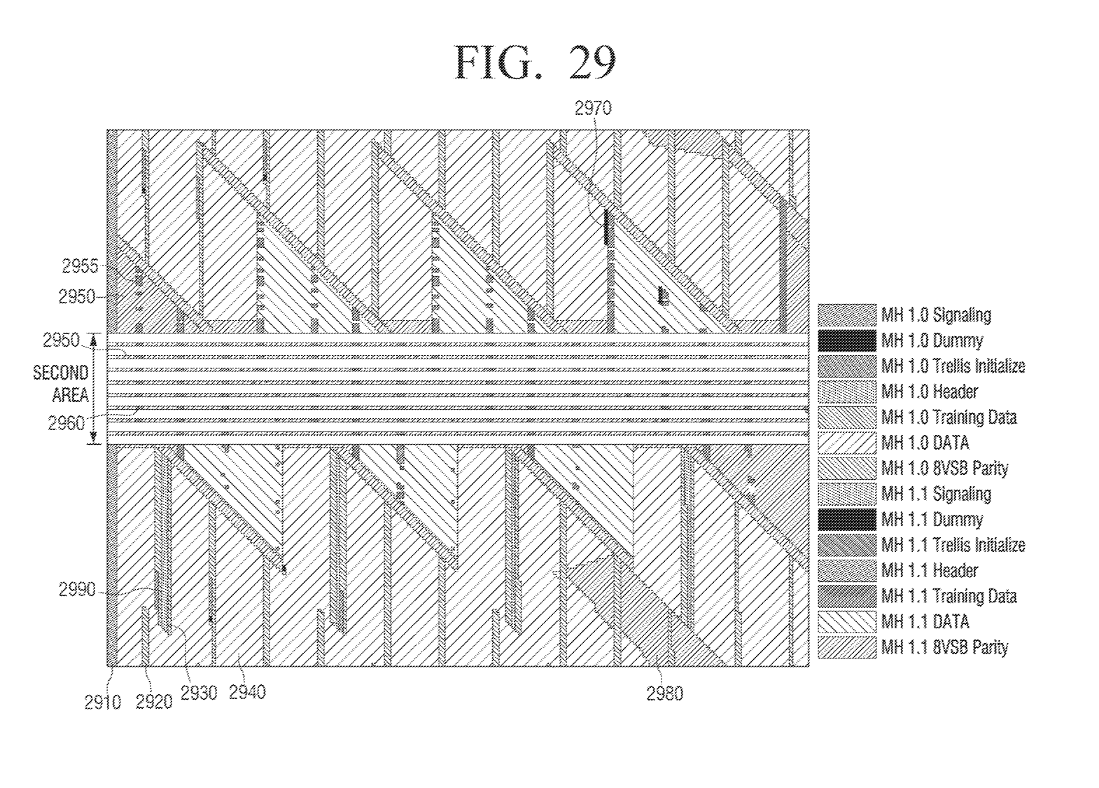

FIG. 29 illustrates a stream construction in which the mobile data and the station data may be arranged by the group formatter 130 according to the first mode according to an exemplary embodiment of transmitting the new mobile data by utilizing the head and tail areas.

In FIG. 29, the new mobile data 2950 and the station data 2960 may be arranged in the determined pattern. Beside the second region, new mobile data and the station data may be arranged in the head and tail areas 2950.

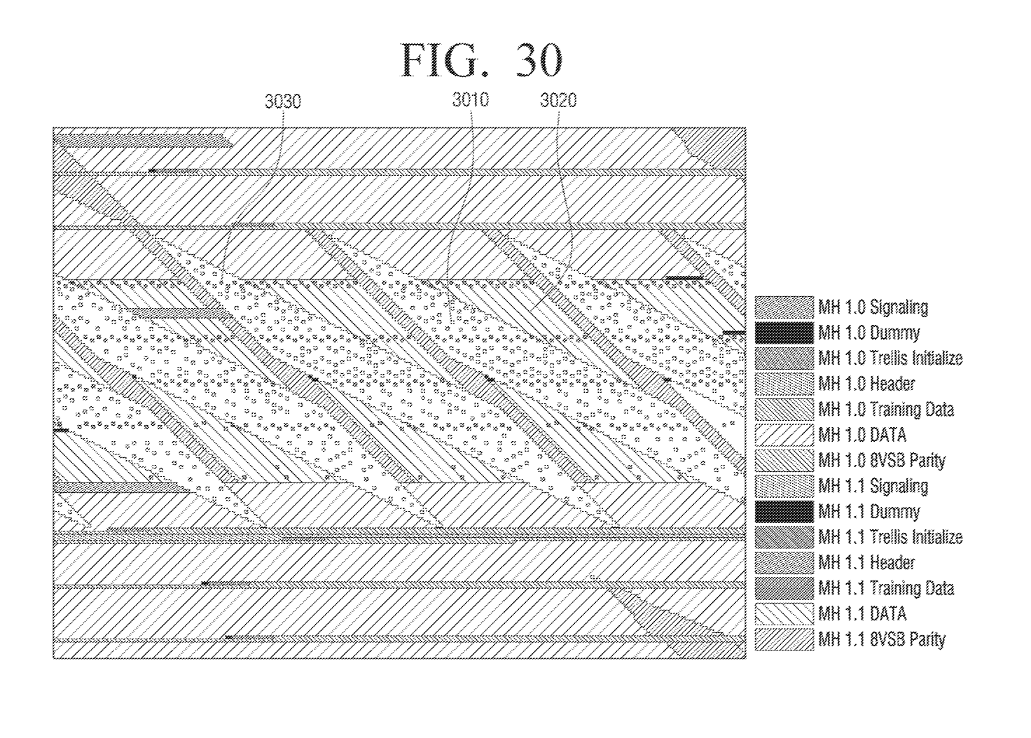

Further, the MPEG header 2910, the station data 2920, the signaling data 2930, the basic mobile data 2940, and the dummies 2970 may be arranged in the vertical direction of the stream. While being arranged, the normal data may be placed in the space within the second region, the encoding and the interleaving may be performed, and the stream in FIG. 30 may be constructed.

FIG. 30 illustrates the stream construction after interleaving under the first mode.

In FIG. 30, new mobile data 3010 and the station data 3030 may be placed in some part of the packets for the normal data. Specifically, the station data may be arranged non-consecutively in the second region to be the long training sequence form similar to the long training sequence in the body area.

The mobile data 2950, arranged in the area corresponding to the head and tail areas in FIG. 29, may be the mobile data 3020 arranged in the head and tail areas. The station data, placed with the mobile data 2950 in FIG. 29, may be arranged with the station data in the second region to be the similar long training sequence station data 3030.

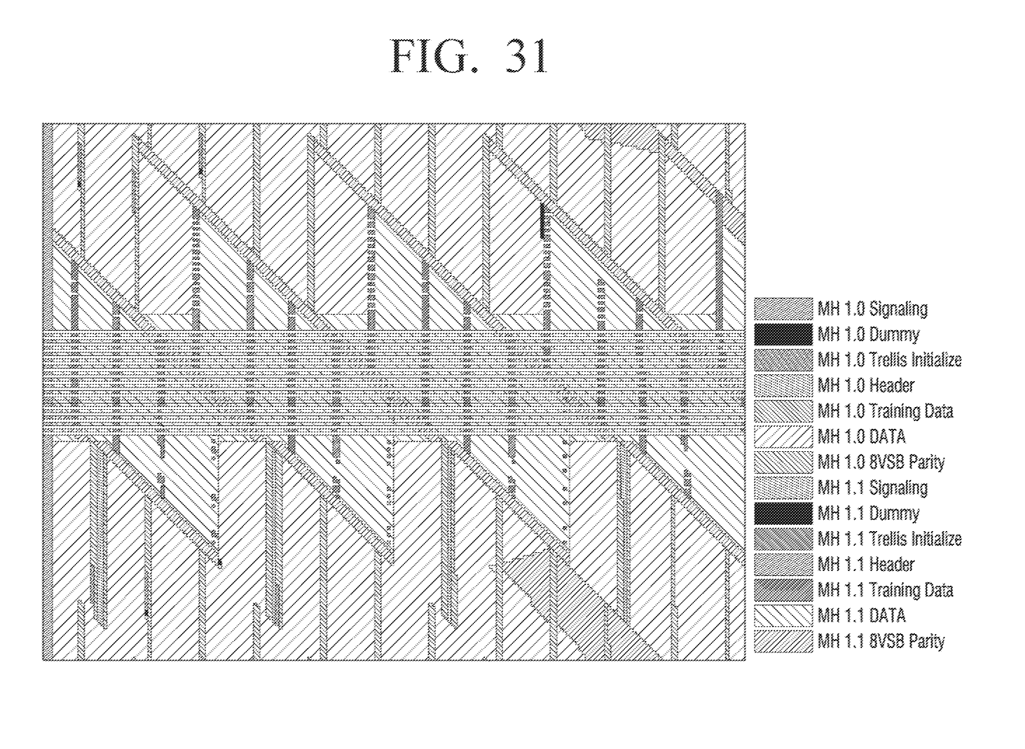

FIG. 31 illustrates a stream construction in which the mobile data and the station data may be placed by the group formatter 130 under the second mode while transmitting new mobile data by utilizing the second region, head and tail areas.

In FIG. 31, the rate of the mobile data included in the second region may increase as compared to FIG. 29. Further, the portion of the mobile data and the station data may increase in FIG. 31.

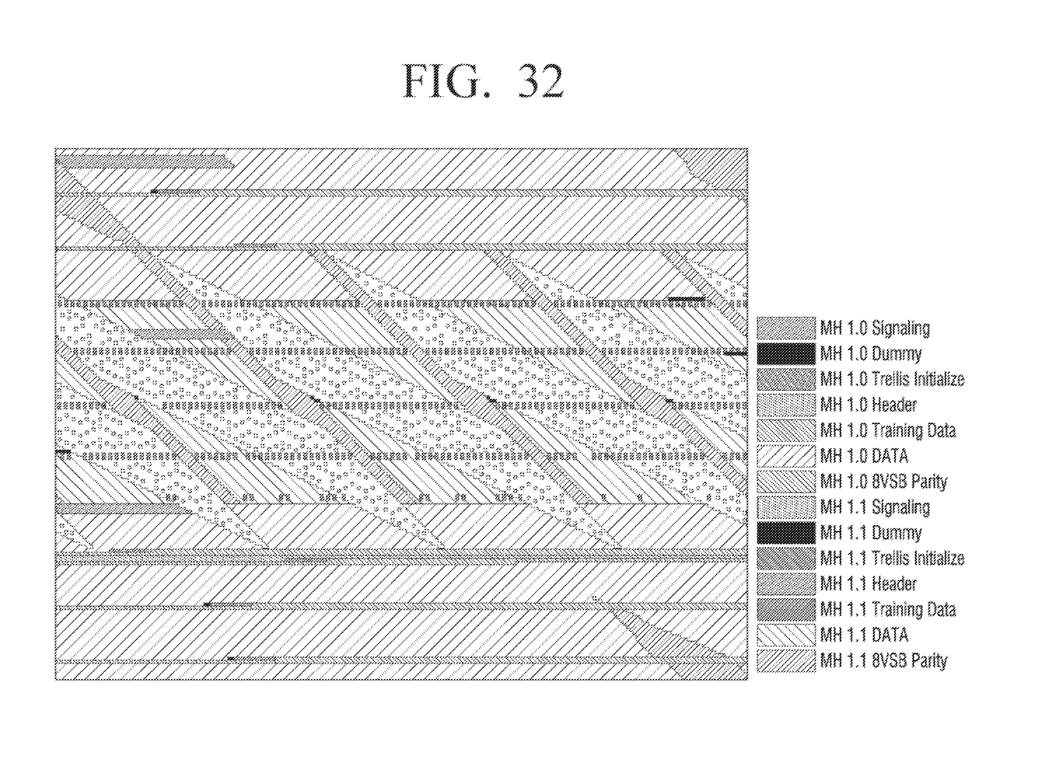

FIG. 32 illustrates that the stream in FIG. 31 may be interleaved. In FIG. 32, the station data in the second region may be formed to be the similar long training sequence more finely compared to the station data in the second region in FIG. 30.

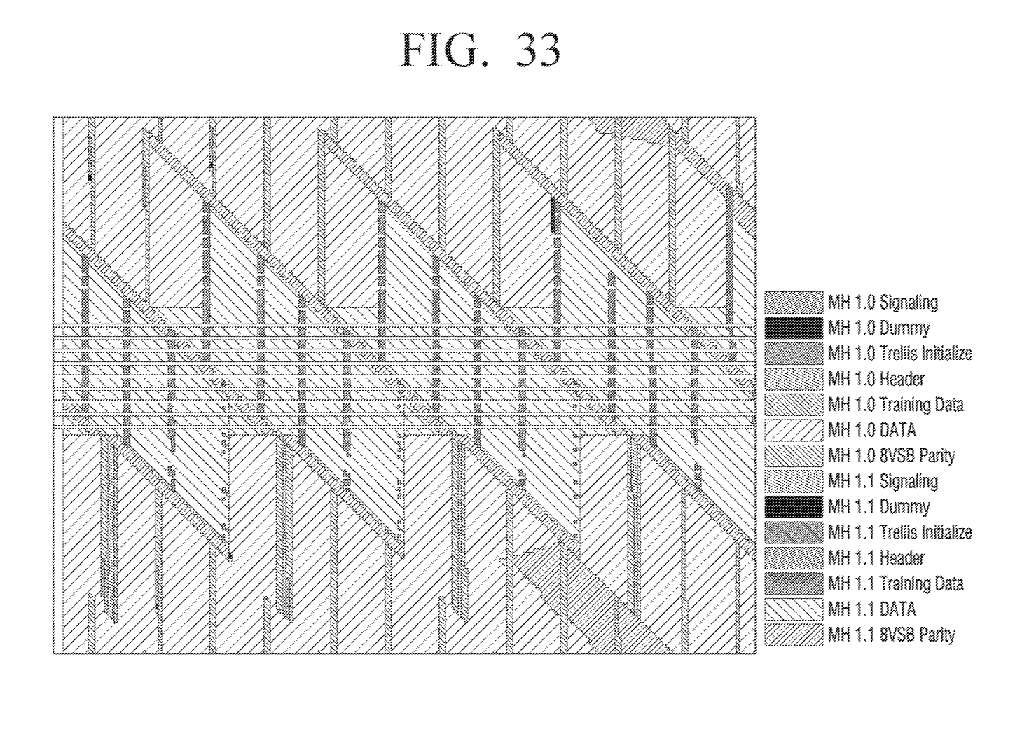

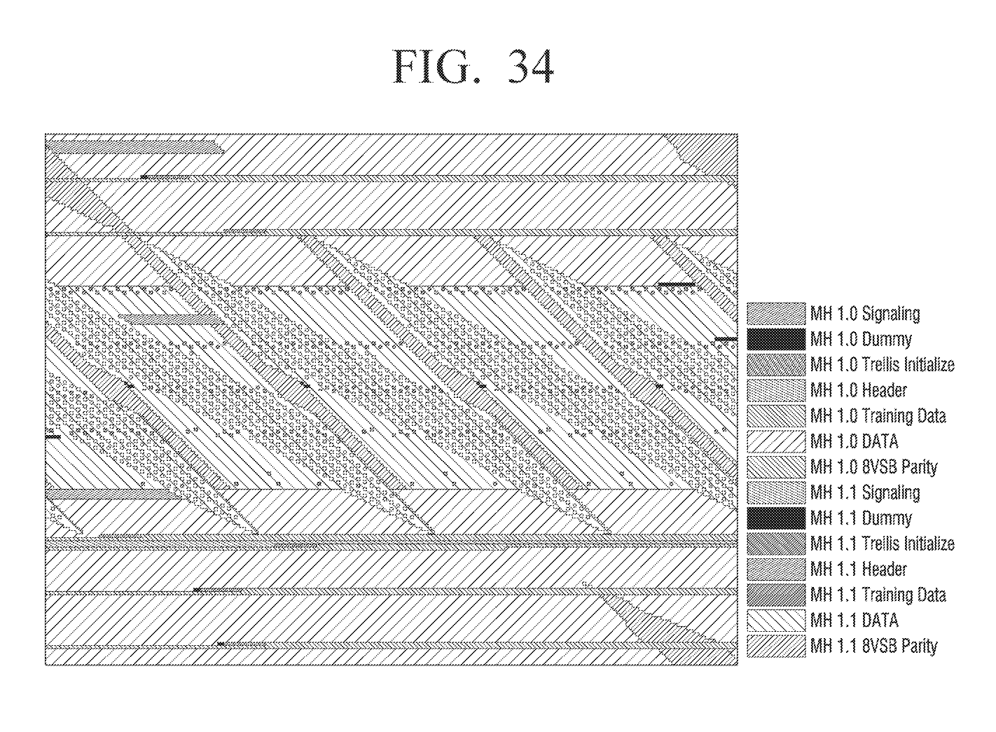

FIG. 33 illustrates a stream construction in which the mobile data and the station data may be arranged by the group formatter 130 under the third mode while transmitting new mobile data by utilizing the second region, head and tail areas. Further, FIG. 34 illustrates that the stream in FIG. 33 may be interleaved.

In FIGS. 33 and 34, the density of the mobile data and the station data may increase compared to the first and second modes.

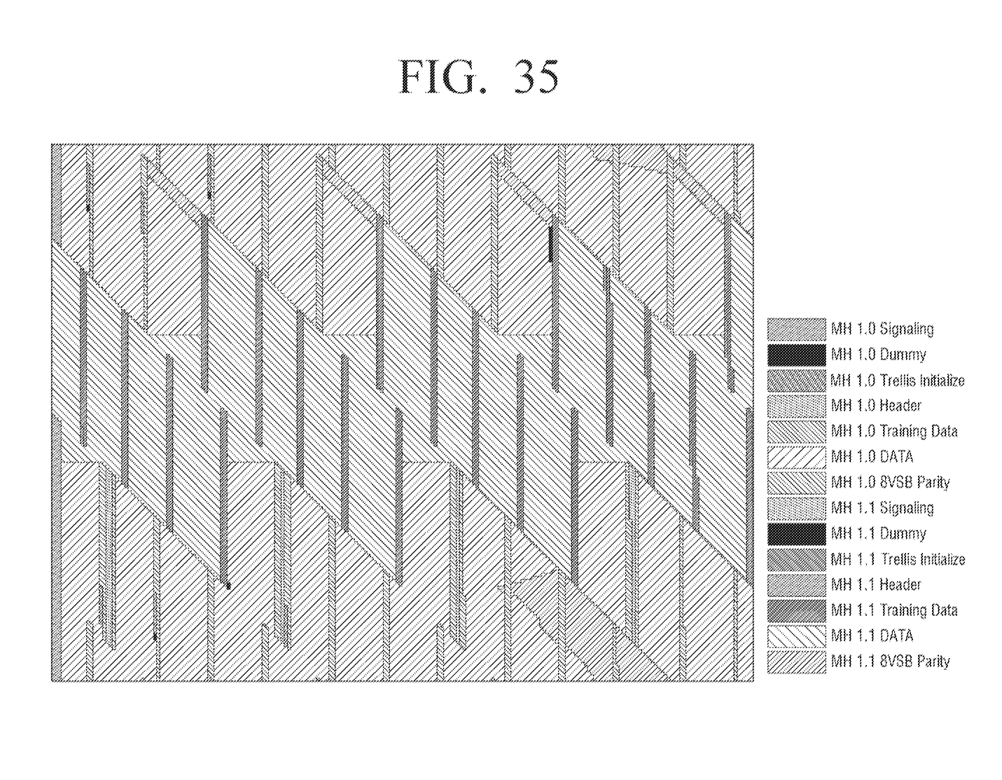

FIG. 35 illustrates a stream construction utilizing the whole normal data areas under the fourth mode while utilizing the whole packets for the normal data and the packets for the basic mobile data in the head and tail areas.

In FIG. 35, the station data may be arranged in the vertical direction in the second region and its surrounding areas, and new mobile data may be filled in the other areas.

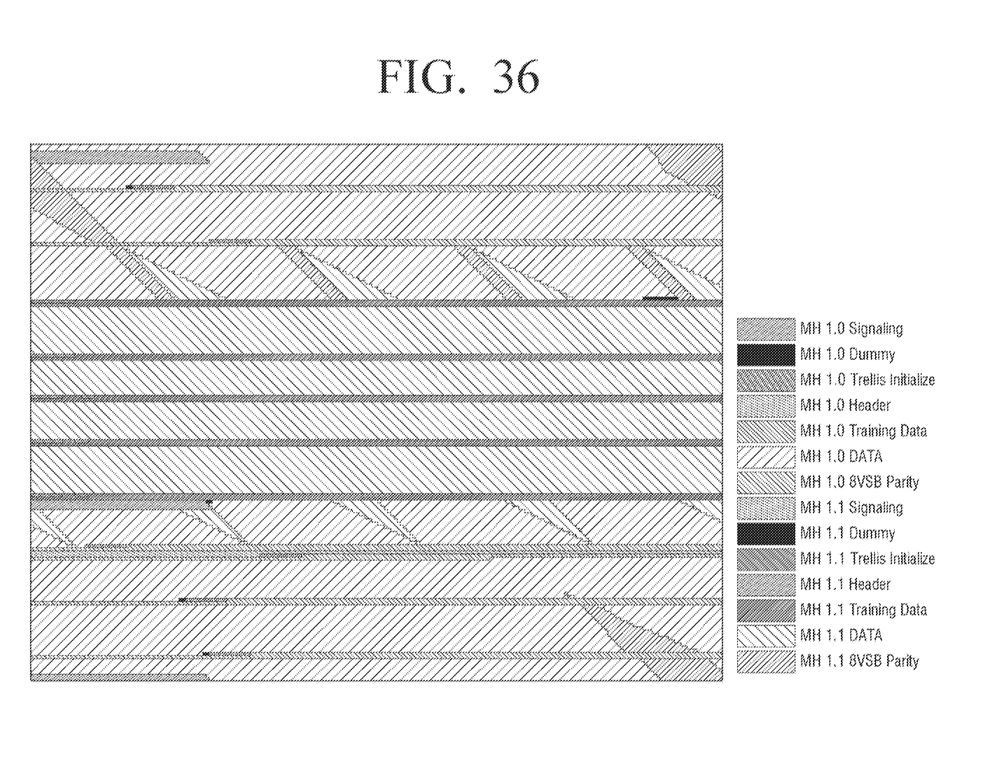

FIG. 36 illustrates that the stream in FIG. 35 may be interleaved. In FIG. 36, the head and tail areas and the whole normal data areas may be filled with new mobile data and the station data. Specifically, the station data may be arranged in the long training sequence form.

Meanwhile, in these areas, the station data may be inserted repeatedly by a plurality of pattern periods, and after interleaving, be the distributed station data.

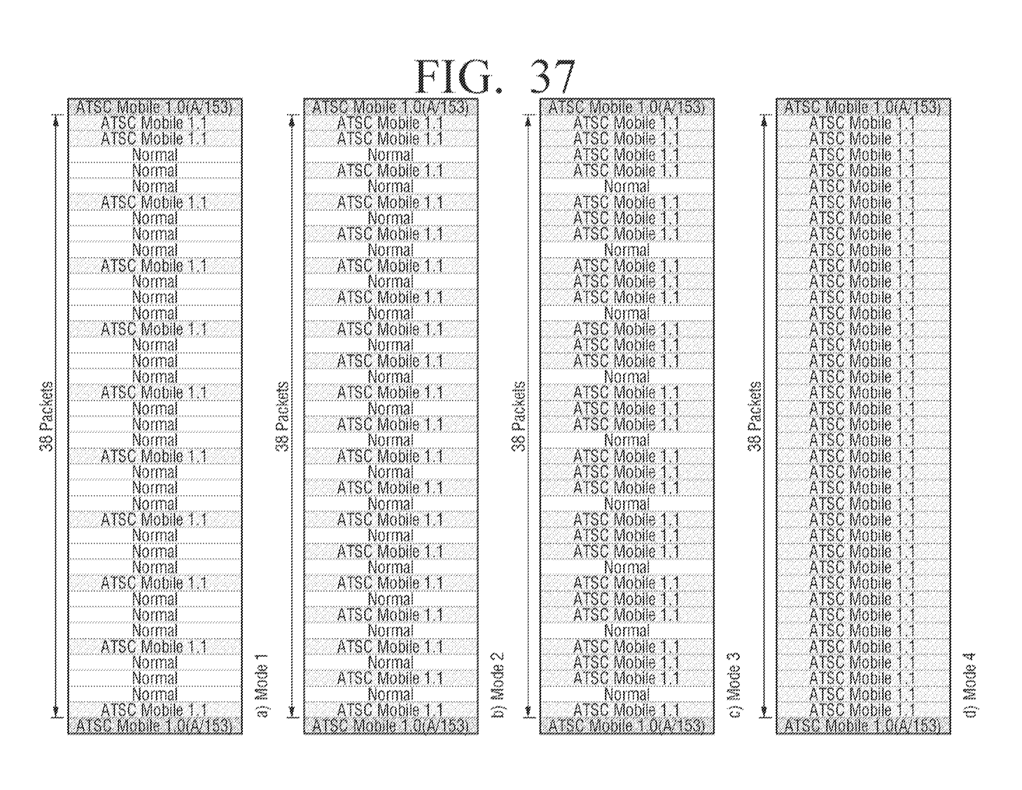

FIG. 37 illustrates the new mobile data inserted into the second region, i.e., the packets for the normal data, for instance, 38 packets, under various modes. For convenience of description, new mobile data may be referred to as the ATSC mobile 1.1 data, or, the 1.1 version data, and the basic mobile data may be referred to as the ATSC mobile 1.0 data, or, the 1.0 version data.

a) In the first mode, the 1.1 version data may be arranged in the first and the last packets. One 1.1 packet and three normal data packets may be arranged repeatedly in the packets between the first and the last. Thus, total 11 packets may be utilized to transmit the 1.1 version data, i.e., new mobile data.

b) In the second mode, the 1.1 version data may be placed in the first and the last packets. One 1.1 packet and one normal data packet may be alternately placed in the packets between the first and the last. Thus, total 20 packets may be utilized to transmit the 1.1 version data, i.e., new mobile data.

c) In the third mode, the 1.1 version data may be placed in the first and the last packets. Three 1.1 packets and one normal data packet may be alternately placed in the packets between the first and the last.

d) In the fourth mode, whole packets corresponding to the second region may be utilized to transmit the 1.1 version data.

The fourth mode may be the compatible mode utilizing the whole packets of the second region to transmit the 1.1 version data or the non-compatible mode placing the 1.1 version data filled in the MPEG header and the parity area for the compatibility with the normal data receiver as well as in whole packets of the second region. Further, a non-compatible mode may be provided in the fifth mode.

In the foregoing description, one-fourth, two-fourths, three-fourths, and four-fourths of the whole packets in the second region may be utilized to transmit the mobile data, corresponding to the first to fourth modes. However, because the number of the packets is 38, i.e., not a multiple of 4, several packets may be fixed to be utilized to transmit new mobile data or the normal data packet and other packets may be divided by 4 to be the modes. In sections (a), (b), and (c) of FIG. 37, the determined number of the packets, i.e., two packets, may be fixed, and 36 packets may include the 1.1 data by one-fourth, two-fourths, and three-fourths.

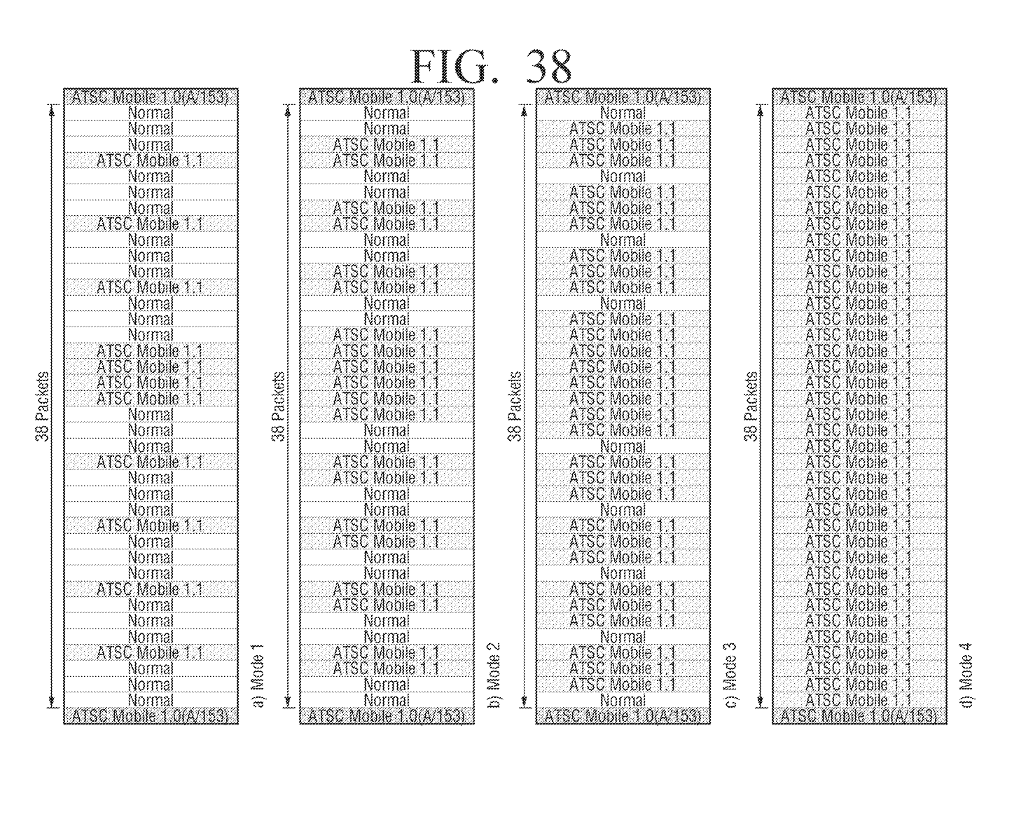

FIG. 38 illustrates the arrangement pattern of the mobile data under another mode.

In FIG. 38, in whole packets of the second region, in other words, in the central packets of 38 packets based on the position of the stream, may be arranged two 1.1 version data. In the other packets may be arranged the 1.1 version data and the normal data by the determined ration under each mode.

a) In the first mode, the mobile data may be arranged in the form which, regarding the other packets than the central two packets, three normal data packets and one 1.1 version data packet may repeat in the upper part, and one 1.1 version data packet and three normal data packets may repeat in the lower part.
b) In the second mode, the mobile data may be arranged by the form in which, regarding the other packets than the central two packets, two normal data packet and two 1.1 version data packet may repeat in the upper part and two 1.1 version data packet and two normal data packet may repeat in the lower part.
c) In the third mode, the mobile data may be arranged by the form in which, regarding the other packets than the central two packets, one normal data packet and three 1.1 version data packets may repeat in the upper part and three 1.1 version data packets and one normal data packet may repeat in the lower part.
d) In the fourth mode, the whole packets may be arranged with the 1.1 version data, which is the same as the fourth mode in FIG. 37.

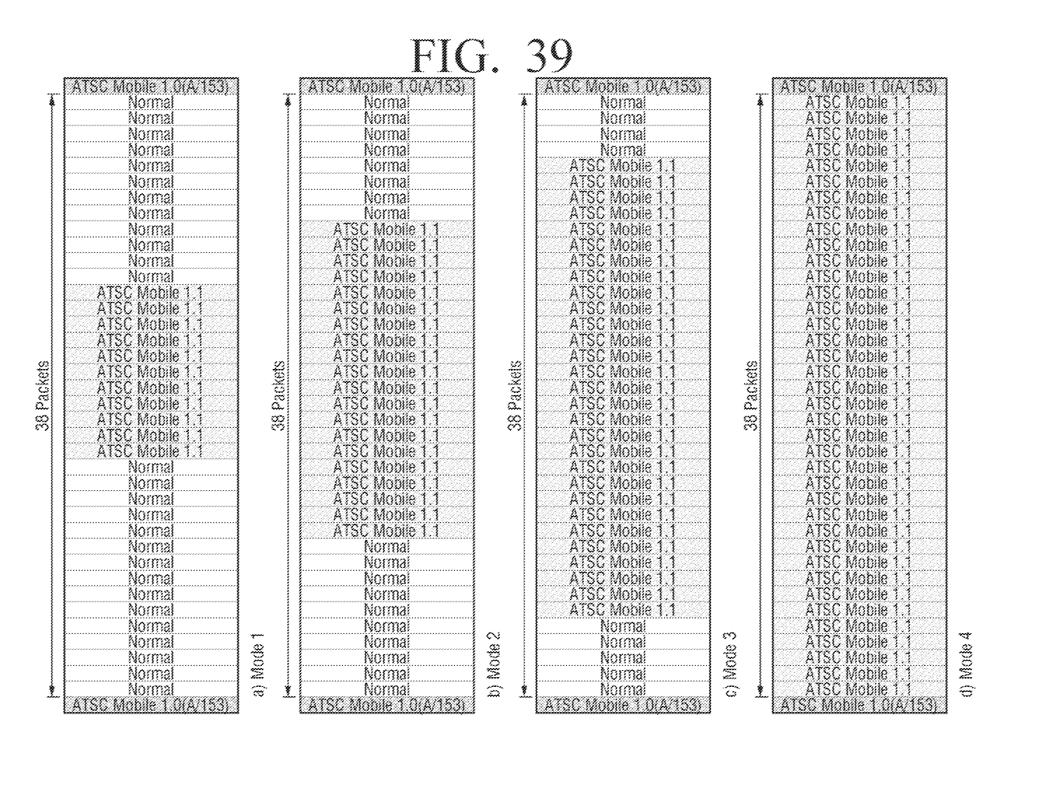

FIG. 39 illustrates an exemplary embodiment in which the 1.1 version data may be arranged successively moving from the central packet to the upper and lower direction based on the stream position.

In the first mode (section (a) of FIG. 39), 11 packets of the whole packets in the second region may be arranged successively moving from the center to the upper and lower direction.

In the second mode (section (b) of FIG. 39), 20 packets may be arranged successively from the center to the upper and lower direction. In the third mode (section (c) of FIG. 39), 30 packets may be arranged successively from the center to the upper and lower direction. In the fourth mode (section (d) of FIG. 39), whole packets may be filled with the 1.1 version data.

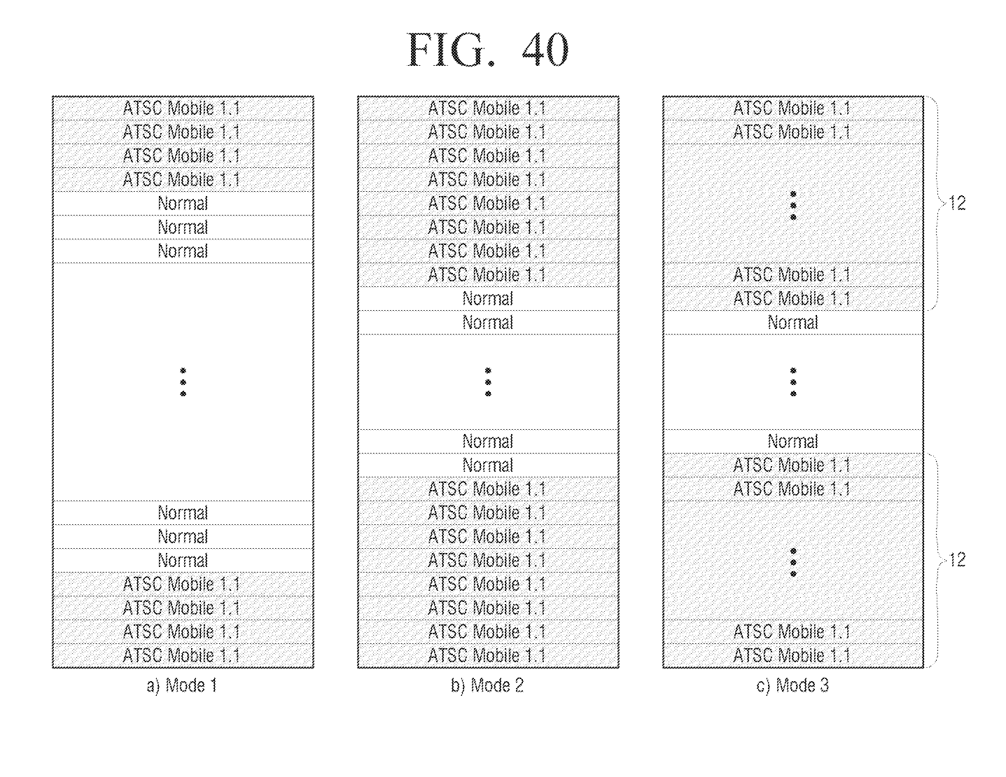

FIG. 40 illustrates a stream construction in which the mobile data may be filled from upper and lower packet to the central direction, in other words, the reverse direction in FIG. 39. Further, in FIG. 40, the number of new mobile data packets under the first to fourth modes may be set differently from those in the foregoing exemplary embodiments.

In the first mode (section (a) of FIG. 40), four 1.1 version data packets may be arranged from the upper packet to the lower direction, and four 1.1 version data packets may be arranged from the lower packet to the upper direction. Thus, 8 1.1 version data packets may be placed.

In the second mode (section (b) of FIG. 40), 8 1.1 version data packets may be arranged from the upper packet to the lower direction, and 8 1.1 version data packets may be arranged from the lower packet to the upper direction. Thus, 16 1.1 version data packets may be placed.

In the third mode (section (c) of FIG. 40), 12 1.1 version data packets may be arranged from the upper packet to the lower direction, and 12 1.1 version data packets may be arranged from the lower packet to the upper direction. Thus, 24 1.1 version data packets may be placed.

The other packets may be filled the normal data. The packet pattern under the fourth mode may be the same as in FIGS. 37 to 39.

Meanwhile, FIGS. 37 to 40 exclude the inserting the station data. However, it is understood that the station data may be inserted in some part of the packet such as the mobile data, or in some part of another packet, or in the whole payload area. The method of inserting the station data is described in the foregoing.

Further, in the fifth mode, i.e., in the non-compatible mode, new mobile data may additionally be filled in the RS parity area and the header area within the basic mobile data area, not within the normal data area.

Meanwhile, the fifth mode may be provided independently from the fourth mode; the fourth mode or fifth mode may be combined with the first to third modes and the four modes may be provided.

FIGS. 37 to 40 illustrate a method of inserting new mobile data in the second region, i.e., the packets for the normal data, for instance, 38 packets under various modes. According to the determined mode in FIGS. 37 to 40, the method of placing new mobile data in the packets for the normal data may be different such as the first to the fourth modes, as described above. The fourth mode may fill new mobile data in 38 packets only, or may fill new mobile data in 38 packets, and additionally in the RS parity area and the header area. Further, the mode may include the first to fifth modes.

Meanwhile, the mode may determine how many packets of 38 packets may be distributed for new mobile data and how the blocks may be constructed within M/H group. If the foregoing mode is referred to as the scalable mode, by utilizing two bits of the signaling field, section (a) of FIG. 37 may be referred to as Scalable Mode 00, section (b) of FIG. 37 as Scalable Mode 01, section (c) of FIG. 37 as Scalable Mode 10, and section (d) of FIG. 37 as Scalable Mode 11. Likewise in section (d) of FIG. 37, although 38 packets may be set for new mobile data, 118 packets for the basic mobile data and 38 packets for the new mobile data may be one M/H group.

By the block construction within the group, two scalable modes may be set. For instance, one mode may set 19.4 Mbps of the transmitting data rate only for the mobile data, and the other mode may set the rate not only for the mobile data. Although 38 packets in one slot may be distributed for the mobile data, M/H groups having different block constructions from each other may be generated.

If 19.4 Mbps of the transmitting data rate is set only for the mobile data and the normal data rate is 0 Mbps, the broadcasting manufacturer may provide the service considering the receiver receiving the mobile data without the receiver receiving the normal data. The area having the placeholder for the MPEG header and the RS parity set to be compatible with the receiver receiving the normal data may be referred to as the area for the mobile data. The transmitting capacity of the mobile data may increase to about 21.5 Mbps.

To set 19.4 Mbps of the transmitting data rate only for the mobile data, each of 156 packets in all M/H slots constructing an M/H frame may be distributed for the mobile data. 16 slots in each M/H sub-frame may be set under Scalable Mode 11. 38 packets for the normal data may be filled with the mobile data, and in the area having the placeholder for the MPEG header and the RS parity in the body area may generate Block SB5. If 16 slots in M/H sub-frame may be set under Scalable Mode 11, and if the RS frame mode is 00, i.e., Single Frame Mode, SB5 may not be provided, and the placeholder corresponding to SB5 may be absorbed in each M/H block, B4, B5, B6, and B7. If 16 slots in the M/H sub-frame are set under the Scalable Mode 11, and if the RS frame mode is 01, i.e., Dual Frame Mode, the placeholder on SB5 position may construct Block SB5. The placeholder area for the RS parity in the head and tail beside the body area may be filled with the mobile data, and the placeholder for the RS parity may be absorbed in the block to which the segment having the placeholder belongs. The placeholder placed in the segment of M/H blocks B8 and B9 may be absorbed in SB1. The placeholder placed in the first 14 segments of M/H block B10 may be absorbed in SB2. The placeholder placed in the last 14 segments of M/H block B1 in the next slot may be absorbed in SB3. The placeholder placed in the segment of M/H blocks B2 and B3 in the next slot may be absorbed in SB4. As in FIG. 20, the area for the MPEG header and the RS parity may not be included in the group format after interleaving.

Meanwhile, if 19.4 Mbps of transmitting data rate is set not only for the mobile data and if the normal data is not 0 Mbps, the broadcasting manufacturer may provide the service considering the receiver receiving the normal data and the mobile data. To keep the compatibility with the receiver receiving the normal data, the MPEG header and the RS parity may be transmitted without being recalled as the mobile data. As described in the compatible mode, some part of 38 packets may be filled with new mobile data, or in whole 38 packets may be filled with new mobile data and not in the MPEG header and the RS parity area. Thus, even though in some slot, 38 packets for the normal data may be filled with the mobile data, SB5 corresponding to the MPEG header and the RS parity area in the body area may not be generated.

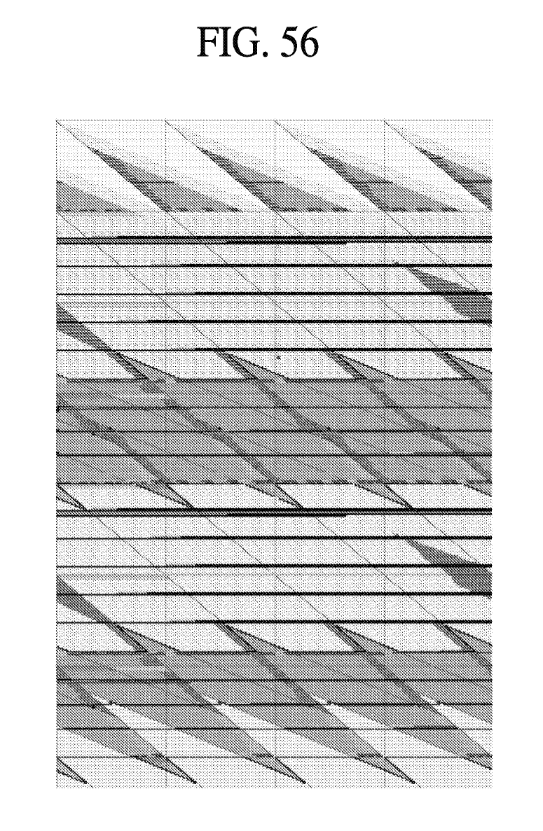

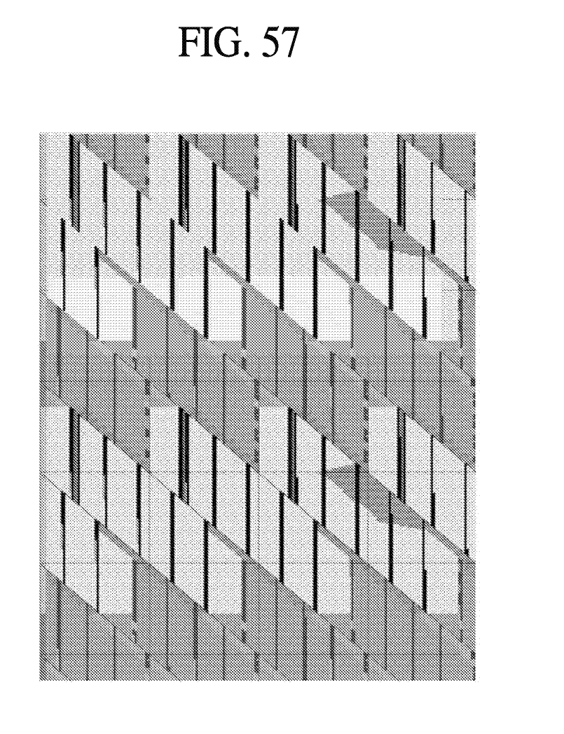

FIG. 57 illustrates a group format on a packet basis considering the compatibility before interleaving if 38 packets for the normal data are filled with the mobile data. As in FIGS. 37 to 40, 38 packets may be distributed for the mobile data, in the formatting the group on a segment basis after interleaving as illustrated in FIG. 56, the area of the MPEG header and the RS parity may be kept and SB5 area may not be generated. The group formatting may correspond to the fourth mode, or Scalable Mode 11. Further, by considering the compatibility, the fourth mode filling new mobile data only to 38 packets may be referred to as Scalable Mode 11a.

Meanwhile, if Scalable Mode 11, the non-compatible mode, is utilized, the slots filling new mobile data under another mode may not be utilized. Total slots, i.e., 0 to 15 slots, may be filled with new mobile data under Scalable Mode 11. The first to fourth modes may be utilized after combining with each other.

In the normal data area of each slot, the mobile data may be filled in various forms. Thus, the form of the slot may change by setting the frame mode and the mode.

If the four modes are provided, each slot distributed to the first to fourth modes may be referred to as the first type slot to fourth type slot.

In the digital broadcasting transmitter, the same type of the slot may be constructed; however, by the determined number of slots, different types of the slot may repeat to construct the stream.

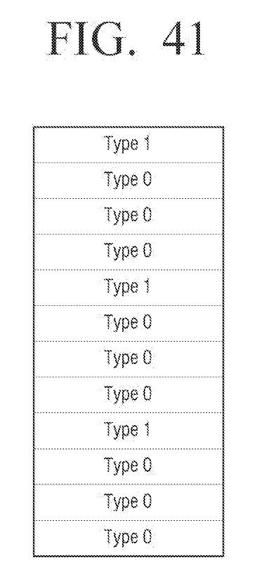

As shown in FIG. 41, the data preprocessor 100 may arrange the mobile data so that one first type slot and three zero type slots may repeat alternately. The zero type slot may place the normal data in the packets for the normal data.

The slot type may be called by utilizing the part of the signaling data such as the TPC or the FIC.

Meanwhile, if the frame mode is set as 1, the mode may be one of a plurality of modes such as the first to fourth modes. The fourth mode may be Scalable Mode 11 or Scalable Mode 11a. The fourth mode may be one of the five modes including Scalable Mode 11 and Scalable Mode 11a. Furthermore, it may be divided by at least one compatible mode and the non-compatible mode, i.e., Scalable Mode 11.

Regarding an exemplary embodiment including the first to fourth modes, the slots corresponding to the modes may be 1-1, 1-2, 1-3, and 1-4 type slots.

1-1 type slot may place 38 packets for the first mode, 1-2 type slot may place 38 packets for the second mode, 1-3 type slot may place 38 packets for the third mode, and 1-4 type slot may place 38 packets for the fourth mode.

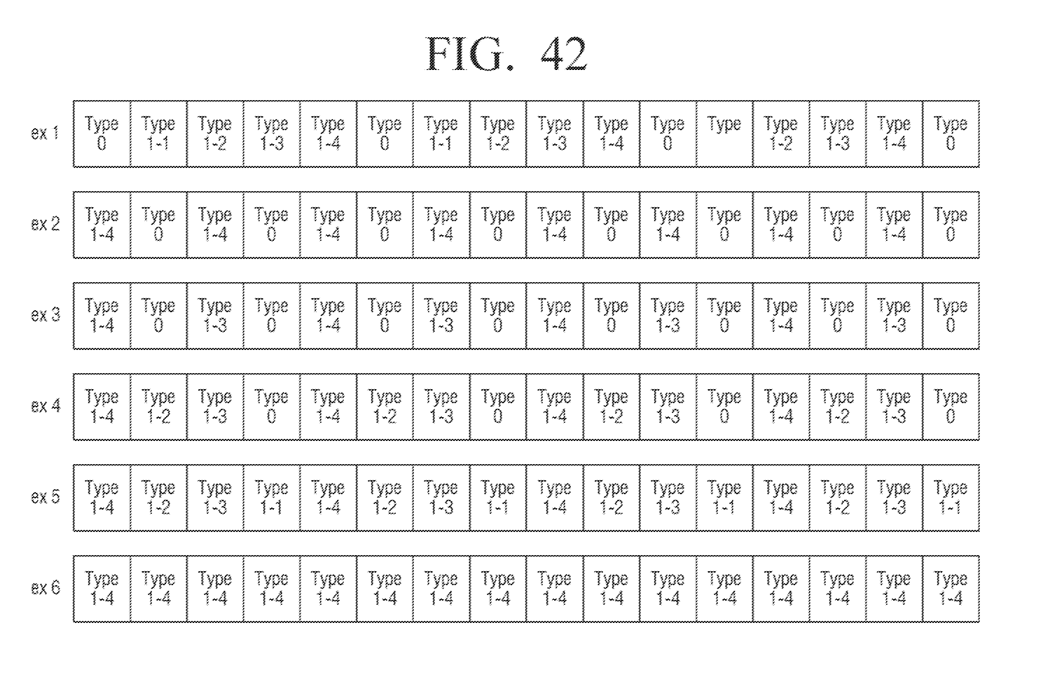

FIG. 42 illustrates a stream in which a zero type slot and 1-1, 1-2, 1-3, and 1-4 type slots may successively repeat.

In Example 2 of FIG. 42, 1-4 type slot and the zero type slot may alternately repeat in the stream. Because the fourth mode may fill the normal data area with the mobile data as described above, Example 2 illustrates that the slot for the whole area of the normal data utilized by the mobile data and the slot for the normal data may be placed alternately.

Further, as in Examples 3, 4, and 5, various types of slots may repeat by various methods. Specifically in Example 6, all slots may be unified by one type to construct the stream.

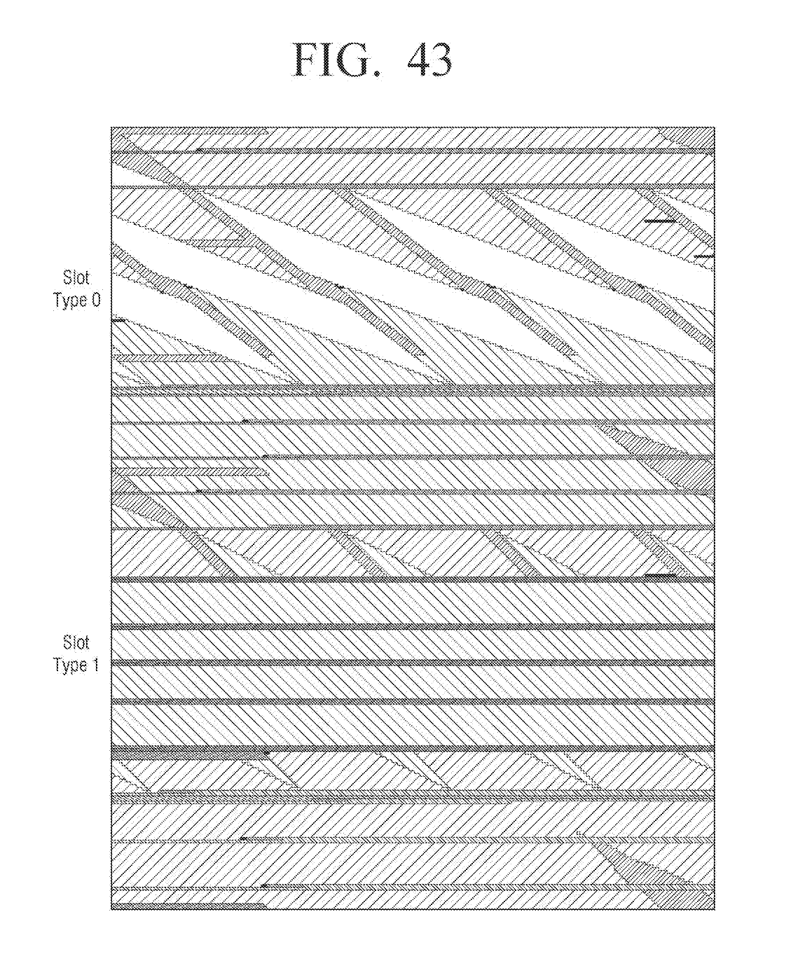

FIG. 43 illustrates a stream construction according to Example 2 of FIG. 42. In the zero type slot, the normal data area may be utilized for the normal data. However, in the first type slot, the whole normal data area may be utilized for the mobile data while the station data may be arranged in the long training sequence form. The slot type may vary.

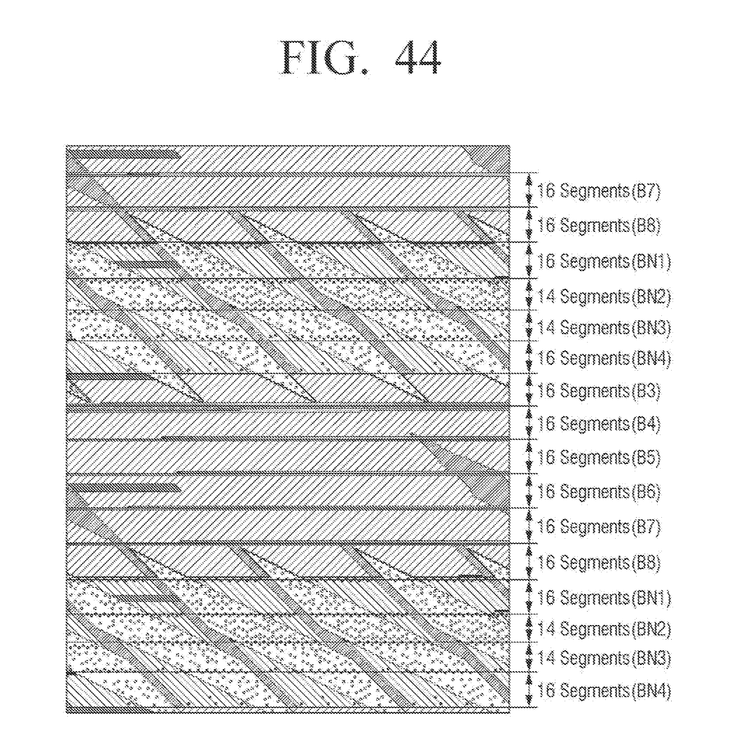

FIGS. 44 to 47 illustrate a stream construction for a method allocating the blocks under the first to fourth modes. The first and second region may be divided by a plurality of blocks in each.

The data preprocessor 100 may block-code on one block basis or on a plurality of block combination basis by the determined block mode.

FIG. 44 illustrates a block division under the first mode. In FIG. 44, the body area may be divided to be B3 to B8, and the head and tail areas may be divided to be BN1 to BN4.

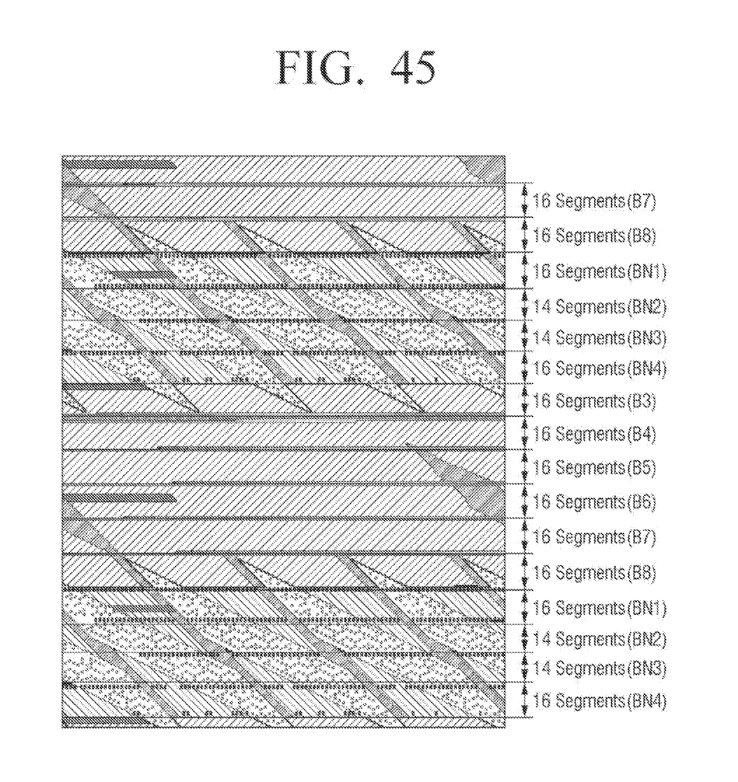

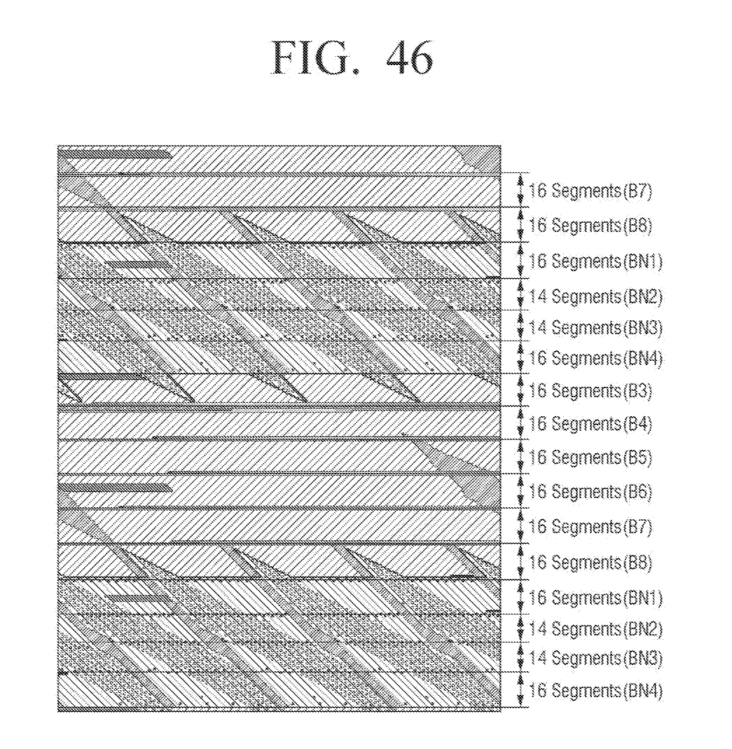

FIGS. 45 and 46 illustrate a block division under the second and third modes. As in FIG. 44, the body area and the head and tail areas may be divided to be a plurality of blocks in each.

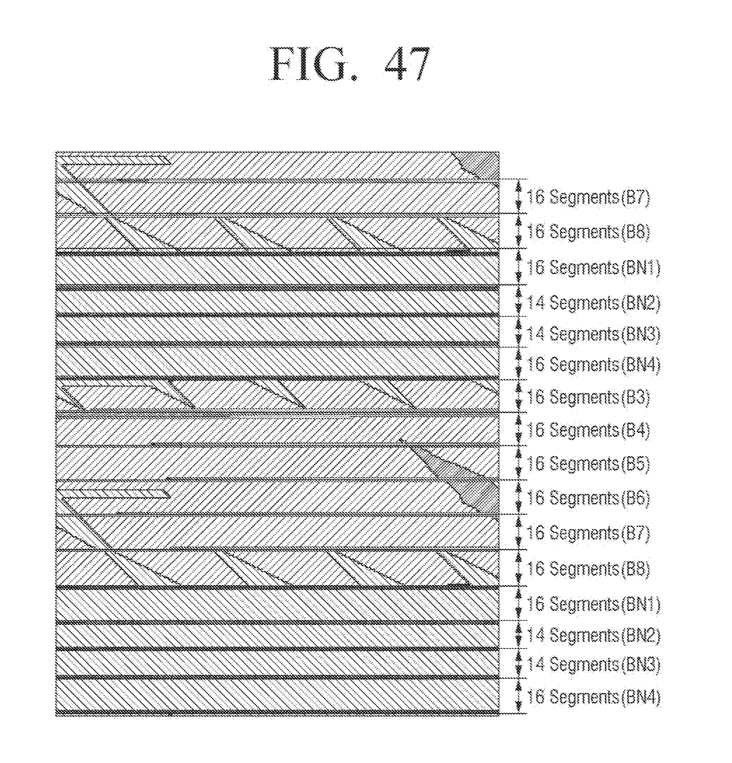

Meanwhile, FIG. 47 illustrates a block division under the fourth mode filling the mobile data in the head and tail areas. Because the normal data area may be filled with the mobile data, the MPEG header of the body and the parity of the normal data may not be utilized. FIG. 47 shows these parts as BN5. BN5 may be filled with new mobile data under the non-compatible mode, or may be utilized for the header and parity under the compatible mode. Compared to FIGS. 44 to 46, the head and tail areas may be divided to be BN1 to BN5 in FIG. 47.

The block processor 120 of the data preprocessor 100 may convert the RS frame on a block basis. As in FIG. 7, the block processor 120 may include the first converter 121. The first converter 121 may combine the mobile data in the RS frame by the determined block mode and output the SCCC block.

The block mode may be set variously.

For instance, if the block mode is set as 0, each block, BN1, BN2, BN3, BN4, or BN5 may be outputted to be one SCCC block and be the SCCC coding basis.

Meanwhile, if the block mode is set as 1, combining the blocks may construct the SCCC block. Specifically, BN1+BN3=SCBN1, BN2+BN4=SCBN2, and BN5 may be SCBN3.

Meanwhile, the basic mobile data placed in the first region besides the mobile data in the second region may be combined by a single or a plurality of numbers and block-coded according to the block mode. Because the related art ATSC-MH is the same as the above process, it may not be further explained in this specification.

The information of the block mode may be subscribed in the basic signaling data or included in the area of new signaling data, and informed to the receiving units. The receiving units may find the information of the block mode, properly decode accordingly, and recall the original stream.

Meanwhile, as described above, the data that can be block-coded may be combined to construct the RS frame. The frame encoder 110 of the data preprocessor may properly combine each frame portion and generate the RS frame so that the block processor 120 may properly block-code.

Specifically, SCBN1 and SCBN2 may be combined to generate the RS frame 0, and, SCBN3 and SCBN4 may be combined to generate the RS frame 1.

Further, SCBN1, SCBN2, SCBN3, and SCBN4 may be combined to generate the RS frame 0, and SCBN5 may generate the RS frame 1.

Further, SCBN1+SCBN2+SCBN3+SCBN4+SCBN5 may generate one RS frame.

The block of the basic mobile data and new added block, SCBN1 to SCBN5, may be combined to generate the RS frame.

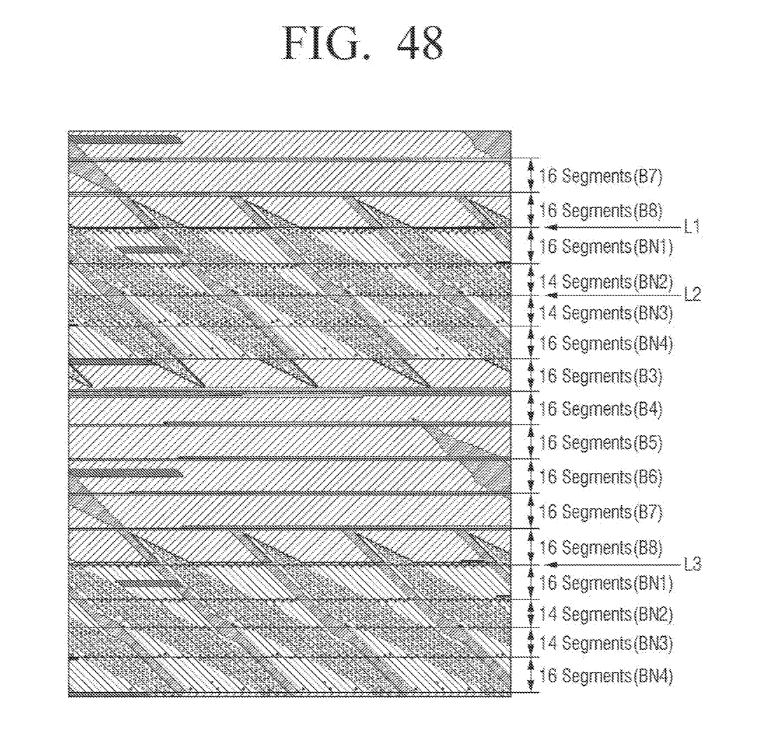

FIG. 48 illustrates several other methods defining the starting of the RS frame according to exemplary embodiments. The related art ATSC-MH may divide the RS frame between BN2 and BN3. However, by inserting the mobile data and the station data in the normal data area, the starting point of the RS frame may be defined by another method.

For instance, based on the boundary between BN1 and B8, the RS frame may start. The RS frame starting point may be defined by the combination of block-coding.

Meanwhile, the construct information of the RS frame may be included in the basic signaling data or in the area of new signaling data, and be provided to the receiving units.

As described above, because new mobile data and the station data may be inserted in the area for the normal data and the area for the basic mobile data, various types of information may be informed to the receiving units. The information may be transmitted by utilizing the reserve bit in the TPC area of the ATSC-MH standard, or by creating and utilizing a new signaling data area. The new signaling area may be positioned in the head/tail because the new signaling area should be in the same position under every mode.

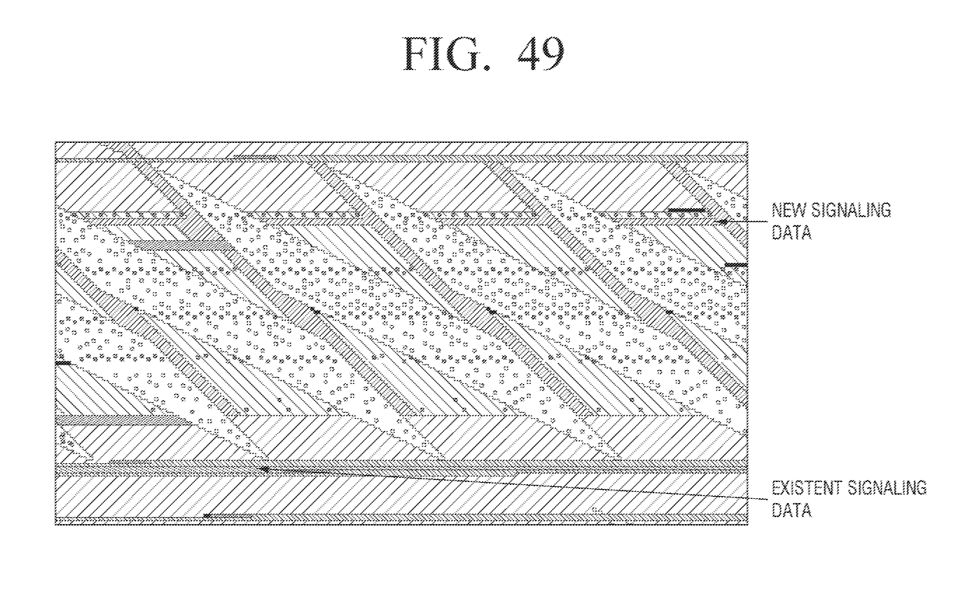

FIG. 49 illustrates a stream construction including an arrangement position of the basic signaling data and new signaling data.

In FIG. 49, the basic signaling data may be placed between the long training sequences in the body area, and new signaling data may be placed within the head/tail area. New signaling data encoded by the signaling encoder 150 may be inserted in the predetermined position as drawn in FIG. 49 by the group formatter 130.

Meanwhile, the signaling encoder 150 may utilize codes other than those of the related art signaling encoder, or may code on another code rate for the improvement of the functions.

Thus, the method adding the basic RS code and utilizing ⅛ PCCC code may be implemented, or the method utilizing RS+¼ PCCC code and sending the same data twice may be implemented to have effects in utilizing ⅛ rate PCCC code.

Meanwhile, as described above, because the station data may be included in the transport stream, the memory in the trellis encoder may be initialized before trellis-encoding the station data.

As in Mode 4, if the long training sequences are set, the corresponding sequences may be processes by one initialization. However, if the station data are placed non-consecutively in other modes, initialization may be done several times. Further, if the memory is initialized to be 0, the symbol of Mode 4 may be difficult to generate.

So that the symbol as in Mode 4 can be generated in Modes 1 to 3, the memory value of the trellis encoder in Mode 4 is in the same position without trellis resetting, i.e., the register value may be loaded to the trellis encoder. The memory values of the trellis encoder in Mode 4 may be stored in a table format, and the trellis encoder may be implemented by the corresponding position value in the stored table. Further, by having another trellis encoder operating in Mode 4, the values from the trellis encoder may be utilized.

In summary, the mobile data may be provided in various methods by utilizing the normal data area and the basic mobile data area in the transport stream. Compared to the related art ATSC standard, a more proper stream may be provided to transmit the mobile data.

[Signaling]

By adding new mobile data and the station data to the transport stream, informing the receiving units to process these data may be utilized. Informing may be implemented by various methods.

First, by utilizing the data field sync used in transmitting the basic mobile data, new mobile data may be informed.

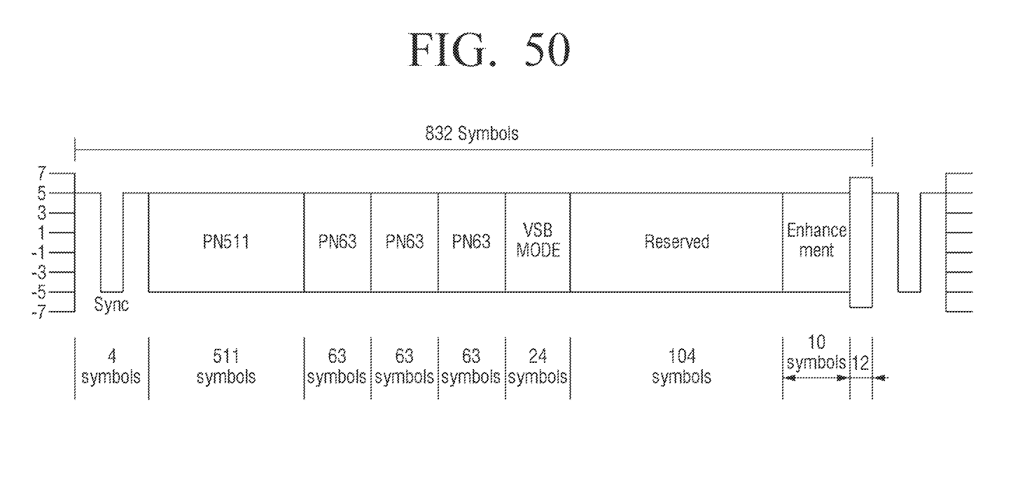

FIG. 50 illustrates an exemplary embodiment of the data field sync. In FIG. 50, the data field sync may include total 832 symbols, and 104 symbols of the total symbols may correspond to the reserve area. In the reserve area, 83 to 92 symbols, i.e., 10 symbols may correspond to the Enhancement area.

If the 1.0 version data are included, 85 symbol may be set as +5, other symbols, 83, 84, and 86 to 92 maybe set as −5 in each odd place of the data field. In each even place of the data field, the signals of the odd place may be vice versa. By utilizing 86 symbols, the inclusion of the 1.1 version data may be informed.

Meanwhile, the inclusion of the 1.1 version data may be informed by another symbol of the Enhancement area. One or a plurality of symbols besides 85 symbol may be set as +5 or other values, and the inclusion of the 1.1 version data may be informed. For instance, 87 symbol may be utilized.

The data field sync may be generated by the control unit 310, the signaling encoder 150, and another provided field sync generator (not illustrated) in FIG. 3, provided by the sync MUX 470 in FIG. 4, and multiplexed with the stream by the sync MUX 470.

Second, by utilizing the TPC, the determining of the 1.1 version data may be informed. The TPC may include the following syntax:

TABLE 1
Syntax No. of Bits Format

| | | |
|---|---|---|
| TPC_data { sub-frame_number slot_number | 34743322222 | uimsbfuimsbf |
| parade_id starting_group_number | 222545215 | uimsbfuimsbf |
| number_of_groups_minus_1 | | uimsbfuimsbf |
| parade_repetition_cycle_minus_1 rs_frame_mode | | bsIbfbsIbfbsIbf |
| rs_code_mode_primary rs_code_mode_secondary | | bsIbfbsIbfbsIbf |
| sccc_block_mode sccc_outer_code_mode_a | | bsIbfbsIbfuims |
| sccc_outer_code_mode_b sccc_outer_code_mode_c | | bfuimsbfuims |
| sccc_outer_code_mode_d fic_version | | bfbsIbfbsIbf |
| parade_continuity_counter total_number_of _groups | | |
| reserved tpc_protocol_version} | | |

In Table 1, the TPC information may have the reserved area. Thus, by utilizing one or a plurality of bits in the reserved area, the packets for the normal data, in other words, whether the second region packets may include the mobile data, the inclusion position, whether new station data may be added, the addition position, or others may be signaled.

The inserted information may be summarized in the following Table 2:

TABLE 2

| Necessary field | Bits (changeable) |
|---|---|
| 1.1 frame mode | 3 |
| 1.1 mobile mode | 2 |
| 1.1 SCCC block mode | 2 |
| 1.1 SCCCBM1 | 2 |
| 1.1 SCCCBM2 | 2 |
| 1.1 SCCCBM3 | 2 |
| 1.1 SCCCBM4 | 2 |
| 1.1 SCCCBM5 | 2 |

In Table 2, 1.1 Frame Mode may indicate the information determining whether the packets for the normal data are utilized by the normal data, or whether by new mobile data, in other words, to the 1.1 version data.

1.1 Mobile Mode may indicate in which pattern the mobile data are arranged in the packets for the normal data. By utilizing 2 bits, writing one of the values, “00,” “01,” “10,” and “11,” one of the four modes such as above Modes 1 to 4 may be marked. Thus, the stream may be placed in the patterns of FIGS. 29, 31, 33, 35, 37, 38, 39, and 40, and the receiving parts may check the information of the mobile mode, and the arrangement position of the mobile data.

1.1 SCCC Block Mode may indicate the information of the block mode regarding the 1.1 version data. 1.1 SCCCBM1 to 1.1 SCCCBM5 may indicate the information of the coding basis for the 1.1 version data.

In addition to the information of Table 2, various information may be provided so that the receiving parts may properly detect and decode new mobile data. The number of the bits in each information may be changeable. Further, the position in each field may be arranged in a different order as compared to Table 2.

Meanwhile, so that the digital broadcast receiver receiving the stream including new mobile data can determine the inclusion of new mobile data, whether new mobile data are included or not may be informed in the FIC information.

The 1.1 version receiver receiving and processing new mobile data may process the 1.0 service information and the 1.1 service information simultaneously. On the contrary, the 1.0 version receiver may pass the 1.1 service information out.

Thus, the area informing whether the 1.1 version data are included or not may be created by changing the FIC segment syntax.

The FIC segment syntax may include the following Tables 3 and 4:

TABLE 3
Syntax No. of Bits Format

| | | |
|---|---|---|
| FIC_segment_header( ) | 2221144 | uimsbf‘11’uimsb |
| { FIC_segment_type | | fbsIbfbsIbfuims |
| reserved | | bfuimsbf |
| FIC_chunk_major_protocol_version | | |
| current_next_indicator error_indicator | | |
| FIC_segment_num | | |
| FIC_last_segment_num } | | |

TABLE 4
Syntax No. of Bits Format

| | | |
|---|---|---|
| FIC_segment_header( ) | 211255 | uimsbfbsIbfbsIb |
| { FIC_segment_type | | fuimsbfuimsbfu |
| current_next_indicator error_indicator | | imsbf |
| FIC_chunk_major_protocol_version | | |
| FIC_segment_num | | |
| FIC_last_segment_num } | | |

In Table 4, instead of the reserved area, FIC_segment_num and FIC_last_segment_num may expand to 5 bits in each.

In Table 4, by adding the value 01 to FIC_segment_type, the 1.1 version data may be informed. If FIC_segment_type is set as 01, the 1.1 version receiver may decode the FIC information and process the 1.1 version data. The 1.0 version receiver may not find the FIC information in this case. On the contrary, if FIC_segment_type is defined as 00 or null segment, the 1.0 version receiver may decode the FIC information and process the basic mobile data.

Meanwhile, by keeping the syntax of the FIC chunk without changing the FIC syntax, the 1.1 version data may be informed by utilizing some part of the area, for instance, the RESERVED area.

The FIC may include 16 bits to the maximum when constructing the great FIC chunk. The 1.1 version data may be marked by changing some part of the syntax including the FIC chunk.

Specifically, in the following Table 5, “MH 1.1 service_status” may be added in the reserve area of the service ensemble loops.

TABLE 5
Syntax No. of Bits Format

| | | |
|---|---|---|
| FIC_chunk_payload( ){ for(i=0; i<num_ensembles; | 8351115816212 | uimsbf‘111’uim |
| i++){ ensemble_id reserved | 21var | sbfbslbfbslbf‘1’ |
| ensemble_protocol_version | | uimsbfuimsbfui |
| SLT_ensemble_indicator | | msbfuimsbf‘1’ui |
| GAT_ensemble_indicator reserved | | msbfuimsbfbslb |
| MH_service_signaling_channel_version | | f |
| num_MH_services for (j=0; j<num_MH_services; | | |
| j++){ MH_service_id MH1.1_service_status | | |
| reserved multi_ensemble_service | | |
| MH_service_status SP_indicator } } | | |
| FIC_chunk_stuffing( )} | | |

In Table 5, by utilizing 2 bits of 3 bits in the reserved area, MH1.1_service_status may be marked. MH1.1_service_status may indicate the data determining whether the 1.1 version data may be included in the stream.

Further, besides MH1.1_service_status, MH1.1_ensemble_indicator may be added. Thus, the syntax of the FIC chunk may include the following Table 6:

TABLE 6
Syntax No. of Bits Format

| | | |
|---|---|---|
| FIC_chunk_payload( ){ for(i=0; i<num_ensembles; | 8125111581622 | uimsbfbslbf‘11’ |
| i++){ ensemble_id MH1.1_ensemble_indicator | 21var | uimsbfbslbfbslb |
| reserved ensemble_protocol_version | | f‘1’uimsbfuimsb |
| SLT_ensemble_indicator | | fuimsbfuimsbf‘ |
| GAT_ensemble_indicator reserved | | 1’uimsbfuimsbf |
| MH_service_signaling_channel_version | | bslbf |
| num_MH_services for (j=0; j<num_MH_services; | | |
| j++){ MH_service_id | | |
| MH1.1_service_status_extension reserved | | |
| multi_ensemble_service MH_service_status | | |
| SP_indicator } } FIC_chunk_stuffing( )} | | |

In Table 6, 1 bit of 3 bits in the first reserved area may be distributed for MH1.1_ensemble_indicator. MH1.1_ensemble_indicator may indicate the information of the ensembles on the 1.1 version data service basis. In Table 6, by utilizing 2 bits of 3 bits in the second reserved area, MH1.1_service_status_extension may be marked.

Further, in following Table 7, the 1.1 version service may be marked as 1.1 by changing the ensemble protocol version and utilizing the value reserved for 1.0.

TABLE 7
Syntax No. of Bits Format

| | | |
|---|---|---|
| FIC_chunk_payload( ){ for(i=0; i<num_ensembles; | 8351115816322 | uimsbf‘111’uim |
| i++){ ensemble_id reserved | 1var | sbfbslbfbslbf‘1’ |
| ensemble_protocol_version | | uimsbfuimsbfui |
| SLT_ensemble_indicator | | msbf‘111’uimsb |
| GAT_ensemble_indicator reserved | | fuimsbfbslbf |
| MH_service_signaling_channel_version | | |
| num_MH_services for (j=0; j<num_MH_services; | | |
| j++){ MH_service_id reserved | | |
| multi_ensemble_service MH_service_status | | |
| SP_indicator } } FIC_chunk_stuffing( )} | | |

Further, in following Table 8, the signaling data may be transmitted by changing the ensemble loop header extension length of the FIC chunk header syntax field, by adding the ensemble extension of the FIC chunk payload syntax field, and adding MH1.1_service_status to the service loop reserved 3 bits in the FIC chunk payload syntax.

TABLE 8
Syntax No. of Bits Format

| | | |
|---|---|---|
| FIC_chunk_payload( ){ for(i=0; i<num_ensembles; | 8351115358162 | uimsbf‘111’uim |
| i++){ ensemble_id reserved | 13221var | sbfbslbfbslbf‘1’ |
| ensemble_protocol_version | | uimsbfuimsbfui |
| SLT_ensemble_indicator | | msbfuimsbf‘111 |
| GAT_ensemble_indicator reserved | | ’uimsbfuimsbfb |
| MH_service_signaling_channel_version reserved | | slbf |
| ensemble extension num_MH_services for (j=0; | | |
| j<num_MH_services; j++){ MH_service_id | | |
| MH_service_status_extension reserved reserved | | |
| multi_ensemble_service MH_service_status | | |
| SP_indicator } } FIC_chunk_stuffing( )} | | |

Alternatively, as shown in the following Table 9, among the syntax field of the FIC chunk header, MH_service_loop_extension_length may be changed, and among the payload field of the FIC chunk, information field related to MH1.1_service status may be added.

TABLE 9
Syntax No. of Bits Format

| | | |
|---|---|---|
| FIC_chunk_payload( ){ for(i=0; i<num_ensembles; | 8351115816322 | uimsbf‘111’uim |
| i++){ ensemble_id reserved | 153var | sbfbslbfbslbf‘1’ |
| ensemble_protocol_version | | uimsbfuimsbfui |
| SLT_ensemble_indicator | | msbf‘111’uimsb |
| GAT_ensemble_indicator reserved | | fuimsbfbslbfui |
| MH_service_signaling_channel_version | | msbfuimsbf |
| num_MH_services for (j=0; j<num_MH_services; | | |
| j++){ MH_service_id reserved | | |
| multi_ensemble_service MH_service_status | | |
| SP_indicator reserved | | |
| MH1.1_Detailed_service_Info } } | | |
| FIC_chunk_stuffing( )} | | |

The signaling data may be provided to the receiving units by utilizing various areas such as the field sync, the TPC information, and the FIC information.

Meanwhile, besides these areas, the signaling data may be inserted in other areas. Thus, in the packet payload of the known data may be inserted the signaling data. By utilizing the FIC information as in Table 5, the inclusion of the 1.1 version data and the position that can find the signaling data may be written. The 1.1 version signaling data may be additionally generated, and the signaling data corresponding to the 1.1 version receiver may be detected.

Further, the signaling data may be constructed to be an additional stream, and be transmitted to the receiver by utilizing other channels than the stream transmitting channels.

Further, in the signaling data, information other than the above information may be included, which can signal at least one of the various information such as the inclusion of the basic or new mobile data, the position of the mobile data, the addition of the station data, the addition position of the station data, the arrangement pattern of the mobile data and the station data, the block mode, and the coding basis.

Meanwhile, the digital broadcast transmitter utilizing the signaling data may include the data preprocessor 100 placing at least one of the mobile data and the station data in the normal data areas of whole packets constructing the stream and the MUX generating the transport stream including the mobile data and the signaling data. The data preprocessor 100 may be constructed as in the above-described various exemplary embodiments, or be modified by excluding, adding, or changing some units. Particularly, the signaling data may be generated by the signaling encoder 150, the control unit 310, or an additionally provided filed sync generator (not illustrated), and be inserted to the transmitting steam by the MUX 200 or the sync MUX 470. The signaling data may indicate the data informing at least one of the arranging the mobile data and the arranging pattern, and may be implemented by the data field sync, the TPC, or the FIC information.

Meanwhile, as described above, if Scalable Mode 11a is provided with Scalable Mode 11, in other words, if Modes 1 to 5 are provided, the method marking the signaling data may be changed.

According to an exemplary embodiment, the signaling field in the TPC field may be referred to as Scalable Mode, 2 bits may be allocated, and four modes of FIGS. 37 to 40 may be referred to as 00, 01, 10, and 11. The fourth mode may have 11 as a bit value whether if implemented as compatible or as non-compatible. However, because the MPEG header and the parity area can be utilized or not in 2 modes, the group format may be different from each other.

The receiver may check all TPC in the other slots as well as the slots including M/H group of M/H parade the receiver intends to receive. If Scalable Mode in every slot is 11 and a Core Mobile Mode (CMM) slot is not found, in other words, if the normal data rate is 0 Mbps, the receiver may determine 11 bits as Scalable Mode 11 and decode accordingly.

Meanwhile, if Scalable Mode of every slot is not 11 and the CMM slot is found, in other words, if the normal data rate is not 0 Mbps, the receiver may find 11 bits as Scalable Mode 11a and decode by considering the compatibility.

According to another exemplary embodiment, the signaling field in the TPC field may be referred to as Scalable Mode and 3 bits may be allocated in the field. Thus, the format of 3 groups corresponding to FIGS. 37 to 40, the first to third modes, and the format of 2 groups corresponding to FIGS. 37 to 40, the fourth and fifth modes, in summary, the format of 5 groups may be signaled.

As described, the modes may include:

1) the first mode arranging new mobile data in 11 packets of 38 packets for the normal data;

2) the second mode arranging new mobile data in 20 packets of 38 packets for the normal data;

3) the third mode arranging new mobile data in 29 packets of 38 packets for the normal data;

4) the fourth mode arranging new mobile data in 38 packets for the normal data; and

5) the fifth mode arranging new mobile data in 38 packets for the normal data and in the MPEG header and the parity areas for the basic mobile data.

The first mode may be Scalable Mode 000, the second mode may be Scalable Mode 001, the third mode may be Scalable Mode 010, the fourth mode, i.e., the mode filling the mobile data in 38 packets and considering the compatibility may be Scalable Mode 011, and the fifth mode, i.e., the mode filling the mobile data in 38 packets and in no need of considering the compatibility may be Scalable Mode 111.

To define additional group formats, the bits of Scalable Mode may be allocated or the signaling bits may be added.

The digital broadcast transmitter according to exemplary embodiments may arrange the basic mobile data, new mobile data, and the normal data in the stream by various methods and may transmit the data.

For instance, in FIG. 4, the group formatter 130 provided in the stream constructor, in other words, the data preprocessor 100, may add the station data, the signaling data, and the configuration data to the stream processed by the block processor 120, and format the data on a group basis.

Thus, if the packet formatter implements the packet formatting, the MUX 200 may perform multiplexing. If in the first to third modes, the MUX 200 may also multiplex the normal data processed by the normal processor 320. If in the fourth to fifth modes, the normal processor 320 may not output the normal data, and the MUX 200 may output the stream as provided by the packet formatter 140.

[Digital Broadcast Receiver]

As explained above, the digital broadcast transmitter may transmit new mobile data by utilizing some or whole packets for the normal data, and some or whole packets for the basic mobile data in the stream.

The digital broadcast receiver may receive and process at least one of the basic mobile data, the normal data, and the new mobile data by the receiver version.

The digital broadcast receiver for the normal data may check the signaling data, and detect and decode the normal data, if the above-described stream is received. As described, if the stream is constructed in a mode excluding the normal data, the receiver for the normal data may not provide the normal data service.

Meanwhile, on the side of the digital broadcast receiver 1.0 version, if the streams of the above-explained various structures are received, the receiver may check the signaling data, and detect and decode the existent mobile data. If the mobile data for use in 1.1 version is arranged in the whole area, the digital broadcast receiver for 1.0 version may not be able to provide the mobile service.

On the contrary, the digital broadcast receiver for 1.1 version may be able to detect and process not only the data for 1.1 version, but also the data for 1.0 version. In this case, if a decoding block for normal data processing is implemented, a normal data service may also be supported.

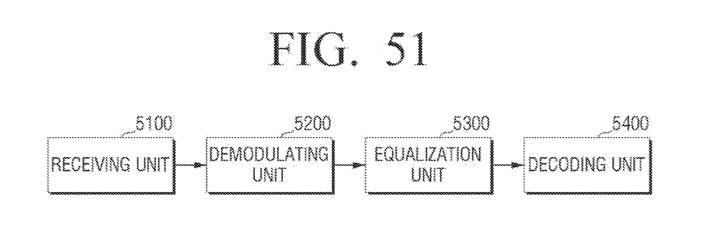

FIG. 51 is a block diagram of a digital broadcast receiver according to an exemplary embodiment. The digital broadcast receiver may implement the constituents corresponding to those of various digital broadcast transmitters of FIGS. 2 to 4 in reverse order. For convenience of illustration, FIG. 51 illustrates only some constituents for the reception.

Accordingly, referring to FIG. 51, the digital broadcast receiver may include a receiving unit 5100 (e.g., receiver), a demodulating unit 5200 (e.g., demodulator), an equalization unit 5300 (e.g., equalizer), and a decoding unit 5400 (e.g., decoder).

The receiving unit 5100 may receive a transport stream (TS) transmitted from the digital broadcast transmitter over antenna, or cable.

The demodulating unit 5200 demodulates the TS received through the receiving unit 5100. The frequency or clock signal of the signal received through the receiving unit 5100 may be synchronized with the digital broadcast transmitter as the signal passes through the demodulating unit 5200.

The equalization unit 5300 equalizes the demodulated TS.

The demodulating unit 5200 and the equalization unit 530 may perform synchronization and equalization more efficiently, by utilizing the known data included in the TS which is newly added along with the mobile data.

The decoding unit 5400 detects the mobile data in the equalized TS and decodes the same.

The location of inserting the mobile data and the known data and the size thereof may be notified by the signaling data included in the TS or by the signaling data received through a separate channel.

The decoding unit 5400 determines the location of the mobile data suitable for the digital broadcast receiver using the signaling data, and then detects the mobile data at the determined location for decoding.

The constitution of the decoding unit 5400 may vary according to exemplary embodiments.

That is, the decoding unit 5400 may include two decoders, e.g., a trellis decoder and a convolution decoder. The two decoders may enhance performance by exchanging decoding reliability information with each other. The output of the convolution decoder may be identical to the input to the RS encoder on the receiver's side.

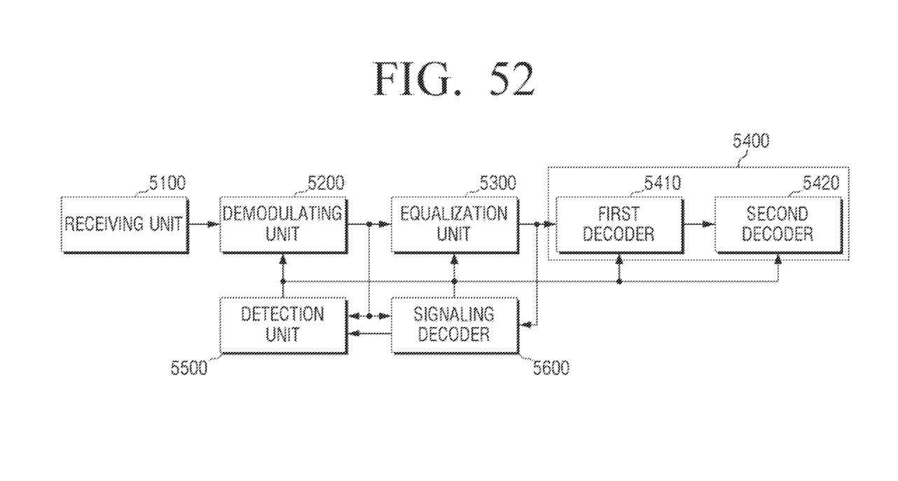

FIG. 52 is a detailed block diagram of a digital broadcast receiver according to an exemplary embodiment.

Referring to FIG. 52, the digital broadcast receiver may include a receiving unit 5100, a demodulating unit 5200, an equalization unit 5300, a decoding unit 5400, a detecting unit 5500 (e.g., detector), and a signaling decoder 5600.

Since the receiving unit 5100, the demodulating unit 5200 and the equalization unit 5300 have the same or similar functions as explained above with reference to FIG. 51, the repetitious explanation thereof will be omitted for the sake of brevity.

The decoding unit 5400 may include a first decoder 5410 and a second decoder 5420.

The first decoder 5410 may perform decoding with respect to at least one of the existent mobile data and the new mobile data. The first decoder 5410 may perform SCCC decoding to decode the data based on block-wise unit.

The second decoder 5420 may perform RS decoding with respect to the stream decoded at the first decoder 5410.

The first and second decoders 5410, 5420 may process the mobile data by using the output value of the signaling decoder 5600.

That is, the signaling decoder 5600 may detect the signaling data included in the stream and perform decoding. To be specific, the signaling decoder 5600 may demultiplex the information such as Reserved area, TPC info area, or FIC info area in the field sync data from the stream. By convolution-decoding and RS-decoding the demultiplexed parts and then inverse-randomizing, the signaling data may be recovered. The recovered signaling data may be provided to the respective constituents within the digital broadcast receiver, such as the demodulating unit 5200, the equalization unit 5300, the decoding unit 5400 and the detecting unit 5500. The signaling data may contain various information to be used at the respective constituents, such as block mode info, mode info, known data insertion pattern info, frame mode, or the like. Since the type and functions of the information are explained in detail above, these will not be explained further for the sake of brevity.

In addition to the information mentioned above, other information such as mobile data coding rate, data rate, location of insertion, type of error correction code used, information of primary service, information for supporting time slicing, description about mobile data, information regarding changes in mode information, information for supporting IP service, or the like may be provided to the receiver in the form of signaling data or other additional data form.

Meanwhile, although FIG. 52 illustrates an example under the assumption that the signaling data is included in the stream, if the signaling data signal is transmitted over a separately-provided channel, the signaling decoder 5600 may decode the signaling data signal and provide the above-listed information.

The detecting unit 5500 may detect the known data in the stream, by using the known data insertion pattern information provided by the signaling decoder 5600. In this case, along with the known data added with the new mobile data, the known data added with the existent mobile data may be processed together.

To be specific, as illustrated in FIGS. 22 to 36, the known data may be inserted in various locations and in various forms, in at least one area from among the body area and head/tail area of the mobile data. The known data insertion pattern such as the location or the starting point may be included in the signaling data. The detecting unit 550 may detect the known data at an appropriate location according to the signaling data and provide the detected known data to the demodulating unit 5200, the equalization unit 5300 and the decoding unit 5400.

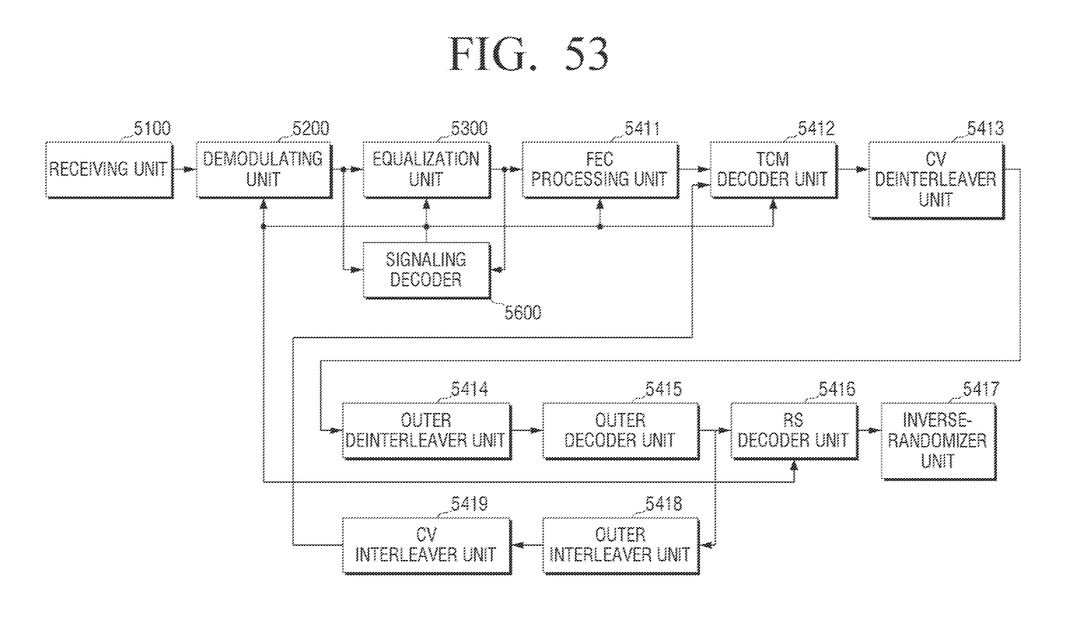

FIG. 53 is a view illustrating a detailed constitution of the digital broadcast receiver according to another exemplary embodiment.

Referring to FIG. 53, the digital broadcast receiver may include a receiving unit 5100, a demodulating unit 5200, an equalization unit 5300, an FEC processing unit 5411 (e.g., FEC processor), a TCM decoder unit 5412 (e.g., TCM decoder), a CV deinterleaver unit 5412 (e.g., CV deinterleaver), an outer deinterleaver unit 5414 (e.g., outer deinterleaver), an outer decoder unit 5415 (e.g., outer decoder), an RS decoder unit 5416 (e.g., RS decoder), an inverse-randomizer unit 5417 (e.g., inverse-randomizer), an outer interleaver unit 5418 (e.g., outer interleaver), a CV interleaver unit 5419 (e.g., CV interleaver), and a signaling decoder 5600.

Since the receiving unit 5100, the demodulating unit 5200, the equalization unit 5300 and the signaling decoder 5600 are explained above with reference to FIG. 52, the repetitious explanation thereof will be omitted for the sake of brevity. The detection unit 5500 shown in FIG. 52 is omitted in FIG. 53. That is, according to an exemplary embodiment, the respective constituents may directly detect the known data by using the signaling data decoded at the signaling decoder 5600.

The FEC processing unit 5411 may perform forward direction error correction with respect to the TS equalized at the equalization unit 5300. The FEC processing unit 5411 may detect the known data in the TS using information provided from the signaling decoder 5600 such as known data location or insertion pattern, and use the same for the forward direction error correction. Alternatively, the additional reference signal may not be used for the forward direction error correction depending on exemplary embodiments.

Meanwhile, FIG. 53 illustrates an arrangement of the constituents in which decoding is performed with respect to the mobile data after FEC processing is completed. That is, the whole TS undergoes FEC processing. However, it is possible that only the mobile data is detected from the TS and undergoes FEC processing.

The TCM decoder unit 5412 may detect the mobile data from the TS outputted from the FEC processing unit 5411 and perform trellis decoding. In this example, if the FEC processing unit 5411 has already detected the mobile data and performed forward direction error correction with respect to the detected portion only, the TCM decoder unit 5412 may perform trellis decoding directly with respect to the inputted data.

The CV deinterleaver unit 5413 may perform convolution-deinterleaving with respect to the trellis-decoded data. As explained above, since the constitution of the digital broadcast receiver corresponds to that of the digital broadcast transmitter which constructs and processes the TS, the CV deinterleaver unit 5413 may not be utilized or provided depending on the constitution of the transmitter.

The outer deinterleaver unit 5414 may perform outer deinterleaving with respect to the convolution-deinterleaved data. After that, the outer decoder unit 5415 may remove the parity from the mobile data by the decoding.

Meanwhile, depending on exemplary embodiments, the process performed from the TCM decoder unit 5412 to the outer decoder unit 5415 may be repeated more than once to enhance the mobile data reception performance. For the repeating, the decoding data of the outer decoder unit 5415 may be passed through the outer interleaver unit 5418 and the CV interleaver unit 5419 and then provided as an input to the TCM decoder unit 5412. Depending on the structure of the transmitter, the CV interleaver unit 5419 may not be utilized or provided.

The trellis decoded data may be provided to the RS decoder unit 5416. Accordingly, the RS decoder unit 5416 may RS-decode the provided data and the inverse-randomizer unit 5417 may perform inverse-randomization. Through this process, the stream with respect to the mobile data, and to be specific, the stream with respect to newly-defined 1.1 version data may be processed.

Meanwhile, as explained above, if the digital broadcast receiver is for 1.1 version, it is possible to process the 1.0 version data as well as 1.1 version data.

That is, at least one of the FEC processing unit 5411 and the TCM decoder unit 5412 may detect the whole mobile data except the normal data and process the detected data.

Further, if the digital broadcast receiver is a commonly-used receiver, the receiver may include a block for normal data processing, a block for 1.0 version data processing, and a block for 1.1 version data processing. In such an example, a plurality of processing paths may be provided at a rear end of the equalization unit 5300, the above-mentioned blocks may be arranged one in each processing path, and at least one processing path may be selected depending on control at a separately-provided control unit (not illustrated) to include appropriate data in the TS.

Further, as explained above, the mobile data may be arranged in a different pattern in each slot. That is, various slots may be repeatedly formed according to a preset pattern, in which the slots may include a first slot form in which the normal data is direction included, a second slot form in which new mobile data is included in the whole normal data area, a third slot form in which new mobile data is included in part of the normal data area, and a fourth slot form in which the new mobile data is included in the whole normal data area and existent mobile area.

The signaling decoder 5600 may decode the signaling data and notify the frame mode information or mode information to the respective constituents. Accordingly, the respective constituents, i.e., the FEC processing unit 5411 or the TCM decoder unit 5412, may detect the mobile data from a predetermined location with respect to the respective slots and process the detected data.

Although a control unit (e.g., controller) is not illustrated in FIGS. 51 to 53, the control unit may be additionally included to apply an appropriately control signal to the respective blocks by using the signaling data decoded at the signaling decoder 5600. The control unit may control the tuning operation of the receiving unit 5100 depending on choice by the operator.

For a receiver of 1.1 version, depending on the operator's choice, 1.0 version data or 1.1 version data may be selectively provided. Further, if there are a plurality of 1.1 version data provided, depending on the operator's choice, one of the services may be provided.

To be specific, as explained above, in some modes such as first to fourth modes (e.g., where all the first to fourth modes may be compatible, or only the fourth mode may be non-compatible), or first to fifth modes, at least one from among the normal data, the existent mobile data and the new mobile data may be arranged in the stream and transmitted.

In the above case, the digital broadcast receiver may detect the respective data at appropriate locations according to the mode, and perform decoding based on the decoding scheme that suits the detected data.

To be specific, in an exemplary embodiment in which the TPC signaling field whose mode is expressed by two bits such as 00, 01, 10, 11 is recovered, if the digital broadcast receiver confirms 11 value from the signaling data, the digital broadcast receiver confirms the TPC of not only the slots containing M/H group of the M/H parade, but also the other slots. Accordingly, if all the slots have mode information as 11 and no CMM slot is found, it is determined that the mode is set to the fourth mode. Accordingly, the digital broadcast receiver may decode the MPEG header and parity area, such as SB5 area explained above, where the new mobile data is arranged in the same manner as the body area stream. However, if every slots' scalable mode is not 11, or if CMM slot is found, the receiver may determine the set mode to be the compatible mode, i.e., the scalable mode 11a, and decode the MPEG header and parity area, i.e., the SB5 area, differently from the rest of the body area stream. That is, the receiver may decode the SB5 area in a manner corresponding to the coding method of the new mobile data. The signaling decoder or a separate control unit may perform the TPC and mode check of the respective slots.

Meanwhile, in an exemplary embodiment in which the mode is represented by three bits so that the signaling bits such as 000, 001, 010, 011, 111 are transmitted, the digital broadcast receiver may check the mode according to the bit value and perform suitable decoding.

The digital broadcast transmitter may construct the TS by combining normal data, existent mobile data, and new mobile data and transmit the result.

Accordingly, the digital broadcast receiver may be implemented in various configurations to receive and process the TS. That is, the digital broadcast receiver may be a receiver for normal data which is capable of processing normal data only, a receiver for existent mobile data which is capable of processing existent mobile data only, a receiver for new mobile data which is capable of processing new mobile data, or a common receiver which is capable of processing at least two of the data.

In the case of the receiver for normal data, as explained above, unlike the first to fourth modes which have compatibility, there is no data to be processed in the fourth or fifth mode which has no compatibility. Accordingly, the digital broadcast receiver may ignore the TS that the digital broadcast receiver cannot perceive and process.

On the contrary, in the case of a receiver for existent mobile data or a common receiver which is capable of processing existent mobile data and the normal data, to process normal data, the receiver decodes the slot made of normal packets only, or decode the normal data included in the whole or part of the 38 packets, and detect and decode the existent mobile data included in the area other than the 38 packets for the processing of the existent mobile data. To be specific, in the case of the slot including the new mobile data, in a separate block mode, the primary ensemble may be filled with the existent mobile data, and the secondary ensemble may be filled with the new mobile data, so that it is possible to transmit both the existent and new mobile data in one slot. Accordingly, in scalable mode 11, the receiver may decode the body area except the SB5 to process the existent mobile data. On the contrary, in scalable mode 11a, since the SB5 is not filled with the new mobile data, the whole body area is decoded to process the existent mobile data. Meanwhile, in paired block mode, since the whole block is filled with the 1.1 mobile data only, the receiver may ignore the corresponding slot in order to process the existent mobile data.

Meanwhile, the receiver for new mobile data or the common receiver capable of processing both the new mobile data and the other data may also perform the decoding depending on the block mode and mode. That is, in separate block mode, and in scalable mode 11, independent block of the SB5 area and the block allocated with the new mobile data may be decoded in a manner suitable for the coding of the new mobile data, while in scalable mode 11a, the decoding is performed with respect to the block allocated with the new mobile data in a manner suitable for the coding of the new mobile data. On the contrary, in paired block mode, the whole block may be decoded.

Referring to FIGS. 51 to 53, a separate control unit or signaling decoder may control the decoding as explained above by checking the block mode and mode. To be specific, if two bits of the signaling data represent the mode and if bit value 11 is transmitted, the control unit or the signaling decoder may check the TPC of not only the slot that includes M/H group of the M/H parade intended for reception, but also the other slots. Accordingly, if the normal data rate is determined to be 0 Mbps, the bit value 11 may be determined to be the scalable mode 11, so that decoding may be performed accordingly. On the contrary, if not every slot has scalable mode 11, or if there is CMM slot, that is, if the normal data rate is other than 0 Mbps, the bit value 11 may be determined to be the scalable mode 11a and the decoding may be performed accordingly.

The digital broadcast receiver of FIGS. 51 to 53 may be implemented as a settop box or TV, or other various portable devices such as mobile phone, PDA, MP3 player, electronic dictionary, laptop computer, or the like. Although not illustrated in FIGS. 51 to 53, an additional constituent may be provided for appropriately scaling or converting the decoded resultant data and output the data on a screen in the form of audio or video data.

Meanwhile, a method of constructing a stream at a digital broadcast transmitter, and a method for processing the stream at a digital broadcast receiver, will be explained in greater detail below with reference to the block diagrams and views of the streams explained above.

That is, the method for constructing a stream at a digital broadcast transmitter may include arranging mobile data in at least a part of the packets allocated for normal data among packets of the stream, and a stream constructing step of inserting the normal data into the stream having the mobile arranged therein to thereby construct a transport stream.

Arranging the mobile data may be performed at the data pre-processor 100 illustrated in FIGS. 2 to 4.

The mobile data may be arranged in various locations either along with the normal data and the existent mobile data, or alone. That is, the mobile data and the known data may be arranged in various manners as illustrated in FIGS. 15 to 40.

Further, constructing the stream may include multiplexing the normal data, which is separately processed from the mobile data, with the mobile data.

The transport stream, when constructed, may pass through the RS encoding, interleaving, trellis encoding, sync multiplexing, or modulation, and is sent to the receiver. Processing the TS may be performed by various parts of the digital broadcast transmitter as the ones illustrated in FIG. 4.

The method for constructing a stream may be implemented in various exemplary embodiments according to various operations of the digital broadcast transmitter.

Meanwhile, a method for processing a stream at a digital broadcast receiver according to an exemplary embodiment may include: receiving a transport stream (TS) divided into a first area allocated for the existent mobile data and a second area allocated for the normal data and having separate mobile data arranged in at least part of the second area; demodulating the received TS; equalizing the demodulated TS; and decoding at least one of the existent mobile data and the data for mobile use from the equalized TS.

The TS received by the method according to an exemplary embodiment may be constructed and sent from the digital broadcast transmitter according to various exemplary embodiments explained above. That is, the TS may have various arrangements of mobile data as illustrated in FIGS. 15 to 21 and FIGS. 29 to 40. Further, the known data may also be arranged in various forms as illustrated in FIGS. 22 to 28.

Various exemplary embodiments for processing a stream may be related to the various exemplary embodiments of the digital broadcast receiver explained above.

Meanwhile, the various examples of the stream as illustrated in FIGS. 15 to 40 are not fixed, but may be switched to different structures depending on occasions. That is, the data pre-processor 100 may arrange the mobile data and the known data by applying various frame modes, modes, block modes, or the like in accordance with a control signal applied from a separate control unit or externally-inputted control signal, and block-code the data. As a result, the digital broadcast operator is able to provide the intended data, and more specifically, mobile data in various sizes.

Further, the new mobile data explained above, i.e., the 1.1 version data may be existent mobile data which is identical to 1.0 version data, or alternatively, the new mobile data may be different data inputted from another source. Alternatively, a plurality of 1.1 version data may be transmitted in one slot. Accordingly, the user of the digital broadcast receiver is able to view various types of data as he or she wishes.

<Method for Block Processing>

Various modified examples of the exemplary embodiments explained above are possible.

By way of example, the block processor 120 of FIG. 4 may appropriately combine the existent mobile data, normal data, new mobile data, and known data arranged within the stream, and block code the same. The new mobile data and the known data may be arranged not only in at least part of the normal data area allocated for normal data, but also in at least part of the existent mobile data area allocated for the existent mobile data. That is, the normal data, new mobile data, and existent mobile data may be mixed with each other.

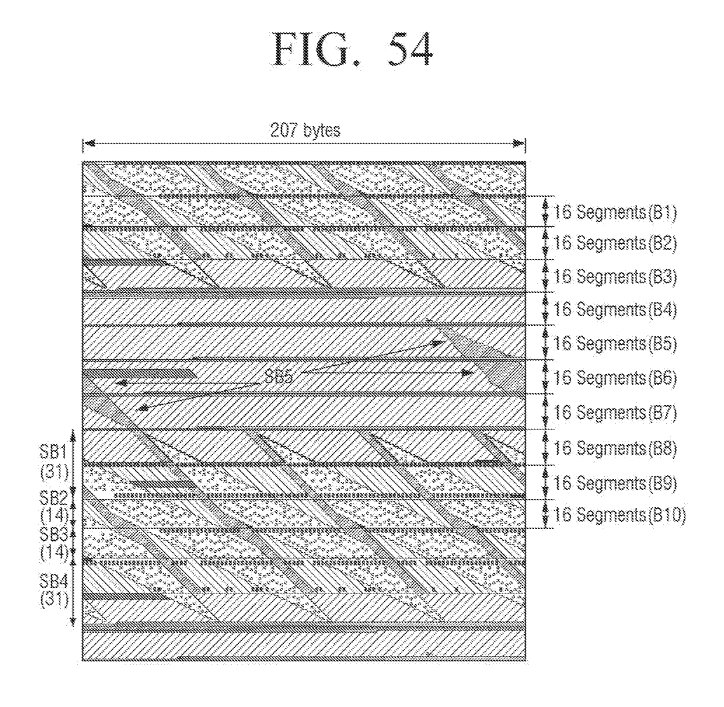

FIG. 54 illustrates an example of a stream format after interleaving. Referring to FIG. 54, the stream containing a mobile data group is made of 208 data segments. The first 5 segments correspond to RS parity data and thus are excluded from the mobile data group. Accordingly, the mobile data group of total 203 data segments is divided into 15 mobile data blocks. To be specific, the mobile data group may include B1 to B10, and SB1 to SB5 blocks. Among these, blocks B1 to B10 may correspond to the mobile data arranged in the existent mobile data area (see FIG. 8). On the contrary, blocks SB1 to SB5 may correspond to the new mobile data allocated to the existent normal data area. The SB5 includes MPEG header and RS parity for backward compatibility.

B1 to B10 may each be made of 16 segments, SB1 and SB4 may each be made of 31 segments, and SB2 and SB3 may each be made of 14 segments, respectively.

These blocks, B1 to B10, SB1 to SB5, may be combined into various forms and block-coded.

That is, as explained above, the block mode may be set variously (e.g., 00, 01, etc.). The respective SCB blocks in a block mode set to 00, and the SCCC Output Block Length (SOBL), and SCCC Input Block Length (SIBL) regarding the respective SCB blocks may be tabulated as follows:

TABLE 10

SIBL

| SCCC Block | SOBL | ½ rate | ¼ rate |
|---|---|---|---|
| SCB1 (B1) | 528 | 264 | 132 |
| SCB2 (B2) | 1536 | 768 | 384 |
| SCB3 (B3) | 2376 | 1188 | 594 |
| SCB4 (B4) | 2388 | 1194 | 597 |
| SCB5 (B5) | 2772 | 1386 | 693 |
| SCB6 (B6) | 2472 | 1236 | 618 |
| SCB7 (B7) | 2772 | 1386 | 693 |
| SCB8 (B8) | 2508 | 1254 | 627 |
| SCB9 (B9) | 1416 | 708 | 354 |
| SCB10 (B10) | 480 | 240 | 120 |

Referring to Table 10, B1 to B10 directly become SCB1 to SCB10.

Meanwhile, respective SCB blocks in a block mode set to 01, and the SOBL (SCCC Output Block Length), and SIBL (SCCC Input Block Length) regarding the respective SCB blocks may be tabulated as follows:

TABLE 11

SIBL

| SCCC Block | SOBL | ½ rate | ¼ rate |
|---|---|---|---|
| SCB1 (B1 + B6) | 3000 | 1500 | 750 |
| SCB2 (B2 + B7) | 4308 | 2154 | 1077 |
| SCB3 (B3 + B8) | 4884 | 2442 | 1221 |
| SCB4 (B4 + B9) | 3804 | 1902 | 951 |
| SCB5 (B5 + B10) | 3252 | 1626 | 813 |

Referring to Table 11, B1 and B6 are combined into one SCB1, and B2 and B7, B3 and B8, B4 and B9, and B5 and B10 are combined into SCB2, SCB3, SCB4, and SCB5, respectively. Further, the input block length varies depending on whether it is ½ rate or ¼ rate.

Meanwhile, as explained above, constructing each of B1 to B10 into SCB block or combining B1 to B10 into SCB block may be performed in CMM mode where there is no new mobile data arranged.

In a Scalabale Full Channel Mobile Mode (SFCMM) where the new mobile data is arranged, the respective blocks may be combined differently to form SCB block. That is, the existent mobile data and the new mobile data may be combined together for SCCC block coding. Tables 12 and 13 illustrate an example of the blocks which are combined differently depending on RS frame mode and slot mode.

TABLE 12

| | RS Frame Mode | | | |
|---|---|---|---|---|
| | 00 | | 01 | |
| | SCCC Block Mode | | | |
| | 00 | 01 | 00 | 01 |
| Description | Separate | Paired SCCC | Separate SCCC | Paired SCCC Block |
| | SCCC | Block Mode | Block Mode | Mode |
| | Block | | | |
| | Mode | | | |
| SCB | SCB | SCB input, | SCB input, M/H | SCB input, M/H |
| | input, | M/H Blocks | Blocks | Blocks |
| | M/H | | | |
| | Blocks | | | |
| SCB1 | B1 | B1 + B6 + SB3 | B1 | B1 + SB3 + B9 + SB1 |
| SCB2 | B2 | B2 + B7 + SB4 | B2 | B2 + SB4 + B10 + SB2 |
| SCB3 | B3 | B3 + B8 | B9 + SB1 | |
| SCB4 | B4 | B4 + B9 + SB1 | B10 + SB2 | |
| SCB5 | B5 | B5 + B10 + SB2 | SB3 | |
| SCB6 | B6 | | SB4 | |
| SCB7 | B7 | | | |
| SCB8 | B8 | | | |
| SCB9 | B9 + SB1 | | | |
| SCB10 | B10 + SB2 | | | |
| SCB11 | SB3 | | | |
| SCB12 | SB4 | | | |

Referring to Table 12, the RS frame mode refers to information which indicates whether one slot includes therein one ensemble (if RS frame mode is 00), or if one slot includes a plurality of ensembles such as primary and secondary ensembles (if RS frame mode is 01). Further, the SCCC block mode refers to information which indicates whether the mode is to perform separate SCCC block processing as in the block mode explained above, or if the mode is to perform SCCC block processing with respect to a combination of a plurality of blocks.

Table 12 is based on an example in which the slot mode is 00. The ‘slot mode’ refers to information which indicates references to distinguish a beginning and an ending of a slot. That is, if slot mode is 00, the slot refers to one that contains therein B1 to B10 and SB1 to SB5 with respect to the identical slot. If the slot mode is 01, the slots refers to one slot that is made of total 15 blocks which is constructed as B1 and B2 are sent to the previous slot, and B1 and B2 of the following slot are included into the current slot. The slot mode may have different names depending on the versions of the specification documents. By way of example, the slot mode may be referred to as Block Extension Mode. This will be explained in detail below.

Referring to Table 12, when the RS frame mode is 00 and SCCC block mode is 00, B1 to B8 are used directly as SCB1 to SCB8, B9 and SB1 are combined to form SCB9, B10 and SB2 are combined to form SCB10, and SB3 and SB4 are respectively used as SCB11 and SCB12. On the contrary, when SCCC block mode is 01, B1, B6, and SB3 are combined to be used as SCB1, B2+B7+SB4 are used as SCB2, and B3+B8, B4+B9+SB1, and B5+B10+SB2 are used as SCB3, SCB4 and SCB5, respectively.

Meanwhile, if the RS frame mode is 01 and SCCC block mode is 00, B1, B2, B9+SB1, B10+SB2, SB3, and SB4 are respectively used as SCB1 to SCB8. If SCCC block mode is 01, B1+SB3+B9+SB1 is used as SCB1, and B2+SB4+B10+SB2 is used as SCB2.

Other than the above, the SCCC blocks may be combined in the manner tabulated below, if the slot mode is 01 and the new mobile data is arranged according to the first, second, and third modes explained above.

TABLE 13

| | RS Frame Mode | | | |
|---|---|---|---|---|
| | 00 | | 01 | |
| | SCCC Block Mode | | | |
| | 00 | 01 | 00 | 01 |
| Description | Separate | Paired SCCC | Separate SCCC | Paired SCCC |
| | SCCC | Block Mode | Block Mode | Block Mode |
| | Block | | | |
| | Mode | | | |
| SCB | SCB | SCB input, | SCB input, M/H | SCB input, M/H |
| | input, | M/H Blocks | Blocks | Blocks |
| | M/H | | | |
| | Blocks | | | |
| SCB1 | B1 + SB3 | B1 + B6 + SB3 | B1 + SB3 | B1 + SB3 + B9 + SB1 |
| SCB2 | B2 + SB4 | B2 + B7 + SB4 | B2 + SB4 | B2 + SB4 + B10 + SB2 |
| SCB3 | B3 | B3 + B8 | B9 + SB1 | |
| SCB4 | B4 | B4 + B9 + SB1 | B10 + SB2 | |
| SCB5 | B5 | B5 + B10 + SB2 | | |
| SCB6 | B6 | | | |
| SCB7 | B7 | | | |
| SCB8 | B8 | | | |
| SCB9 | B9 + SB1 | | | |
| SCB10 | B10 + SB2 | | | |

Referring to Table 13, B1 to B10 and SB1 to SB5 may be combined in various manners according to the setting of RS frame mode, SCCC block mode, or the like.

Meanwhile, if the slot mode is 01 and if the new mobile data is arranged along the whole normal data area according to the fourth mode, the SCB blocks may have the following various combinations.

TABLE 14

| | RS Frame Mode | | | |
|---|---|---|---|---|
| | 00 | | 01 | |
| | SCCC Block Mode | | | |
| | 00 | 01 | 00 | 01 |
| Description | Separate | Paired SCCC | Separate SCCC | Paired SCCC |
| | SCCC Block | Block Mode | Block Mode | Block Mode |
| | Mode | | | |
| SCB | SCB input, | SCB input, M/H | SCB input, M/H | SCB input, |
| | M/H Blocks | Blocks | Blocks | M/H Blocks |
| SCB1 | B1 + SB3 | B1 + B6 + SB3 + | B1 + SB3 | B1 + SB3 + B9 + |
| | | SB5 | | SB1 |
| SCB2 | B2 + SB4 | B2 + B7 + SB4 | B2 + SB4 | B2 + SB4 + B10 + |
| | | | | SB2 |
| SCB3 | B3 | B3 + B8 | B9 + SB1 | |
| SCB4 | B4 | B4 + B9 + SB1 | B10 + SB2 | |
| SCB5 | B5 | B5 + B10 + SB2 | | |
| SCB6 | B6 + SB5 | | | |
| SCB7 | B7 | | | |
| SCB8 | B8 | | | |
| SCB9 | B9 + SB1 | | | |
| SCB10 | B10 + SB2 | | | |

As explained above, the existent mobile data, normal data, and new mobile data may be block-wise divided and each block may be combined variously according to respective modes to construct an SCCC block. As a result, the SCCC blocks are combined to form an RS frame.

The combination and coding of the blocks as explained above may be performed at the data pre-processor 100 as the one illustrated in various exemplary embodiments explained above. To be specific, the block processor 120 within the data pre-processor 100 may combine the blocks and perform block-coding. Since most operations except the combination method are explained above in various exemplary embodiments, repetitious explanation thereof will be omitted herein for the sake of brevity.

Meanwhile, the coding rate for coding the SCCC block, i.e., the SCCC outer code rate, may be determined differently depending on the outer code mode. To be specific, the above may be tabulated as follows:

TABLE 15

| SCCC outer | |
|---|---|
| code mode | Description |
| 00 | The outer code rate of a SCCC Block is ½ rate |
| 01 | The outer code rate of a SCCC Block is ¼ rate |
| 10 | The outer code rate of a SCCC Block is ⅓ rate |
| 11 | Reserved |

Referring to Table 15, the SCCC outer code mode may be set variously, such as 00, 01, 10, 11. That is, the SCCC block may be coded at ½ code rate when in 00, ¼ code rate when in 01, and ⅓ code rate when in 10. The code rate may vary depending on the specification versions. The newly added code rate may be provided to SCCC outer code mode 11. Meanwhile, the matching relationship between the SCCC outer code mode and the code rate may vary. The data pre-processor 100 may code the SCCC block at an appropriate code rate according to the setting of the outer code mode. The setting of the outer code mode may be notified from the control unit 310 or other constituent, or through a separate signaling channel. Meanwhile, at ⅓ code rate, 1 bit is inputted and 3 bits are outputted. Herein, the encoder may be constructed in various configurations. By way of example, the encoder may have a combination of ½ and ¼ code rates, and may be configured to puncture the output from the 4-state convolution encoder.

[Block Extension Mode: BEM]

As explained above, the blocks existing in slots may be coded differently depending on the slot mode or Block Extension Mode. As explained above, in Block Extension Mode 00, the slot refers to one that directly includes B1 to B10 and SB1 to SB5 with respect to the same slot, and in Block Extension Mode 01, the slot refers to one that includes total 15 blocks in which B1 and B2 are sent to the previous slot and B1 and B2 of the following slot are included in the current slot.

The group regions per block may be distinguished within the slots. For example, the four blocks B4 to B7 may be Group Region A, two blocks B3 and B8 may be Group Region B, two blocks B2 and B9 may be Group Region C, and two blocks B1 and B10 may be Group Region D. Further, the four blocks SB1 to SB4 which are generated as a result of interleaving 38 packets of the normal data area may be called Group Region E.

If the Block Extension Mode of a slot is 01, the Group Regions A and B made of blocks B3 to B8 may be defined as primary ensemble. Blocks B1 and B2 are sent to the previous slots, blocks B9 and B10, blocks SB1 to SB4, and blocks B1 and B2 of the following slot may be included to define Group Regions C, D, and E as a new secondary ensemble. Similar to the primary ensemble, in the secondary ensemble, it is possible to fill the head/tail area with long training data in length that corresponds to one data segment. Accordingly, the reception performance at the head/tail areas can be improved to the same level of reception at the body area.

If the Block Extension Mode of a slot is 00, the primary ensemble is the same as BEM 01. However, the secondary ensemble is different. The secondary ensemble may be defined by including the blocks B1 and B2 and B9 and B10, and SB1 to SB4 of the current slot. Unlike the primary ensemble, the secondary ensemble has the head/tail areas in a serrated pattern which does not allow filling with long training data. Accordingly, the head/tail areas have inferior reception than that at the body area.

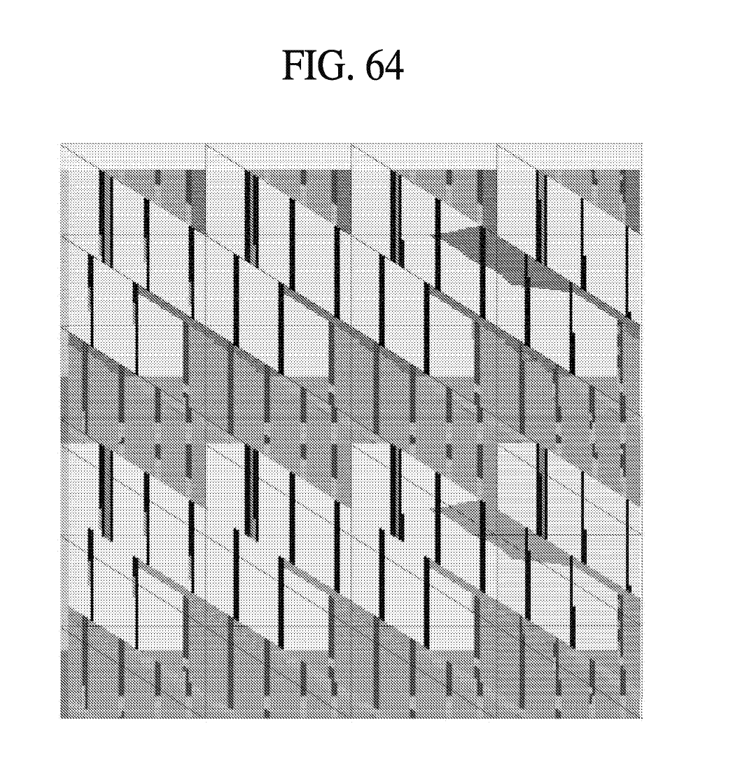

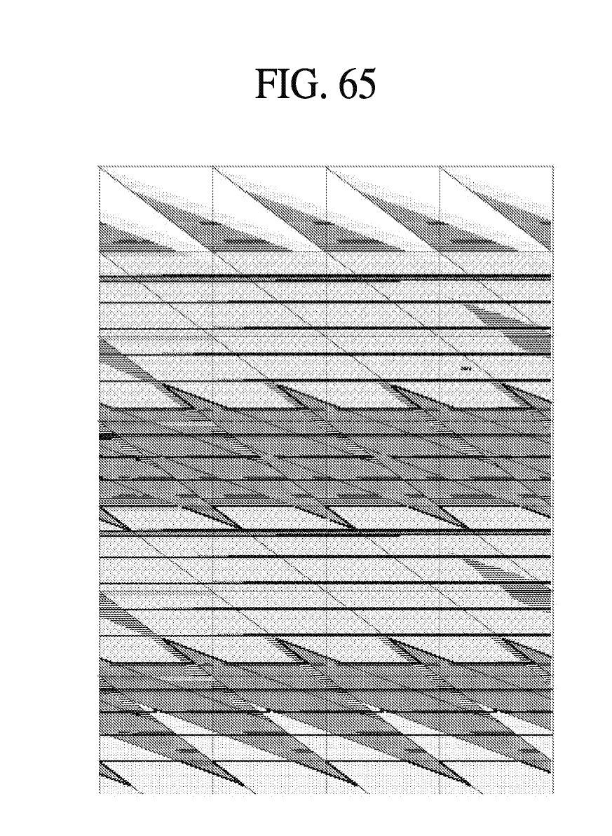

Meanwhile, if two slots are adjacent to each other by BEM 00 mode, it is possible to fill the long training data in the overlapping portions of the respective serrations of the head/tail areas. Referring to FIGS. 64 and 65, as the respective segmented training segments are connected at an area where the serration-shaped portions of the two adjacent slots in BEM 00 mode meet, the long training data in the same length as one data segment can be generated. FIGS. 64 and 65 show the location of a trellis encoder initialization byte, and the location of the known byte.

Depending on services, the slots (SFCMM slots) filled with the new mobile data may be arranged adjacent to the slots (SMM slots) filled with the existent mobile data or the slots (Full Main Slots) filled with 156 packets of normal data only, when the M/H frame is constructed. Herein, if the SFCMM slots have BEM mode as 00, combination may be possible without having any problem, even when CMM slots or Full Main Slots are arranged as the adjacent slots. Among the 16 slots within the M/H sub-frame, it is assumed that BEM 00 slot is arranged at Slot #0, and CMM slot is arranged at slot #1. In this case, block coding is performed with respect to the combination of the blocks B1 to B10 and blocks SB1 to SB4 within slot #0, and likewise, block coding is performed with respect to the combination of the blocks B1 to B10 within slot #1.

Meanwhile, if BEM mode of SFCMM slot is 01, an orphan region is taken into consideration when the CMM slot or the Full Main slot is arranged as an adjacent slot. The orphan region refers to an area where a plurality of different types of slots are successively arranged and thus cannot be easily used in any slot.

For example, among the 16 slots within the M/H sub-frame, it is assumed that BEM 01 slot is arranged at slot #0 and CMM slot is arranged at slot #1. In this case, blocks B1 and B2 within slot #0 are sent to the previous slot, and blocks B3 to B10 and SB1 to SB4 and blocks B1 and B2 of the following slot are included for block coding. That is, it is necessary to avoid interference between the two slots filled with mobile data 1.0 and mobile data 1.1 which are non-compatible with each other, according to the block coding of BEM 01.

Meanwhile, BEM 00 slot and BEM 01 slot may be set so as not to be used in combination. On the contrary, in the case of BEM 01, CMM mode, BEM01 mode and Full Main mode slots may be used in combination with each other. The area that cannot be used easily due to mode difference can be considered as an orphan region and used accordingly.

[Orphan Region]

The orphan region to prevent interference between two slots may vary depending on the type of adjacent slot to the slot having BEM 01, or depending on the order of adjacent slots.

First, if (i)th slot is CMM slot and the following slot (i+1)th slot is BEM 01 slot, the blocks B1 and B2 existing in the head area of the BEM 01 slot are sent to the previous slot. However, since the CMM slot is not block-coded by using blocks B1 and B2 of the following slot, the blocks B1 and B2 of the (i+1)th slot remain unallocated to any service and this is called an ‘Orphan Type1.’ Likewise, if (i)th slot is Full Main slot and the following slot (i+1)th slot is BEM 01 slot, the blocks B1 and B2 of the (i+1)th slot remain unallocated to any service, thus generating Orphan Type1.

Second, if (i)th slot is BEM 01 slot and the following slot (i+1) is CMM slot, since the block coding is performed at the (i)th BEM 01 slot by using the blocks B1 and B2 of the following slot, the following slot cannot use the blocks B1 and B2. That is, the following slot, i.e., the CMM slot, has to be set to Dual Frame mode so that the service is allocated only for the primary ensemble, while the secondary ensemble is left empty. Herein, among the secondary ensemble made of blocks B1 to B2 and B9 to B10, blocks B1 and B2 are borrowed from the previous (i)th slot, but the remaining blocks B9 and B10 remain unallocated to any service. This is defined as Orphan Type2.

Lastly, if (i)th slot is adjacent to BEM 01 slot, and (i+1)th slot is adjacent to Full Main slot, Orphan Type3 is generated. As the BEM 01 slot borrows the area corresponding to blocks B1 and B2 from the following Full Main slot, among the 156 following slots, it is impossible to transmit normal data to the 32 upper packets where blocks B1 and B2 are present. That is, while part of the first 32 packets of the following slot corresponds to blocks B1 and B2 and thus the same is used from the (i)th BEM 01 slot, the remaining area that does not correspond to blocks B1 and B2 remain unallocated to any service. Accordingly, the remaining area which does not correspond to the blocks B1 and B2 among the first 32 packets of the following slot are distributed in a part of Group Regions A and B in the group format after interleaving. Accordingly, Orphan Type3 is generated in the body area of the following slot.

[Utilizing Orphan]

The Orphan Region may include new mobile data, training data, or dummy bytes, depending on needs. If the new mobile data is filled in the Orphan Region, the trellis encoder is initialized to suit the intended training sequence to generate and then the known byte is defined so that the receiver can perceive the training sequence.

Table 16 lists an example of the location of the Orphan Region and manner of using the same when BEM=01.

TABLE 16

| | | | Orphan | |
|---|---|---|---|---|
| Slot(i) | Slot(i + 1) | Loss(bytes) | Location | Orphan Use |
| CMM | BEM = 01 | 1850 | Slot(i + 1) Head | Training |
| | | | | (141/89) |
| BEM = 01 | CMM | 1570 | Slot(i + 1) Tail | Training |
| | | | | (195/141) |
| Full Main | BEM = 01 | 1850 | Slot(i + 1) Head | Training |
| | | | | (141/89) |
| BEM = 01 | Full Main | 3808 | Slot(i + 1) Part of | Dummy |
| | | | Region A and B | |

Alternatively, the Orphan Region may be generated as listed in Table 17 when BEM=01.

TABLE 17

| | | | | | Orphan |
|---|---|---|---|---|---|
| | | | | Orphan | Use(Known |
| Orphan | | | | Region | bytes/Initialization |
| Type | Slot(i) | Slot(i + 1) | Loss(bytes) | Location | bytes) |
| type 1 | CMM slot | SFCMM Slot | 1618 | Slot(i + 1) | Training(210/ |
| | | with | | Head | 252) |
| | | BEM = 01 | | | |
| type 2 | SFCMM Slot | CMM slot | 1570 | Slot(i + 1) | Training(195/ |
| | with | | | Tail | 141) |
| | BEM = 01 | | | | |
| type 1 | M/H Slot | SFCMM Slot | 1618 | Slot(i + 1) | Training(210/ |
| | with only | with | | Head | 252) |
| | Main | BEM = 01 | | | |
| | packets | | | | |
| type 3 | SFCMM Slot | M/H Slot | 3808 | Slot(i + 1) Part | Dummy |
| | with | with only | | of Regions A | |
| | BEM = 01 | Main | | and B | |
| | | packets | | | |

Ad indicated above, Orphan Regions may be formed at various locations and with sizes depending on the forms of the two successive slots. Further, the Orphan Region may be utilized for various purposes such as training data, dummies, or the like. Although not specified in Tables 16 and 17, the mobile data may also be usable in the Orphan Region.

Meanwhile, if the Orphan Region is utilized, a method for processing a stream at a digital broadcast transmitter may be implemented as including: a step of constructing a stream in which a plurality of different types of slots which have at least one of existent mobile data, normal data, and new mobile data arranged therein in different formats and which are arranged in succession; and a transmitting step encoding and interleaving the stream and outputting the result as a transport stream. The transmitting step may be performed at the exciter unit 400 from among the constituents of the digital broadcast transmitter explained above.

Meanwhile, the step of constructing the stream may include arranging at least one of new mobile data, training data, and dummy data in the Orphan Region where the data is not allocated due to format discrepancy between successive slots. The ways to utilize the Orphan Region are explained above.

Further, the Orphan Region may appear in various types as explained above.

That is, if CMM slot and SFCMM slot having Block Extension Mode 01 are arranged in sequence, or if the Full Main slot having normal data only and SFCMM slot having Block Extension Mode 01 are arranged in sequence, the first type Orphan Region may be formed on the head of the SFCMM sot.

If the SFCMM slot having Block Extension Mode 01 and the CMM slot are arranged in sequence, the second type Orphan Region may be formed on the tail of the CMM slot, or if the SFCMM slot having Block Extension Mode 01 and the Full Main slot having normal data only are arranged in sequence, the third type Orphan Region may be formed on the body of the Full Main slot.

As explained above, the ‘CMM slot’ refers to a slot in which mobile data is arranged in the first area allocated for existent mobile data, and normal data is arranged in the second area allocated for normal data.

Also, as explained above, the ‘SFCMM slot’ refers to a slot in which the new mobile data is arranged according to a predetermined mode in at least part of the whole area that includes the first and second areas.

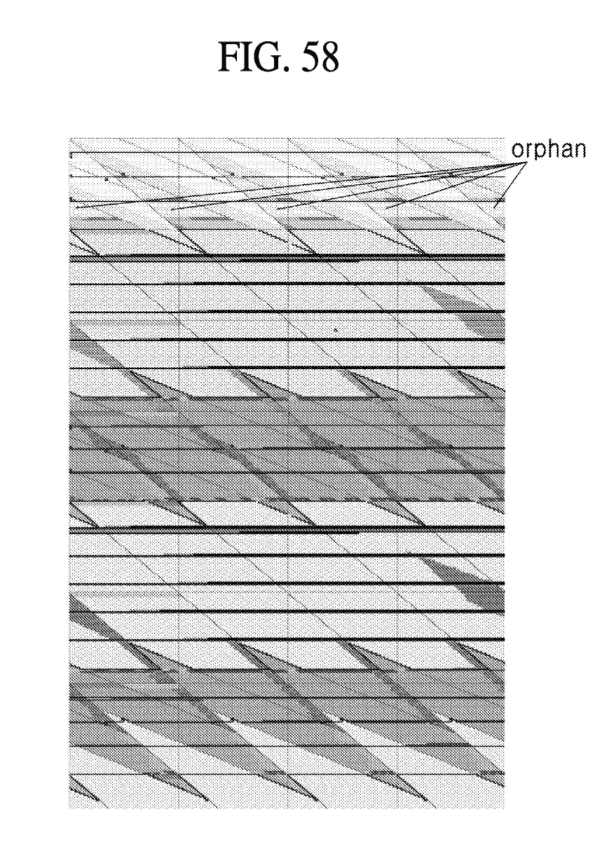

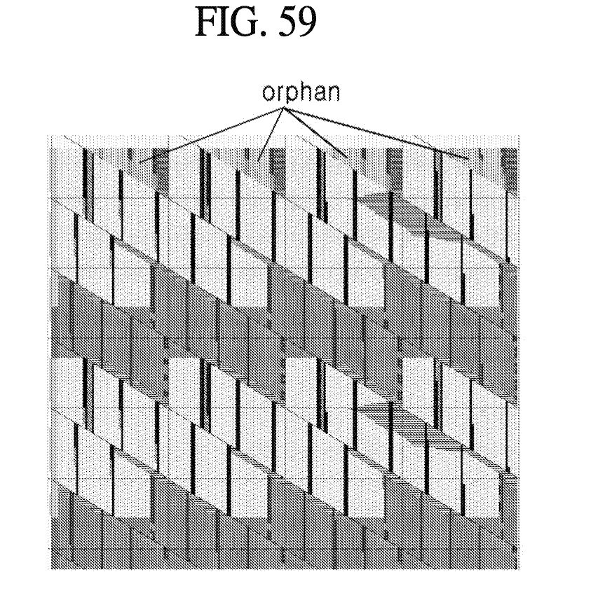

FIG. 58 illustrates a stream constitution showing the first type Orphan Region after interleaving, and FIG. 59 illustrates a stream constitution showing the first type Orphan Region before interleaving.

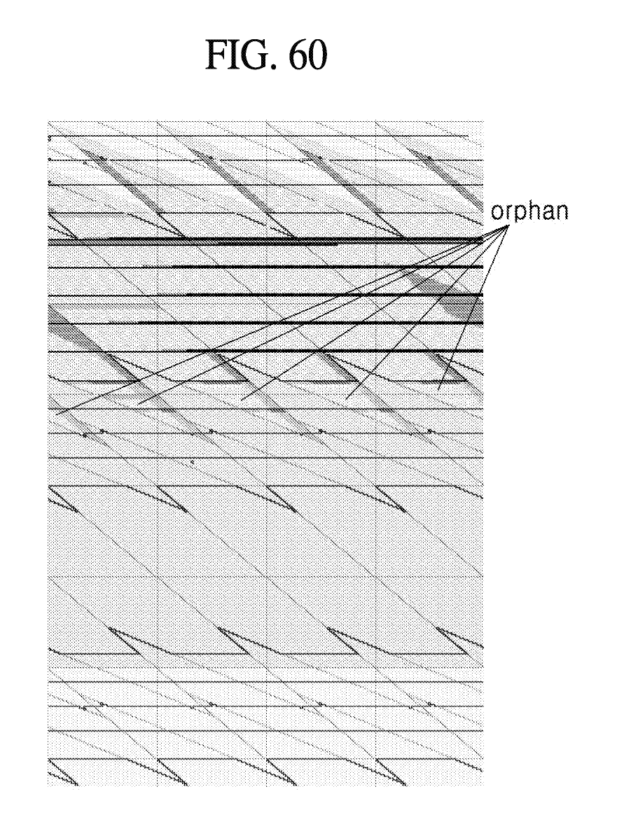

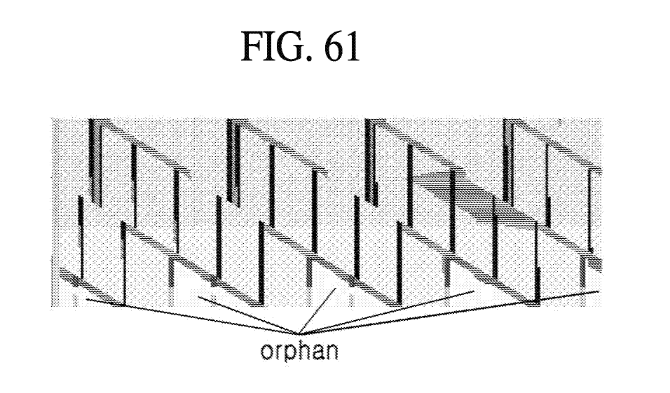

FIG. 60 illustrates a stream constitution showing the second type Orphan Region after interleaving, and FIG. 61 illustrates a stream constitution showing the second type Orphan Region before interleaving.

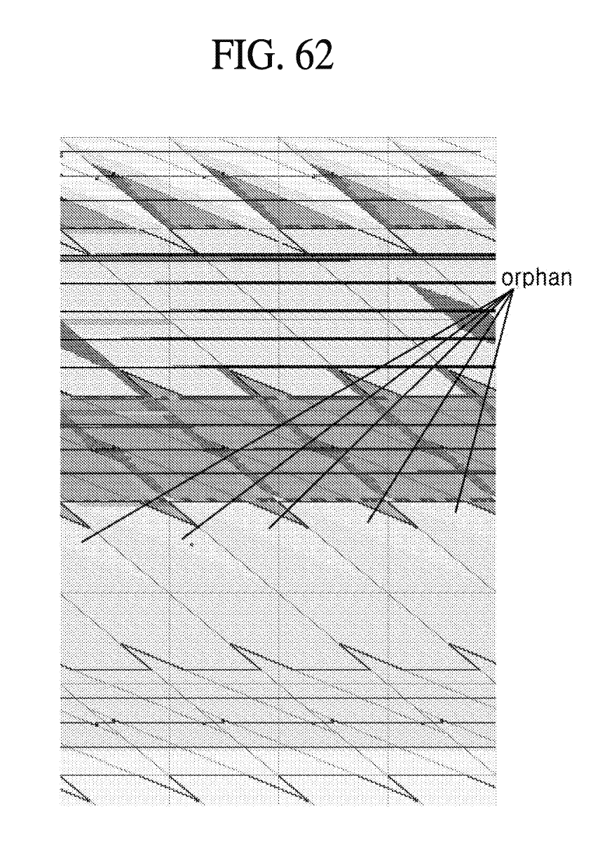

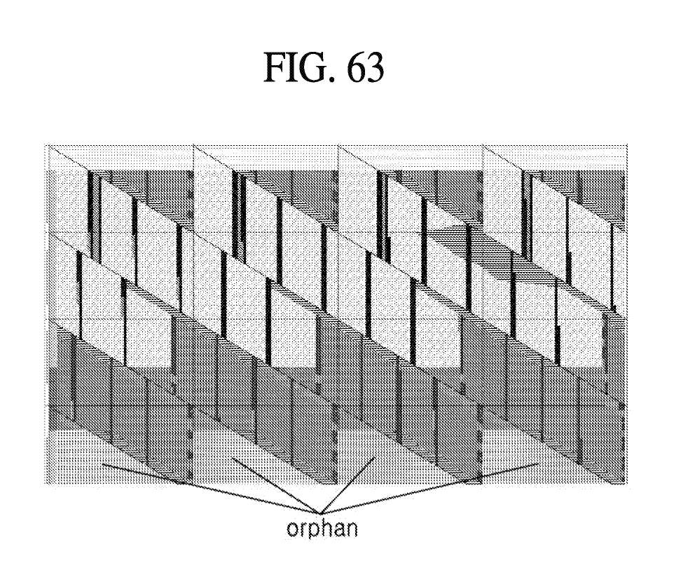

FIG. 62 illustrates a stream constitution showing the third type Orphan Region after interleaving, and FIG. 63 illustrates a stream constitution showing the third type Orphan Region before interleaving.

As the above drawings indicate, the Orphan Region may be generated at various locations according to the slot arrangement patterns.

Meanwhile, the TS transmitted from the digital broadcast transmitter may be received and processed at the digital broadcast receiver.

That is, the digital broadcast receiver may include a receiving unit which receives an encoded and interleaved TS having a plurality of different types of slots in which at least one of existent mobile data, normal data, and new mobile data is arranged in different formats respectively, a demodulating unit which demodulates the TS, an equalization unit which equalizes the demodulated TS, and a decoding unit which decodes the new mobile data from the equalized stream. Herein, the transport stream may include the Orphan Region were data is not allocated due to format discrepancy between the successive slots, and at least one of the new mobile data, training data, and dummy data may be arranged in the Orphan Region.

Depending on types of the digital broadcast receiver, i.e., depending on whether the digital broadcast receiver is a receiver for normal data only, a receiver for CMM only, a receiver for SFCMM only, or a common receiver, the receiver may detect and process only the data that the receiver can process.

Meanwhile, as explained above, whether the data exists in the Orphan Region and the type of such data may be notified by using signaling information. That is, the digital broadcast receiver may decode the signaling information and add the signaling decoder to confirm the presence/absence of the data in the Orphan Region and the type of such data.

[Signaling Data]

Meanwhile, as explained above, the additional information such as the number of data packets or code rate of the existent or new mobile data may be transmitted to the receiver as signaling data.

By way of example, the signaling information may be transmitted using the reserve area of the TPC. In this case, information about the current frame may be transmitted in some sub-frames, while the information about the next frame may be transmitted in the other sub-frames, thereby implementing “Signaling in Advance.” That is, predetermined TPC parameters and FIC data may be signaled in advance.

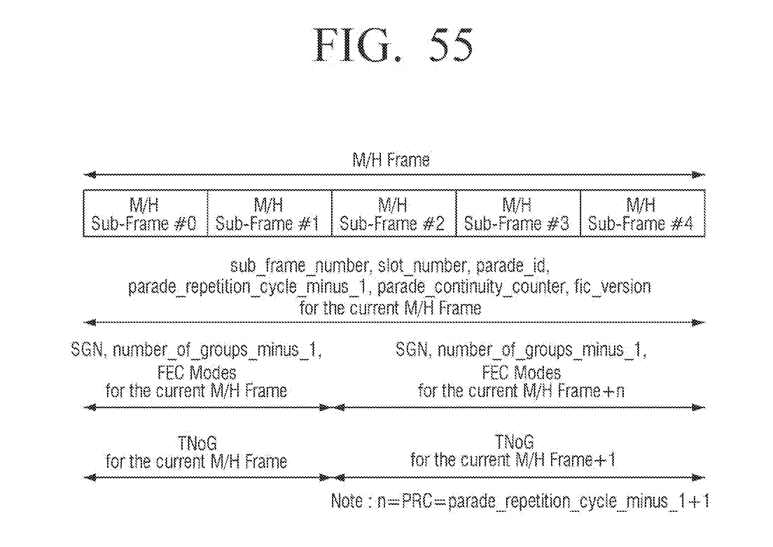

To be specific, referring to FIG. 55, one M/H frame may be divided into 5 sub-frames, which are: sub_frame_number, slot_number, parade_id, parade_repetition_cycle_minus_{—}1, parade_continuity_counter, fic_vrsion. Furthermore, the TPC parameters such as the added slot mode as explained above may transmit the information about the current frame in the 5 sub-frames. Meanwhile, TPC parameters such as SGN, number_of_groups_minus_{—}1, FEC Modes, TNoG, number of existent or new mobile data packets added as explained above, or code rate, may be recorded differently depending on the sub-frame numbers. That is, in sub-frame #0, #1, information about the current frame is transmitted, and in sub-frames #2, #3, #4, information about the next frame in consideration of the Parade Repetition Cycle (PRC) may be transmitted. In the case of TNoG, only the information regarding the current frame may be transmitted in sub-frames #0, #1, and information about the current and following frames may all be transmitted in sub-frames #2, #3, #4.

To be specific, TPC information may be constructed a follows:

TABLE 18

| | | No. | |
|---|---|---|---|
| | | of | |
| Syntax | | Bits | Format |
| TPC_data { | | | |
| sub-frame_number | | 3 | uimsbf |
| slot_number | | 4 | uimsbf |
| parade_id | | 7 | uimsbf |
| if(sub-frame_number ≦ 1){ | | | |
| current_starting_group_number | | 4 | uimsbf |
| current_number_of_groups_minus_1 | } | 3 | uimsbf |
| if(sub-frame_number ≧ 2){ | | | |
| next_starting_group_number | | 4 | uimsbf |
| next_number_of_groups_minus_1 | } | 3 | uimsbf |
| parade_repetition_cycle_minus_1 | | 3 | uimsbf |
| if(sub-frame_number ≦ 1){ | | | |
| current_rs_frame_mode | | 2 | bslbf |
| current_rs_code_mode_primary | | 2 | bslbf |
| current_rs_code_mode_secondary | | 2 | bslbf |
| current_sccc_block_mode | | 2 | bslbf |
| current_sccc_outer_code_mode_a | | 2 | bslbf |
| current_sccc_outer_code_mode_b | | 2 | bslbf |
| current_sccc_outer_code_mode_c | | 2 | bslbf |
| current_sccc_outer_code_mode_d | } | 2 | bslbf |
| if(sub-frame_number ≧ 2){ | | | |
| next_rs_frame_mode | | 2 | bslbf |
| next_rs_code_mode_primary | | 2 | bslbf |
| next_rs_code_mode_secondary | | 2 | bslbf |
| next_sccc_block_mode | | 2 | bslbf |
| next_sccc_outer_code_mode_a | | 2 | bslbf |
| next_sccc_outer_code_mode_b | | 2 | bslbf |
| next_sccc_outer_code_mode_c | | 2 | bslbf |
| next_sccc_outer_code_mode_d | } | 2 | bslbf |
| fic_version | | 5 | uimsbf |
| parade_continuity_counter | | 4 | uimsbf |
| if(sub-frame_number ≦ 1){ | | | |
| current_TNoG | | 5 | uimsbf |
| reserved | } | 5 | bslbf |
| if(sub-frame_number ≧ 2){ | | | |
| next_TNoG | | 5 | uimsbf |
| current_TNoG | } | 5 | uimsbf |
| if(sub-frame_number ≦ 1){ | | | |
| current_sccc_outer_code_mode_e | | 2 | bslbf |
| current_scalable_mode | } | 2 | uimsbf |
| if(sub-frame_number ≧ 2){ | | | |
| next_sccc_outer_code_mode_e | | 2 | bslbf |
| next_scalable_mode | } | 2 | uimsbf |
| slot mode | | 2 | uimsbf |
| reserved | | 10 | bslbf |
| tpc_protocol_version | | 5 | bslbf |
| } | | | |

Referring to Table 18, various information regarding the current M/H frame is transmitted under sub-frame number 1 (i.e., #0, #1), while various information regarding the next M/H frame in consideration of the PRC is transmitted in sub-frame #2 and above (i.e., #2, #3, #4). Accordingly, since information about the next frame is known in advance, processing efficiency is further improved.

Meanwhile, in various exemplary embodiments, the constitution of the receiver may vary. That is, the receiver may decode the block-coded data which is combined variously depending on block modes, to recover the existent mobile data, normal data, and new mobile data. Further, by checking the signaling information about the next frame in advance, it is possible to prepare processing in accordance with the signaling information.

To be specific, in a digital broadcast receiver constructed as illustrated in FIG. 51, the receiving unit 5100 may receive a stream which is generated by combining the data arranged in the existent mobile data area, and new mobile data arranged in a normal data area in a block-wise unit and SCCC-coding the same.

Herein, the stream is divided in a frame unit, and one frame is divided into a plurality of sub-frames. At least part of the plurality of sub-frames may include signaling information regarding the current frame, and the other sub-frames of the plurality of sub-frames may include signaling information regarding the next frame in consideration of the PRC. By way of example, among total 5 sub-frames, information regarding the current frame may be included in frames #0, #1, and information regarding the next frame in consideration of the PRC may be included in sub-frames #2, #3, #4.

Further, on the side of the digital broadcast transmitter, the stream may be SCCC-coded at one of ½, ⅓, ¼ rates.

When the stream is transmitted, the demodulating unit 5200 demodulates the stream, and the equalization unit 5300 equalizes the demodulated stream.

The decoding unit 5400 decodes at least one of the existent mobile data and the new mobile data from the equalized stream. In this case, it is possible to prepare the processing for the next frame by using the frame information included in the respective sub-frames.

As explained above, the digital broadcast receiver is capable of appropriately processing the stream transmitted from the digital broadcast transmitter according to various exemplary embodiments. A method for processing a stream at the digital broadcast receiver will not be additionally explained or illustrated for the sake of brevity.

Since the receiver according to various exemplary embodiments has a substantially similar construction as that of other exemplary embodiments explained above, again, this will not be additionally illustrated or explained for the sake of brevity.

Meanwhile, FIG. 56 illustrates an M/H group format before data interleaving in the compatible mode, i.e., in Scalable Mode 11a.

Referring to FIG. 56, the M/H group containing mobile data may be made of 208 data segments. If the M/H group is distributed over 156 packets of the M/H slot constructed based on a 156 packet unit, according to the interleaving rule of the interleaver 430, the interleaving causes the 156 packets to spread over 208 data segments.

Total 208 data segment mobile data group is divided based on 15 mobile data blocks. To be specific, the mobile data group includes blocks B1 to B10, and SB1 to SB5. Referring to FIG. 8, the blocks B1 to B10 may correspond to the mobile data arranged in the existent mobile data area. On the contrary, the blocks SB1 to SB5 may correspond to the new mobile data allocated in the existent normal data area. SB5 refers to an area that contains MPEG header and RS parity for backward compatibility.

Like the existent mobile data area, blocks B1 to B10 may each be made of 16 segments, block SB4 may be made of 31 segments, and blocks SB2 and SB3 may each be made of 14 segments. Block SB1 may have different length of distributed segments, depending on mode. If normal data is not transmitted in any frame, i.e., if all the 19.4 Mbps data rate is filled with mobile data, block SB1 may be made of 32 segments. If normal data is transmitted even partially, block SB1 may be made of 31 segments.

Block SB5 is where the MPEG header and the RS parity existing in the 51 segments of the body area are distributed, and if normal data is not transmitted in any of the frames, i.e., if mobile data is filled at 19.4 Mbps data rate, the mobile data may be filled to define block SB5. This corresponds to the non-compatible mode explained above. If all the allocated data is mobile data and thus it is unnecessary to consider compatibility, the area for the MPEG header and the RS parity provided for compatibility with the receiver for receiving existent normal data may be re-defined as mobile data and used accordingly.

Meanwhile, as explained above, the blocks B1 to B10, SB1 to SB5 may be combined in various patterns for block coding.

That is, if SCCC block mode is 00 (Separate Block), the SCCC outer code mode may be implemented differently from each other for Group Regions (A, B, C, D). On the contrary, if SCCC block mode is 01 (Paired Block), the SCCC outer code mode of the all the regions are identical. For example, the newly added mobile data blocks SB1 and SB4 follow SCCC outer code mode set for Group Region C, and blocks SB2 and SB3 follow the SCCC outer code mode set in Group Region D. Lastly, block SB5 follows the SCCC outer code mode set in Group Region A.

To be specific, if block SB5 is derived, this means that the service is performed with the mobile data only. Even in this case, SB5 coding may be implemented differently, by considering compatibility between the receiver which receives existent mobile data and a receiver which additionally receives new mobile data.

That is, if the slots derived from block SB5 are in the Separate Block mode according to which the primary ensemble is filled with 1.0 mobile data and the secondary ensemble is filed with 1.1 mobile data, compatibility is maintained between the receivers of the respective mobile data. Accordingly, the SB5 block may be coded independently.

Meanwhile, if the slots derived from block SB5 are in the Paired Block mode, since it is a single frame where only the 1.1 mobile data is filled, compatibility between existent mobile data receivers is not of concern. Accordingly, block SB5 may be absorbed into part of the existent body area and coded.

To be specific, in a non-compatible mode (i.e., Scalable Mode 11) in which new mobile data is arranged in the whole second area in one slot, the SB5 coding may be applied differently depending on block modes. For example, in the Separate mode where the block mode set with respect to corresponding slots allows coexistence of the existent mobile data and the new mobile data, SB5 block, which contains MPEG header and RS parity areas, may be coded independently from the body area within the corresponding slot. However, in the Paired Block mode in which only the new mobile data exists, the SB5 block, which contains MPEG header and RS parity areas, may be coded along with the rest area of the body area. Accordingly, block-coding can be performed in various manners.

Accordingly, upon receiving the TS, the digital broadcast receiver checks the mode according to the signaling data, and detects and reproduces the new mobile data appropriately according to the mode. That is, if the new mobile data is transmitted in the Paired Block mode in the non-compatible mode (i.e., fifth mode or Scalable Mode 11), the receiver may perform decoding the SB5 block along with the mobile data included in the existent body area, without separating decoding the SB5 block.

Meanwhile, as explained above, if known data, i.e., a training sequence, is present, the memories within the trellis encoder are initialized before the training sequence is trellis-encoded. In this situation, the initialization byte, which is prepared for the memory initialization, is arranged prior to the training sequence.

FIG. 56 illustrates a stream construction after interleaving. Referring to FIG. 56, the training sequence appears in the form of a plurality of long training sequences in the body area, and also appears in the form of a plurality of long training sequences in the head/tail areas. To be specific, total 5 long training sequences appear in the head/tail areas. Among the training sequences, the second, third, and fourth training sequences may be set so that the trellis initialization byte starts not from the first byte of each segment, but starts after a predetermined number of bytes.

The change of location of the trellis initialization byte is not limited to the head/tail areas only. That is, a plurality of long training sequences included in the body area may also be designed so that the trellis initialization byte of some of the long training sequences start after a predetermined number of bytes of each segment.

[PL, SOBL, SIBL Sizes Depending on Block Modes]

Meanwhile, depending on block modes, RS Frame Portion Length (PL), SCCC output block length (SOBL), or SCCC input block length (SIBL) may be varied. Table 19 below lists the PL of the primary RS frame when RS frame mode is 00 (i.e., single frame), SCCC block mode is 00 (i.e., Separate Block), and SCCC Block Extension Mode is 01.

TABLE 19

| SCCC Outer Code Mode Combinations | | | | | | | | |
|---|---|---|---|---|---|---|---|---|
| | | For | For | | | | | |
| | | Region | Region | | | | | |
| For | | C, | D, | | | | | |
| Region A | | M/H | M/H | | | | | |
| and M/H | | Blocks | Blocks | PL | | | | |
| Block | For | SB1 and | SB2 and | Scalable | Scalable | Scalable | Scalable | Scalable |
| SB5 | Region B | SB4 | SB3 | Mode 00 | Mode 01 | Mode 10 | Mode 11 | Mode 11a |
| 00 | 00 | 00 | 00 | 10440 | 11094 | 11748 | 13884 | 12444 |
| 00 | 00 | 00 | 10 | 10138 | 10678 | 11216 | 13126 | 11766 |
| 00 | 00 | 00 | 01 | 9987 | 10470 | 10950 | 12747 | 11427 |
| 00 | 00 | 10 | 00 | 9810 | 10360 | 10912 | 12698 | 11522 |
| 00 | 00 | 10 | 10 | 9508 | 9944 | 10380 | 11940 | 10844 |
| 00 | 00 | 10 | 01 | 9357 | 9736 | 10114 | 11561 | 10505 |
| 00 | 00 | 01 | 00 | 9495 | 9993 | 10494 | 12105 | 11061 |
| 00 | 00 | 01 | 10 | 9193 | 9577 | 9962 | 11347 | 10383 |
| 00 | 00 | 01 | 01 | 9042 | 9369 | 9696 | 10968 | 10044 |
| 00 | 10 | 00 | 00 | 9626 | 10280 | 10934 | 13070 | 11630 |
| 00 | 10 | 00 | 10 | 9324 | 9864 | 10402 | 12312 | 10952 |
| 00 | 10 | 00 | 01 | 9173 | 9656 | 10136 | 11933 | 10613 |
| 00 | 10 | 10 | 00 | 8996 | 9546 | 10098 | 11884 | 10708 |
| 00 | 10 | 10 | 10 | 8694 | 9130 | 9566 | 11126 | 10030 |
| 00 | 10 | 10 | 01 | 8543 | 8922 | 9300 | 10747 | 9691 |
| 00 | 10 | 01 | 00 | 8681 | 9179 | 9680 | 11291 | 10247 |
| 00 | 10 | 01 | 10 | 8379 | 8763 | 9148 | 10533 | 9569 |
| 00 | 10 | 01 | 01 | 8228 | 8555 | 8882 | 10154 | 9230 |
| 00 | 01 | 00 | 00 | 9219 | 9873 | 10527 | 12663 | 11223 |
| 00 | 01 | 00 | 10 | 8917 | 9457 | 9995 | 11905 | 10545 |
| 00 | 01 | 00 | 01 | 8766 | 9249 | 9729 | 11526 | 10206 |
| 00 | 01 | 10 | 00 | 8589 | 9139 | 9691 | 11477 | 10301 |
| 00 | 01 | 10 | 10 | 8287 | 8723 | 9159 | 10719 | 9623 |
| 00 | 01 | 10 | 01 | 8136 | 8515 | 8893 | 10340 | 9284 |
| 00 | 01 | 01 | 00 | 8274 | 8772 | 9273 | 10884 | 9840 |
| 00 | 01 | 01 | 10 | 7972 | 8356 | 8741 | 10126 | 9162 |
| 00 | 01 | 01 | 01 | 7821 | 8148 | 8475 | 9747 | 8823 |
| 10 | 00 | 00 | 00 | 8706 | 9360 | 10014 | 12422 | 10710 |
| 10 | 00 | 00 | 10 | 8404 | 8944 | 9482 | 11256 | 10032 |
| 10 | 00 | 00 | 01 | 8253 | 8736 | 9216 | 10877 | 9693 |
| 10 | 00 | 10 | 00 | 8076 | 8626 | 9178 | 10828 | 9788 |
| 10 | 00 | 10 | 10 | 7774 | 8210 | 8646 | 10070 | 9110 |
| 10 | 00 | 10 | 01 | 7623 | 8002 | 8380 | 9691 | 8771 |
| 10 | 00 | 01 | 00 | 7761 | 8259 | 8760 | 10235 | 9327 |
| 10 | 00 | 01 | 10 | 7459 | 7843 | 8228 | 9477 | 8649 |
| 10 | 00 | 01 | 01 | 7308 | 7635 | 7962 | 9098 | 8310 |
| 10 | 10 | 00 | 00 | 7892 | 8546 | 9200 | 11200 | 9896 |
| 10 | 10 | 00 | 10 | 7590 | 8130 | 8668 | 10442 | 9218 |
| 10 | 10 | 00 | 01 | 7439 | 7922 | 8402 | 10063 | 8879 |
| 10 | 10 | 10 | 00 | 7262 | 7812 | 8364 | 10014 | 8974 |
| 10 | 10 | 10 | 10 | 6960 | 7396 | 7832 | 9256 | 8296 |
| 10 | 10 | 10 | 01 | 6809 | 7188 | 7566 | 8877 | 7957 |
| 10 | 10 | 01 | 00 | 6947 | 7445 | 7946 | 9421 | 8513 |
| 10 | 10 | 01 | 10 | 6645 | 7029 | 7414 | 8663 | 7835 |
| 10 | 10 | 01 | 01 | 6494 | 6821 | 7148 | 8284 | 7496 |
| 10 | 01 | 00 | 00 | 7485 | 8139 | 8793 | 10793 | 9489 |
| 10 | 01 | 00 | 10 | 7183 | 7723 | 8261 | 10035 | 8811 |
| 10 | 01 | 00 | 01 | 7032 | 7515 | 7995 | 9656 | 8472 |
| 10 | 01 | 10 | 00 | 6855 | 7405 | 7957 | 9607 | 8567 |
| 10 | 01 | 10 | 10 | 6553 | 6989 | 7425 | 8849 | 7889 |
| 10 | 01 | 10 | 01 | 6402 | 6781 | 7159 | 8470 | 7550 |
| 10 | 01 | 01 | 00 | 6540 | 7038 | 7539 | 9014 | 8106 |
| 10 | 01 | 01 | 10 | 6238 | 6622 | 7007 | 8256 | 7428 |
| 10 | 01 | 01 | 01 | 6087 | 6414 | 6741 | 7877 | 7089 |
| 01 | 00 | 00 | 00 | 7839 | 8493 | 9147 | 11079 | 9843 |
| 01 | 00 | 00 | 10 | 7537 | 8077 | 8615 | 10321 | 9165 |
| 01 | 00 | 00 | 01 | 7386 | 7869 | 8349 | 9942 | 8826 |
| 01 | 00 | 10 | 00 | 7209 | 7759 | 8311 | 9893 | 8921 |
| 01 | 00 | 10 | 10 | 6907 | 7343 | 7779 | 9135 | 8243 |
| 01 | 00 | 10 | 01 | 6756 | 7135 | 7513 | 8756 | 7904 |
| 01 | 00 | 01 | 00 | 6894 | 7392 | 7893 | 9300 | 8460 |
| 01 | 00 | 01 | 10 | 6592 | 6976 | 7361 | 8542 | 7782 |
| 01 | 00 | 01 | 01 | 6441 | 6768 | 7095 | 8163 | 7443 |
| 01 | 10 | 00 | 00 | 7025 | 7679 | 8333 | 10265 | 9029 |
| 01 | 10 | 00 | 10 | 6723 | 7263 | 7801 | 9507 | 8351 |
| 01 | 10 | 00 | 01 | 6572 | 7055 | 7535 | 9128 | 8012 |
| 01 | 10 | 10 | 00 | 6395 | 6945 | 7497 | 9079 | 8107 |
| 01 | 10 | 10 | 10 | 6093 | 6529 | 6965 | 8321 | 7429 |
| 01 | 10 | 10 | 01 | 5942 | 6321 | 6699 | 7942 | 7090 |
| 01 | 10 | 01 | 00 | 6080 | 6578 | 7079 | 8486 | 7646 |
| 01 | 10 | 01 | 10 | 5778 | 6162 | 6547 | 7728 | 6968 |
| 01 | 10 | 01 | 01 | 5627 | 5954 | 6281 | 7349 | 6629 |
| 01 | 01 | 00 | 00 | 6618 | 7272 | 7926 | 9858 | 8622 |
| 01 | 01 | 00 | 10 | 6316 | 6856 | 7394 | 9100 | 7944 |
| 01 | 01 | 00 | 01 | 6165 | 6648 | 7128 | 8721 | 7605 |
| 01 | 01 | 10 | 00 | 5988 | 6538 | 7090 | 8672 | 7700 |
| 01 | 01 | 10 | 10 | 5686 | 6122 | 6558 | 7914 | 7022 |
| 01 | 01 | 10 | 01 | 5535 | 5914 | 6292 | 7535 | 6683 |
| 01 | 01 | 01 | 00 | 5673 | 6171 | 6672 | 8079 | 7239 |
| 01 | 01 | 01 | 10 | 5371 | 5755 | 6140 | 7321 | 6561 |
| 01 | 01 | 01 | 01 | 5220 | 5547 | 5874 | 6942 | 6222 |

| | | | | | |
|---|---|---|---|---|---|
| Others | Undefined | Undefined | Undefined | Undefined | Undefined |

Further, Table 20 below lists the PL of the primary RS frame when RS frame mode is 00 (i.e., single frame), SCCC block mode is 01 (i.e., Paired Block), and SCCC Block Extension Mode is 01.

TABLE 20

| | PL | | | | |
|---|---|---|---|---|---|
| SCCC | | | | | Scalable |
| Outer Code | Scalable | Scalable | Scalable | Scalable | Mode |
| Mode | Mode 00 | Mode 01 | Mode 10 | Mode 11 | 11a |
| 00 | 10440 | 11094 | 11748 | 13884 | 12444 |
| 10 | 6960 | 7396 | 7832 | 9256 | 8296 |
| 01 | 5220 | 5547 | 5874 | 6942 | 6222 |

| | |
|---|---|
| Others | Undefined |

Further, Table 21 below lists the PL of the secondary RS frame when RS frame mode is 01 (i.e., dual frame), SCCC block mode is 00 (i.e., Separated Block), and SCCC Block Extension Mode is 01.

TABLE 21

| SCCC Outer Code | | | | | | | |
|---|---|---|---|---|---|---|---|
| Mode Combinations | | | | | | | |
| For | | | | | | | |
| Region | | | | | | | |
| C, | | | | | | | |
| M/H | For Region | | | | | | |
| Blocks | D, M/H | | PL | | | | |
| SB1 | Blocks | | | | | | Scalable |
| and | SB2 and | For M/H | Scalable | Scalable | Scalable | Scalable | Mode |
| SB4 | SB3 | Block SB5 | Mode 00 | Mode 01 | Mode 10 | Mode 11 | 11a |
| 00 | 00 | 00 | 2796 | 3450 | 4104 | 6240 | 4800 |
| 00 | 10 | 00 | 2494 | 3034 | 3572 | 5482 | 4122 |
| 00 | 01 | 00 | 2343 | 2826 | 3306 | 5103 | 3783 |
| 10 | 00 | 00 | 2166 | 2716 | 3268 | 5054 | 3878 |
| 10 | 10 | 00 | 1864 | 2300 | 2736 | 4296 | 3200 |
| 10 | 01 | 00 | 1713 | 2092 | 2470 | 3917 | 2861 |
| 01 | 00 | 00 | 1851 | 2349 | 2850 | 4461 | 3417 |
| 01 | 10 | 00 | 1549 | 1933 | 2318 | 3703 | 2739 |
| 01 | 01 | 00 | 1398 | 1725 | 2052 | 3324 | 2400 |
| 00 | 00 | 01 | 2796 | 3450 | 4104 | 6036 | 4800 |
| 00 | 10 | 01 | 2494 | 3034 | 3572 | 5278 | 4122 |
| 00 | 01 | 01 | 2343 | 2826 | 3306 | 4899 | 3783 |
| 10 | 00 | 01 | 2166 | 2716 | 3268 | 4850 | 3878 |
| 10 | 10 | 01 | 1864 | 2300 | 2736 | 4092 | 3200 |
| 10 | 01 | 01 | 1713 | 2092 | 2470 | 3713 | 2861 |
| 01 | 00 | 01 | 1851 | 2349 | 2850 | 4257 | 3417 |
| 01 | 10 | 01 | 1549 | 1933 | 2318 | 3499 | 2739 |
| 01 | 01 | 01 | 1398 | 1725 | 2052 | 3120 | 2400 |

| | | | | | |
|---|---|---|---|---|---|
| Others | Undefined | Undefined | Undefined | Undefined | Undefined |

Further, Table 22 below lists the SOBL and SIBL when SCCC block mode is 00 (i.e., Separated Block), RS frame mode is 00 (i.e., single frame), and SCCC Block Extension Mode is 01.

TABLE 22

| | SOBL | | | | | | | | | |
|---|---|---|---|---|---|---|---|---|---|---|
| | Scalable | Scalable | Scalable | Scalable | Scalable | Scalable | Scalable | Scalable | Scalable | Scalable |
| | Mode | Mode | Mode | Mode | Mode | Mode | Mode | Mode | Mode | Mode |
| SCCC Block | 00 | 01 | 10 | 11 | 11a | 00 | 01 | 10 | 11 | 11a |
| | | | | | | SIBL | | | | |
| | | | | | | ½ rate | | | | |
| SCB1 (B1 + | 888 | 1212 | 1536 | 2280 | 1932 | 444 | 606 | 768 | 1140 | 966 |
| SB3) | | | | | | | | | | |
| SCB2 (B2 + | 1872 | 2160 | 2412 | 3432 | 2568 | 936 | 1080 | 1206 | 1716 | 1284 |
| SB4) | | | | | | | | | | |
| SCB3 (B3) | 2376 | 2376 | 2376 | 2376 | 2376 | 1188 | 1188 | 1188 | 1188 | 1188 |
| SCB4 (B4) | 2388 | 2388 | 2388 | 2388 | 2388 | 1194 | 1194 | 1194 | 1194 | 1194 |
| SCB5 (B5) | 2772 | 2772 | 2772 | 2772 | 2772 | 1386 | 1386 | 1386 | 1386 | 1386 |
| SCB6 (B6) | 2472 | 2472 | 2472 | 2472 | 2472 | 1236 | 1236 | 1236 | 1236 | 1236 |
| SCB7 (B7) | 2772 | 2772 | 2772 | 2772 | 2772 | 1386 | 1386 | 1386 | 1386 | 1386 |
| SCB8 (B8) | 2508 | 2508 | 2508 | 2508 | 2508 | 1254 | 1254 | 1254 | 1254 | 1254 |
| SCB9 (B9 + | 1908 | 2244 | 2604 | 3684 | 2964 | 954 | 1122 | 1302 | 1842 | 1482 |
| SB1) | | | | | | | | | | |
| SCB10 (B10 + | 924 | 1284 | 1656 | 2268 | 2136 | 462 | 642 | 828 | 1134 | 1068 |
| SB2) | | | | | | | | | | |
| SCB11 (SB5) | 0 | 0 | 0 | 816 | 0 | 0 | 0 | 0 | 408 | 0 |
| | | | | | | SIBL | | | | |
| | | | | | | ⅓ rate | | | | |
| SCB1 (B1 + | 888 | 1212 | 1536 | 2280 | 1932 | 296 | 404 | 512 | 760 | 644 |
| SB3) | | | | | | | | | | |
| SCB2 (B2 + | 1872 | 2160 | 2412 | 3432 | 2568 | 624 | 720 | 804 | 1144 | 856 |
| SB4) | | | | | | | | | | |
| SCB3 (B3) | 2376 | 2376 | 2376 | 2376 | 2376 | 792 | 792 | 792 | 792 | 792 |
| SCB4 (B4) | 2388 | 2388 | 2388 | 2388 | 2388 | 796 | 796 | 796 | 796 | 796 |
| SCB5 (B5) | 2772 | 2772 | 2772 | 2772 | 2772 | 924 | 924 | 924 | 924 | 924 |
| SCB6 (B6) | 2472 | 2472 | 2472 | 2472 | 2472 | 824 | 824 | 824 | 824 | 824 |
| SCB7 (B7) | 2772 | 2772 | 2772 | 2772 | 2772 | 924 | 924 | 924 | 924 | 924 |
| SCB8 (B8) | 2508 | 2508 | 2508 | 2508 | 2508 | 836 | 836 | 836 | 836 | 836 |
| SCB9 (B9 + | 1908 | 2244 | 2604 | 3684 | 2964 | 636 | 748 | 868 | 1228 | 988 |
| SB1) | | | | | | | | | | |
| SCB10 (B10 + | 924 | 1284 | 1656 | 2268 | 2136 | 308 | 428 | 552 | 756 | 712 |
| SB2) | | | | | | | | | | |
| SCB11 (SB5) | 0 | 0 | 0 | 816 | 0 | 0 | 0 | 0 | 272 | 0 |
| | | | | | | SIBL | | | | |
| | | | | | | ¼ rate | | | | |
| SCB1 (B1 + | 888 | 1212 | 1536 | 2280 | 1932 | 222 | 303 | 384 | 570 | 483 |
| SB3) | | | | | | | | | | |
| SCB2 (B2 + | 1872 | 2160 | 2412 | 3432 | 2568 | 468 | 540 | 603 | 858 | 642 |
| SB4) | | | | | | | | | | |
| SCB3 (B3) | 2376 | 2376 | 2376 | 2376 | 2376 | 594 | 594 | 594 | 594 | 594 |
| SCB4 (B4) | 2388 | 2388 | 2388 | 2388 | 2388 | 597 | 597 | 597 | 597 | 597 |
| SCB5 (B5) | 2772 | 2772 | 2772 | 2772 | 2772 | 693 | 693 | 693 | 693 | 693 |
| SCB6 (B6) | 2472 | 2472 | 2472 | 2472 | 2472 | 618 | 618 | 618 | 618 | 618 |
| SCB7 (B7) | 2772 | 2772 | 2772 | 2772 | 2772 | 693 | 693 | 693 | 693 | 693 |
| SCB8 (B8) | 2508 | 2508 | 2508 | 2508 | 2508 | 627 | 627 | 627 | 627 | 627 |
| SCB9 (B9 + | 1908 | 2244 | 2604 | 3684 | 2964 | 477 | 561 | 651 | 921 | 741 |
| SB1) | | | | | | | | | | |
| SCB10 (B10 + | 924 | 1284 | 1656 | 2268 | 2136 | 231 | 321 | 414 | 567 | 534 |
| SB2) | | | | | | | | | | |
| SCB11 (SB5) | 0 | 0 | 0 | 816 | 0 | 0 | 0 | 0 | 204 | 0 |

Further, Table 23 below lists the SOBL and SIBL when SCCC block mode is 01 (i.e., Paired Block), RS frame mode is 01 (i.e., dual frame), and SCCC Block Extension Mode is 01.

TABLE 23

| | SOBL1 | | | | | | | | | |
|---|---|---|---|---|---|---|---|---|---|---|
| | Scalable | Scalable | Scalable | Scalable | Scalable | Scalable | Scalable | Scalable | Scalable | Scalable |
| | Mode | Mode | Mode | Mode | Mode | Mode | Mode | Mode | Mode | Mode |
| SCCC Block | 00 | 01 | 10 | 11 | 11a | 00 | 01 | 10 | 11 | 11a |
| | | | | | | SIBL | | | | |
| | | | | | | ½ rate | | | | |
| SCB1 (B1 + B6 + | 3360 | 3684 | 4008 | 4752 | 4404 | 1680 | 1842 | 2004 | 2376 | 2202 |
| SB3) | | | | | | | | | | |
| SCB2 (B2 + B7 + | 4644 | 4932 | 5184 | 6204 | 5340 | 2322 | 2466 | 2592 | 3102 | 2670 |
| SB4) | | | | | | | | | | |
| SCB3 (B3 + B8) | 4884 | 4884 | 4884 | 4884 | 4884 | 2442 | 2442 | 2442 | 2442 | 2442 |
| SCB4 (B4 + B9 + | 4296 | 4632 | 4992 | 6072 | 5352 | 2148 | 2316 | 2496 | 3036 | 2676 |
| SB1) | | | | | | | | | | |
| SCB5 (B5 + B10 + | 3696 | 4056 | 4428 | 5040 | 4908 | 1848 | 2028 | 2214 | 2520 | 2454 |
| SB2) | | | | | | | | | | |
| SCB6 (SB5) | 0 | 0 | 0 | 816 | 0 | 0 | 0 | 0 | 408 | 0 |
| | | | | | | SIBL | | | | |
| | | | | | | ⅓ rate | | | | |
| SCB1 (B1 + B6 + | 3360 | 3684 | 4008 | 4752 | 4404 | 1120 | 1228 | 1336 | 1584 | 1468 |
| SB3) | | | | | | | | | | |
| SCB2 (B2 + B7 + | 4644 | 4932 | 5184 | 6204 | 5340 | 1548 | 1644 | 1728 | 2068 | 1780 |
| SB4) | | | | | | | | | | |
| SCB3 (B3 + B8) | 4884 | 4884 | 4884 | 4884 | 4884 | 1628 | 1628 | 1628 | 1628 | 1628 |
| SCB4 (B4 + B9 + | 4296 | 4632 | 4992 | 6072 | 5352 | 1432 | 1544 | 1664 | 2024 | 1784 |
| SB1) | | | | | | | | | | |
| SCB5 (B5 + B10 + | 3696 | 4056 | 4428 | 5040 | 4908 | 1232 | 1352 | 1476 | 1680 | 1636 |
| SB2) | | | | | | | | | | |
| SCB6 (SB5) | 0 | 0 | 0 | 816 | 0 | 0 | 0 | 0 | 272 | 0 |
| | | | | | | SIBL | | | | |
| | | | | | | ¼ rate | | | | |
| SCB1 (B1 + B6 + | 3360 | 3684 | 4008 | 4752 | 4404 | 840 | 921 | 1002 | 1188 | 1101 |
| SB3) | | | | | | | | | | |
| SCB2 (B2 + B7 + | 4644 | 4932 | 5184 | 6204 | 5340 | 1161 | 1233 | 1296 | 1551 | 1335 |
| SB4) | | | | | | | | | | |
| SCB3 (B3 + B8) | 4884 | 4884 | 4884 | 4884 | 4884 | 1221 | 1221 | 1221 | 1221 | 1221 |
| SCB4 (B4 + B9 + | 4296 | 4632 | 4992 | 6072 | 5352 | 1074 | 1158 | 1248 | 1518 | 1338 |
| SB1) | | | | | | | | | | |
| SCB5 (B5 + B10 + | 3696 | 4056 | 4428 | 5040 | 4908 | 924 | 1014 | 1107 | 1260 | 1227 |
| SB2) | | | | | | | | | | |
| SCB6 (SB5) | 0 | 0 | 0 | 816 | 0 | 0 | 0 | 0 | 204 | 0 |

As explained above, PL, SOBL, SIBL of various sizes may be implemented depending on block modes. However, the above tables provide only illustrative examples, and accordingly, an exemplary embodiment is not limited to the specific examples.

[Initialization]

As explained above, initialization is performed when the known data, i.e., training data, is included in the stream. That is, in an ATSC-M/H transmission system, the trellis encoder may be initialized to suit the training sequence to be generated, and known bytes may be defined to enable the receiver to perceive the training sequence.

In the group format of BEM 00 mode, trellis initialization bytes are located on the boundary of the respective serrations, and known bytes are distributed therebeyond. As the trellis encoding is performed from the upper to the lower segments and from the left to the right bytes, trellis encoding is performed on the boundary of the serrations where the data of the other slots are filled. Accordingly, since it is impossible to anticipate the trellis encoder memory value on the boundary of the serration where the data of the next, current slot is filled, the trellis encoder is to be initialized in every boundary of the serration. Referring to FIGS. 56 and 57, the initialization bytes are distributed on the serration boundary of the head area made of blocks B1 and B2, and the initialization bytes may also be distributed on the serration boundary of the tail area made of blocks SB1 to SB4.

If two slots are adjacent in BEM 00, the short training data of the respective head/tail areas is successively connected by being located on the same segments, thereby acting as one long training data. As explained above, if two BEM 00 slots are adjacent to each other, causing concatenation of training, only the first maximum 12 initialization bytes of the segments having the training data therein may be used for the initialization mode, while the initialization bytes existing on the area where the serrations meet may be inputted like the known bytes and trellis-encoded.

Except for the first maximum 12 initialization bytes of the segment, the intermediate initialization bytes existing in an area where the serrations meet may be inputted as the known bytes or as initialization bytes depending on whether the BEM 00 slot is adjacent to the same slot or adjacent to slot other than BEM 00. That is, the operation of the trellis encoder may be multiplexing in normal mode or multiplexing in initialization mode during the intermediate initialization bytes. Since generated symbols change according to the mode of multiplexing the input at the trellis encoder, the symbol values to be used as the training sequence at the receiver may also change. Accordingly, to minimize the confusion at the receiver, if the long training sequence is constructed by the two adjacent BEM 00 slots, based on the symbols generated by multiplexing all the intermediate initialization bytes with the known bytes, the intermediate initialization bytes to be used in initialization mode may be determined, if the BEM 00 slot is not adjacent to the same slot. That is, it is possible to determine the intermediate initialization bytes to obtain the same value as the long training symbol values as generated in the case of concatenation. The symbol values for the first two symbols of the intermediate initialization bytes may be different from the symbol values generated in the case of concatenation.

As explained above, a method for processing a stream at a digital broadcast transmitter may be implemented so that the long training sequence is formed on the boundary of the successive slots.

That is, the method for processing the stream at the transmitter may include a stream constructing step of constructing a stream in which slots having a plurality of blocks are arranged successively, and a transmission step of encoding and interleaving the stream and outputting as a transport stream.

If the slots, which are set to Block Extension Mode 00 to use the whole blocks within corresponding slots, are arranged successively, the stream constructing step may include arranging known data in a preset segment of each of the successive slots so that the long training sequence is formed in the boundary of the successive slots with the serration patterns thereof meeting each other. The Block Extension Mode 00 refers to a mode in which even the blocks B1 and B2 are used in that slot. Accordingly, in the boundary with the next slot, serrations of the preceding slot and those of the following slot are interlocked with each other. In this case, the known data are arranged at appropriate segment locations of the preceding slot and the following slot so that the known data continue after the serrations of the two slots. To be specific, by arranging the known data in the approximately 130th segment of the preceding slot and arranging the known data on the 15th segment of the following slot, the known data is connected at the boundary area to thus form one long training sequence.

If the first known data arranged on the serrations of the preceding slot and the second known data arranged on the serrations of the following slot are alternately connected at a boundary area, the first and second known data values may be preset to form a known long training sequence between the digital broadcast receiver.

Alternatively, the known data may be inserted to have the same sequence with reference to the long training sequence used in the slot of Block Extension Mode 01 which causes some blocks within the corresponding slot to be provided to the other slots.

FIG. 64 illustrates a stream construction before interleaving in Block Extension mode 00, and FIG. 65 illustrates a stream construction after interleaving in Block Extension mode 00.

Meanwhile, if the known data is arranged in the form of the long training sequence as explained above, initialization is not necessary for each of the known data areas. Accordingly, the operation may include a step of initializing the trellis encoder before trellis encoding of the known data corresponding to the first part of the long training sequence.

On the contrary, if the slots, which are set to different Block Extension Modes, are arranged successively, the known data does not continue on the boundary area. Accordingly, in this case, the transmission step may include initializing the trellis encoder before every trellis encoding of the known data arranged on the serrations at the boundary of the successively-arranged slots.

Meanwhile, as explained above, if the known data is arranged on the boundary area and transmitted in the form of the long training sequence, the method for processing a stream at the digital broadcast receiver may be implemented suitably.

That is, the method for processing a stream at the digital broadcast receiver may include a receiving step of receiving an encoded and interleaved transport stream in which slots having a plurality of blocks are arranged successively, demodulating the received TS, equalizing the demodulated TS, and decoding the new mobile data from the equalized stream.

The respective slots of the TS may include at least one of normal data, existent mobile data, and new mobile data.

Further, if slots, which are set to Block Extension Mode 00, are arranged successively to use the whole blocks within the corresponding slot, the TS may have known data arranged on a preset segment of each of the successive slots so that the long training sequence is formed on a boundary of the successive slots where the serrations thereof meet.

As explained above, the known data at the boundary of the preceding and following successive slots may be continuously connected to form a known long training sequence between the digital broadcast transmitter.

Further, such a long training sequence may have the same sequence with reference to the long training sequence used in the slot of Block Extension Mode 01 to provide some blocks within the corresponding slot to the other slots.

The digital broadcast receiver may check the Block Extension Mode of the respective slots to determine whether the long training sequence is used or not.

That is, the method for processing a stream of the digital broadcast receiver may additionally include a step of decoding signaling data with respect to the respective slots and checking the Block Extension Modes of the respective slots. To be specific, the Block Extension Mode may be recorded in the TPC of each slot.

In the above case, the digital broadcast receiver may delay data detection and processing until the Block Extension Mode of the next slot is checked, even when reception of one slot is completed. That is, if decoding of the signaling data of the following slot in the successive slots is completed, revealing that the next slot has Block Extension Mode 00, the operation may include a step of detecting the known data at the serrations on the boundary of the successive slots as the long training sequence and processing the same.

Meanwhile, in another exemplary embodiment, the signaling data of each slot may be implemented to reveal information about the neighboring slots.

In the above case, the digital broadcast receiver may perform a step of decoding the signaling data of the preceding slot in the successive slots and checking the Block Extension Modes of the preceding and following slots.

The method for processing a stream at a digital broadcast transmitter and a digital broadcast receiver explained above may be implemented in a digital broadcast transmitter and a digital broadcast receiver having the construction as explained and illustrated herein. By way of example, the digital broadcast receiver may include the basic constituents such as receiving unit, demodulating unit, equalization unit, and decoding unit, and additional constituents such as a detection unit to detect and process known data. In this case, upon determining that two slots of Block Extension Mode 00 are received, the detection unit may detect the long training data arranged on the boundary of the slots to use it for error correction. The detection unit may also provide the result of detection to at least one of the demodulating unit, equalization unit and decoding unit.

[Location of Training Data in Consideration of RS Parity]

Since the segment data changes during the initialization of the trellis encoder, a previously-calculated RS parity value is to be changed with respect to the segment for which the RS parity value has already been determined, in order to ensure normal operation of the receiver without error. If the packets have a trellis initialization byte, 20 non-systematic RS parity of the corresponding packets cannot come before the trellis initialization byte. The trellis initialization bytes only exist at a location where the above restriction is satisfied, and training data can be generated by such initialization byte.

Referring to FIGS. 64 and 65, in order to arrange the trellis initialization byte before the RS parity, the location of the RS parity is changed differently from the group format of BEM 01 slot. That is, in the group format of BEM 01 slot, only RS parities are located in the first 5 segments among the 208 data segments after interleaving. However, in BEM 00 slot's case, referring to FIGS. 64 and 65, the location of the RS parities may be changed to fill the lower portion of the block B2.

In consideration of the changed RS parities, the training data distributed in BEM 00 slot may be located so that first, second, and third training data may be placed in 7th and 8th segments, 20th and 21st segments, and 31st and 32nd segments of blocks B1 and B2. The changed RS parities may be placed in the 33rd to 37th segments of block B1 and B2 area. Further, in the tail area, first, second, third, fourth, and fifth training data may be placed in the 134th and 135th segments, 150th and 151st segments, 163rd and 164th segments, 176th and 177th segments, and 187th and 188th segments. If two BEM 00 slots are adjacent to each other to generate concatenated long training data, first training data of the blocks B1 and B2 area and the third training data of the tail, the second training data of blocks B1 and B2, and the fourth training data of the tail area, and the third training data of the block B1 and B2 area and the fifth training data of the tail may be connected to each other.

As explained above, training data can be arranged in various matters and initialization can be performed accordingly.

The digital broadcast receiver detects the training data from a location where the training data is arranged. To be specific, the detection unit or signaling decoder illustrated in FIG. 52 may detect the information to indicate the location where the training data is arranged. Accordingly, it is possible to detect the training data at the checked location and perform error correction.

While not restricted thereto, an exemplary embodiment can be embodied as computer-readable code on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Also, an exemplary embodiment may be written as a computer program transmitted over a computer-readable transmission medium, such as a carrier wave, and received and implemented in general-use or special-purpose digital computers that execute the programs. Moreover, it is understood that in exemplary embodiments, one or more units of the above-described apparatuses, transmitters, and receivers can include circuitry, a processor, a microprocessor, etc., and may execute a computer program stored in a computer-readable medium.

The foregoing exemplary embodiments and advantages are merely exemplary and are not to be construed as limiting the present inventive concept. The present teaching can be readily applied to other types of apparatuses. Also, the description of exemplary embodiments is intended to be illustrative, and not to limit the scope of the claims, and many alternatives, modifications, and variations will be apparent to those skilled in the art.

1. A method for processing a stream of a digital broadcast transmitter, the method comprising:
arranging second mobile data in a slot according to a predetermined mode, the slot comprising a first area allocated for first mobile data and a second area allocated for normal data;
constructing a stream in which known data and the second mobile data are arranged; and
encoding and interleaving the stream and outputting the encoded and interleaved stream,
wherein the predetermined mode is a mode to arrange the second mobile data within at least part of the second area.

2. The method of claim 1, wherein the second area is made of 38 packets, and the mode to arrange the second mobile data in the at least part of the second area comprises at least one of:
a first mode to arrange the second mobile data in the 38 packets at ¼ rate;
a second mode to arrange the second mobile data in the 38 packets at 2/4 rate;
a third mode to arrange the second mobile data in the 38 packets at ¾ rate; and
a fourth mode to arrange the second mobile data in all of the 38 packets.

3. The method of claim 1, wherein, if the second mobile data is arranged in all of the second area in one slot, the arranging comprises:
if a block mode set for a corresponding slot is a Separate mode, coding a block containing an MPEG header and a Reed Solomon (RS) parity area independently from a body area within the slot; and
if the block mode is a Paired mode, coding the block containing the MPEG header and the RS parity area along with the body area.

4. The method of claim 1, further comprising encoding signaling data to notify a receiver of the predetermined mode, wherein the signaling data comprises a preset number of bits to notify the predetermined mode.

5. The method of claim 2, further comprising encoding signaling data to notify a receiver of the predetermined mode, wherein the signaling data comprises 3 bits which are recorded as 000 to indicate the first mode, 001 to indicate the second mode, 010 to indicate the third mode, 011 to indicate the fourth mode, and 111 to indicate a fifth mode in which the second mobile data is arranged in an MPEG header and an RS parity area and all of the second area.

6. The method of claim 1, wherein:
the encoding and interleaving comprises dividing, by the interleaving, the TS into a body area and head/tail areas;
the known data is arranged in the body area and the head/tail area, respectively, in a form of a plurality of long training sequences; and
an initialization byte is arranged immediately before a starting point of each of the long training sequences to initialize memories within a trellis encoder to trellis-encode the TS.

7. The method of claim 6, wherein:
the known data is arranged in a form of a total of 5 long training sequences in the head/tail areas;
initialization bytes arranged immediately before a starting point of a second long training sequence, a third long training sequence, and a fourth long training sequence, among the 5 long training sequences, are arranged after a preset number of bytes from a first byte of each segment where the second long training sequence, the third long training sequence, and the fourth long training sequences are arranged.

8. The method of claim 1, wherein the arranging comprises:
if 16 slots constructing one Mobile/Handheld (M/H) sub-frame within the stream are set in the another mode to arrange the second mobile data in an MPEG header and an RS parity area and all of the second area, and if an RS frame mode is a Single Frame mode, a block having a placeholder for the MPEG header and the RS parity area is absorbed into at least one other block and used; and
if the RS frame mode is a Dual Frame mode, the block having a placeholder for the MPEG header and the RS parity area is used separately from the at least one other block.

9. A digital broadcast transmitter, comprising:
a stream constructor which constructs a stream in which known data and second mobile data are provided, by arranging the second mobile data in a slot according to a predetermined mode, wherein the slot comprises a first area allocated for first mobile data and a second area allocated for normal data; and
an exciter which encodes and interleaves the constructed stream and outputs the encoded and interleaved stream,
wherein the predetermined mode is a mode to arrange the second mobile data within at least part of the second area.

10. The transmitter of claim 9, wherein the second area is made of 38 packets, and the mode to arrange the second mobile data in the at least part of the second area comprises at least one of:
a first mode to arrange the second mobile data in the 38 packets at ¼ rate;
a second mode to arrange the second mobile data in the 38 packets at 2/4 rate;
a third mode to arrange the second mobile data in the 38 packets at ¾ rate; and
a fourth mode to arrange the second mobile data in all of the 38 packets.

11. The transmitter of claim 9, wherein, if the second mobile data is arranged in all of the second area in one slot:
the stream constructor codes a block containing an MPEG header and an RS parity area independently from a body area within the slot if a block mode set for a corresponding slot is a Separate mode; and
the stream constructor codes the block containing the MPEG header and the RS parity area along with the body area if the block mode is a Paired mode.

12. The transmitter of claim 9, wherein the stream constructor comprises a signaling encoder which encodes signaling data to notify a receiver of the predetermined mode, the signaling data comprising a preset number of bits to notify the predetermined mode.

13. The transmitter of claim 10, wherein the stream constructor comprises a signaling encoder which encodes signaling data to notify a receiver of the predetermined mode, the signaling data comprising 3 bits which are recorded as 000 to indicate the first mode, 001 to indicate the second mode, 010 to indicate the third mode, 011 to indicate the fourth mode, and 111 to indicate a fifth mode in which the second mobile data is arranged in an MPEG header and an RS parity area and all of the second area.

14. The transmitter of claim 9, wherein:
the TS is divided by the interleaving into a body area and head/tail areas;
the known data is arranged in the body area and the head/tail are, respectively, in a form of a plurality of long training sequences; and
an initialization byte is arranged immediately before a starting point of each of the long training sequences to initialize memories within a trellis encoder to trellis-encode the TS.

15. The transmitter of claim 14, wherein:
the known data is arranged in a form of a total of 5 long training sequences in the head/tail areas;
initialization bytes arranged immediately before a starting point of a second long training sequence, a third long training sequence, and a fourth long training sequence, among the 5 long training sequences, are arranged after a preset number of bytes from a first byte of each segment where the second long training sequence, the third long training sequence, and the fourth long training sequences are arranged.

16. The transmitter of claim 9, wherein:
if 16 slots constructing one Mobile/Handheld (M/H) sub-frame within the stream are set in the another mode to arrange the second mobile data in an MPEG header and an RS parity area and all of the second area, and, if an RS frame mode is a Single Frame mode, the stream constructor absorbs a block having a placeholder for the MPEG header and the RS parity area into at least one other block and uses the at least one other block; and
if the RS frame mode is a Dual Frame mode, the stream constructor uses the block having the placeholder for the MPEG header and the RS parity area separately from the at least one other block.

17. A method for processing a stream of a digital broadcast receiver, the method comprising:
receiving a transport stream (TS) comprising a first area allocated for first mobile data and a second area allocated for normal data, and in which second mobile data is arranged in at least one of the first area and the second area in accordance with a predetermined mode;
demodulating the received TS;
equalizing the demodulated TS; and
decoding the second mobile data from the equalized stream,
wherein the predetermined mode is a mode to arrange the second mobile data in at least part of the second area.

18. The method of claim 17, wherein the second area is made of 38 packets, and the mode to arrange the second mobile data in the at least part of the second area comprises at least one of:
a first mode to arrange the second mobile data in the 38 packets at ¼ rate;
a second mode to arrange the second mobile data in the 38 packets at 2/4 rate;
a third mode to arrange the second mobile data in the 38 packets at ¾ rate; and
a fourth mode to arrange the second mobile data in all of the 38 packets.

19. The method of claim 17, further comprising decoding signaling data and detecting information about the predetermined mode and information about a block mode, wherein:
if the predetermined mode is to arrange the new mobile data in all of the second area within one slot, and if the block mode set for a corresponding slot is a Separate mode, the decoding comprises decoding a block containing an MPEG header and an RS parity area independently from a body area inside the slot; and
if the predetermined mode is to arrange the new mobile data in all of the second area within one slot, and if the block mode is a Paired mode, the decoding comprises decoding the block containing the MPEG header and the RS parity area along with the body area.

20. The method of claim 17, further comprising decoding signaling data and detecting information about the predetermined mode, wherein the signaling data comprises a preset number of bits to indicate the predetermined mode.

21. The method of claim 18, further comprising decoding signaling data to detect information about the predetermined mode,
wherein the signaling data comprises 3 bits which are recorded as 000 to indicate the first mode, 001 to indicate the second mode, 010 to indicate the third mode, 011 to indicate the fourth mode, and 111 to indicate a fifth mode in which the second mobile data is arranged in the MPEG header and the RS parity area and all of the second area.

22. The method of claim 18, further comprising, if the predetermined mode is one of the first mode, the second mode, and the third mode, detecting the normal data included in the TS and decoding the detected normal data.

23. The method of claim 17, wherein, at a digital broadcast transmitter which transmits the TS:
if 16 slots constructing one Mobile/Handheld (M/H) sub-frame within the stream are set in the another mode to arrange the second mobile data in an MPEG header and an RS parity area and all of the second area, and if an RS frame mode is a Single Frame mode, a block having a placeholder for the MPEG header and the RS parity area is absorbed into at least one other block and used; and
if the RS frame mode is a Dual Frame mode, the block having the placeholder for the MPEG header and the RS parity area is used separately from the at least one other block.

24. A digital broadcast receiver, comprising:
a receiver which receives a transport stream (TS) comprising a first area allocated for first mobile data and a second area allocated for normal data, and in which second mobile data is arranged in at least one of the first area and the second areas in accordance with a predetermined mode;
a demodulator which demodulates the received TS;
an equalizer which equalizes the demodulated TS; and
a decoder which decodes the second mobile data from the equalized stream,
wherein the predetermined mode is a mode to arrange the second mobile data in at least part of the second area.

25. The receiver of claim 24, wherein the second area is made of 38 packets, and the mode to arrange the second mobile data in the at least part of the second area comprises at least one of:
a first mode to arrange the second mobile data in the 38 packets at ¼ rate;
a second mode to arrange the second mobile data in the 38 packets at 2/4 rate;
a third mode to arrange the second mobile data in the 38 packets at ¾ rate; and
a fourth mode to arrange the second mobile data in all of the 38 packets.

26. The receiver of claim 24, further comprising a signaling decoder which decodes signaling data and detects information about the predetermined mode and information about a block mode, wherein:
if the predetermined mode is to arrange the new mobile data in all of the second area within one slot, and if the block mode set for a corresponding slot is a Separate mode, the signaling decoder decodes a block containing an MPEG header and an RS parity area independently from a body area inside the slot; and
if the predetermined mode is to arrange the new mobile data in all of the second area within one slot, and if the block mode is a Paired mode, the signaling decoder decodes the block containing the MPEG header and the RS parity area along with the body area.

27. The receiver of claim 24, further comprising a signaling decoder which decodes signaling data and detects information about the predetermined mode, wherein the signaling data comprises a preset number of bits to indicate the predetermined mode.

28. The receiver of claim 25, further comprising a signaling decoder which decodes signaling data and detects information about the predetermined mode,
wherein the signaling data comprises 3 bits which are recorded as 000 to indicate the first mode, 001 to indicate the second mode, 010 to indicate the third mode, 011 to indicate the fourth mode, and 111 to indicate a fifth mode in which the second mobile data is arranged in an MPEG header and an RS parity area and all of the second area.

29. The receiver of claim 24, wherein, at a digital broadcast transmitter which transmits the TS:
if 16 slots constructing one Mobile/Handheld (M/H) sub-frame within the stream are set in the another mode to arrange the second mobile data in an MPEG header and an RS parity area and all of the second area, and if an RS frame mode is a Single Frame mode, a block having a placeholder for the MPEG header and the RS parity area is absorbed into at least one other block and used; and
if the RS frame mode is a Dual Frame mode, the block having the placeholder for the MPEG header and the RS parity area is used separately from the at least one other block.

30. A computer readable recording medium having recorded thereon a program executable by a computer for performing the method of claim 1.

31. A computer readable recording medium having recorded thereon a program executable by a computer for performing the method of claim 17.

32. The method of claim 1, wherein the predetermined mode is a mode to arrange the second mobile data in an MPEG header and a Reed Solomon (RS) parity area and all of the second area.

33. The transmitter of claim 9, wherein the predetermined mode is a mode to arrange the second mobile data in an MPEG header and a Reed Solomon (RS) parity area and all of the second area.

34. The method of claim 17, wherein the predetermined mode is a mode to arrange the second mobile data in an MPEG header and a Reed Solomon (RS) parity area and all of the second area.

35. The method of claim 24, wherein the predetermined mode is a mode to arrange the second mobile data in an MPEG header and a Reed Solomon (RS) parity area and all of the second area.
